(19) United States
(12) Patent Application Publication
(10) Pub. No.: US 2026/0185490 A1
(43) Pub. Date: Jul. 2, 2026

(54) TURBOFAN ENGINE INCLUDING A FAN ACTUATION SYSTEM

(71) Applicant: General Electric Company, Evendale, OH (US)

(72) Inventors: Randy M. Vondrell, Newport, KY (US); Keith A. Miedema, Fairfield, OH (US)

(21) Appl. No.: 19/552,578

(22) Filed: Feb. 27, 2026

Related U.S. Application Data
(63) Continuation-in-part of application No. 19/357,928, filed on Oct. 14, 2025.
Application No. 19/357,928 is a continuation-in-part of application No. 19/097,493, filed on Apr. 1, 2025, now Pat. No. 12,480,415.
Application No. 19/097,493 is a continuation-in-part of application No. 18/400,746, filed on Dec. 29, 2023, now Pat. No. 12,345,178.

(51) Int. Cl. F02C 9/26; B64D 27/10; B64D 31/00; F02C 9/22

(52) U.S. Cl. CPC F02C 9/26; B64D 27/10; B64D 31/00; F02C 9/22; F05D 2220/36; F05D 2240/54

(57) ABSTRACT

A turbofan engine for an aircraft includes a fan and a fan actuation system. The fan has a plurality of fan blades coupled to a fan shaft having one or more fan bearings. The fan blades are rotatable about a pitch axis. The fan actuation system is disposed within a fan hub and includes one or more actuators for rotating the fan blades about the pitch axis and one or more radial thrust bearings. The fan actuation system is characterized by a fan actuation system length envelope in a range from 8.5 to 24 and given by

$$\frac{{N}_{FB} \times {D}_{FT}}{{L}_{AXIAL} \times ( \frac{{R}_{TB}}{{N}_{FB}} )} .$$

N_{FB} is a number of the fan blades, D_{FT} is a fan tip diameter of the fan blades, R_{TB} is a thrust bearing radius of the radial thrust bearings, and L_{AXIAL} is an axial length from a fan hub tip to the fan bearings.

### CROSS REFERENCE TO RELATED APPLICATIONS

This application is a continuation-in-part of U.S. patent application Ser. No. 19/357,928, filed Oct. 14, 2025, which is a continuation-in-part of U.S. patent application Ser. No. 19/097,493, filed Apr. 1, 2025, which is a continuation-in-part of U.S. patent application Ser. No. 18/400,746, filed on Dec. 29, 2023, and issued as U.S. Pat. No. 12,345,178 on Jul. 1, 2025, the contents of all of which are hereby incorporated by reference herein in their entireties.

### TECHNICAL FIELD

The present disclosure relates generally to fan actuation systems for turbofan engines.

### BACKGROUND

Turbofan engines, for example, for an aircraft, generally include a fan having fan blades, a compressor section, a combustion section, and a turbine section arranged in flow communication with one another. Some turbofan engines include a fan actuation system for actuating the fan blades of the fan.

### BRIEF DESCRIPTION OF THE DRAWINGS

The foregoing and other features and advantages will be apparent from the following, more particular, description of various exemplary aspects, as illustrated in the accompanying drawings, wherein like reference numbers generally indicate identical, functionally similar, or structurally similar elements.

FIG. 1 is a schematic cross-sectional diagram of a turbofan engine, taken along a longitudinal centerline axis of the turbofan engine, according to the present disclosure.

FIG. 2 shows a schematic view of a turbofan engine, according to the present disclosure.

FIG. 3 shows a fan having a fan actuation system, according to the present disclosure.

FIG. 4 is a schematic cross-sectional diagram of a fan actuation system for a turbofan engine, taken along a longitudinal centerline axis of the turbofan engine, according to the present disclosure.

FIG. 5 is a schematic cross-sectional view of a fan actuation system for a turbofan engine, according to another aspect.

FIG. 6 is a schematic cross-sectional view of a fan actuation system for the turbofan engine, taken along the longitudinal centerline axis of the turbofan engine, according to the present disclosure.

FIG. 7 is a schematic cross-sectional view of a fan actuation system for the turbofan engine, taken along the longitudinal centerline axis of the turbofan engine, according to another aspect.

FIG. 8 is a schematic cross-sectional view of a fan actuation system for the turbofan engine, taken along the longitudinal centerline axis of the turbofan engine, according to another aspect.

FIG. 9 is a schematic cross-sectional view of a fan actuation system for the turbofan engine, taken along the longitudinal centerline axis of the turbofan engine, according to another aspect.

FIG. 10 is a schematic cross-sectional view of a fan actuation system for the turbofan engine, taken along the longitudinal centerline axis of the turbofan engine, according to another aspect.

FIG. 11 represents, in graph form, a fan actuation system envelope as a function of a loading envelope, according to the present disclosure.

FIG. 12 represents, in graph form, the fan actuation system envelope as a function of a spacing envelope, according to the present disclosure.

FIG. 13 represents, in graph form, a fan actuation system length envelope as a function of a loading envelope, according to the present disclosure.

FIG. 14 represents, in graph form, the fan actuation system length envelope as a function of a spacing envelope, according to the present disclosure.

FIG. 15 is a schematic view of a forward end of a fan of the turbofan engine of FIG. 2, according to the present disclosure.

FIG. 16 is an enlarged, schematic, cross-sectional diagram of the turbofan engine of FIG. 1 and having one or more fan bearings, taken at detail 16 in FIG. 1, according to the present disclosure.

FIG. 17 is an enlarged, schematic, cross-sectional diagram of the turbofan engine of FIG. 1 and having one or more fan bearings, taken along the longitudinal centerline axis, according to another aspect.

FIG. 18 is a schematic cross-sectional view of a fan bearing for the turbofan engine of FIG. 1, according to another aspect.

FIG. 19 represents, in graph form, a fan bearing envelope as a function of a takeoff thrust of the turbofan engine, according to the present disclosure.

FIG. 20 represents, in graph form, the fan bearing envelope as a function of the takeoff thrust, according to another aspect.

FIG. 21 is an enlarged schematic, cross-sectional view of a segment of a fan of having a fan actuation system, according to another aspect.

FIG. 22 is a flowpath view of an exemplary embodiment of a rotor assembly of the propulsion system of FIG. 2;

FIG. 23 is a perspective view of an exemplary embodiment of the rotor assembly of FIG. 22;

FIGS. 24-25 are top-down views of a portion of an exemplary embodiment of a variable blade pitch rotor assembly for a propulsion system according to an aspect of the present disclosure;

FIGS. 26-27 are schematic depictions of modes of operation for the exemplary embodiments of the variable blade pitch rotor assembly of FIGS. 24-25;

FIG. 28 is an exemplary embodiment of a vane of a vane assembly of the propulsion system of FIG. 2;

FIGS. 29-33 are roll-out views of embodiments of the vane assembly of the propulsion system of FIG. 2;

FIG. 34 is an exemplary embodiment of positions of an articulatable vane of the propulsion system of FIG. 2;

FIGS. 35-36 are top-down views of a portion of an exemplary embodiment of a variable vane pitch assembly for a propulsion system according to aspects of the present disclosure;

FIGS. 37-41 are top-down schematic views depicting operations of an exemplary embodiment of a blade and a vane of the propulsion system of FIG. 2;

FIG. 42 is a flowchart outlining steps of a method for adjusting thrust vector for an unducted rotor engine;

FIGS. 43-49 are schematic depictions of embodiments of computing systems configured to operate one or more propulsion systems according to aspects of the present disclosure; and

FIGS. 50-51 are schematic depictions of embodiments of engine arrangements and computing systems according to embodiments depicted in FIGS. 53-59.

FIG. 52 is a schematic view of an aircraft including the engine of FIG. 2 and a control system, in accordance with an exemplary aspect of the present disclosure.

FIG. 53 is an exemplary noise control method, in accordance with an exemplary aspect of the present disclosure.

FIG. 54 is an exemplary noise profile in accordance with an exemplary aspect of the present disclosure.

FIG. 55 is a graphical illustration of change in pitch angle of outlet guide vanes and fan noise in accordance with an exemplary aspect of the present disclosure.

FIG. 56 is a graphical illustration of fan speed and fan system noise associated with an approach operation, in accordance with an exemplary aspect of the present disclosure.

FIG. 57 is a graphical illustration of fan speed and fan system noise associated with a sideline operation, in accordance with an exemplary aspect of the present disclosure.

FIG. 58 is a schematic view of an aircraft including the engine of FIG. 2 and a control system, in accordance with an exemplary aspect of the present disclosure.

FIG. 59 is an exemplary noise control method, in accordance with an exemplary aspect of the present disclosure.

### DETAILED DESCRIPTION

Features, advantages, and aspects of the present disclosure are set forth or apparent from a consideration of the following detailed description, drawings, and claims. Moreover, the following detailed description is exemplary and intended to provide further explanation without limiting the scope of the disclosure as claimed.

Various aspects of the present disclosure are discussed in detail below. While specific aspects are discussed, this is done for illustration purposes only. A person skilled in the relevant art will recognize that other components and configurations may be used without departing from the present disclosure.

As used herein, the terms “first,” “second,” “third,” and “fourth” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbofan engine or vehicle, and refer to the normal operational attitude of the turbofan engine or vehicle. For example, with regard to a turbofan engine, forward refers to a position closer to an engine inlet and aft refers to a position closer to an engine nozzle or exhaust.

As used herein, the terms “low,” “mid” (or “mid-level”), and “high,” or their respective comparative degrees (e.g., “lower” and “higher”, where applicable), when used with compressor, combustor, turbine, shaft, fan, or turbofan engine components, each refers to relative pressures, relative speeds, relative temperatures, or relative power outputs within an engine unless otherwise specified. For example, a “low-power” setting defines the engine or the combustor configured to operate at a power output lower than a “high-power” setting of the engine or the combustor, and a “mid-level power” setting defines the engine or the combustor configured to operate at a power output higher than a “low-power” setting and lower than a “high-power” setting. The terms “low,” “mid” (or “mid-level”) or “high” in such aforementioned terms may additionally, or alternatively, be understood as relative to minimum allowable speeds, pressures, or temperatures, or minimum or maximum allowable speeds, pressures, or temperatures relative to normal, desired, steady state, etc., operation of the engine. A mission cycle for a turbofan engine includes, for example, a low-power operation, a mid-level power operation, and a high-power operation. Low-power operation includes, for example, engine start, idle, taxiing, and approach. Mid-level power operation includes, for example, cruise. High-power operation includes, for example, takeoff and climb.

The various power levels of the turbofan engine are defined as a percentage of a sea level static (SLS) maximum engine rated thrust. Low power operation includes, for example, less than thirty percent (30%) of the SLS maximum engine rated thrust of the turbofan engine. Mid-level power operation includes, for example, thirty percent (30%) to eighty-five percent (85%) of the SLS maximum engine rated thrust of the turbofan engine. High power operation includes, for example, greater than eighty-five percent (85%) of the SLS maximum engine rated thrust of the turbofan engine. The values of the thrust for each of the low power operation, the mid-level power operation, and the high power operation of the turbofan engine are exemplary only, and other values of the thrust can be used to define the low power operation, the mid-level power operation, and the high power operation.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbofan engine. Moreover, the terms “radial” and “radially” refer to directions and orientations that extend substantially perpendicular to the centerline of the turbofan engine. In addition, as used herein, the terms “circumferential” and “circumferentially” refer to directions and orientations that extend arcuately about the centerline of the turbofan engine.

As used herein, a “turbofan engine” includes a core flowpath defined by a compressor section, a combustion section, and a turbine section, and a fan that directs air into the core flowpath, and rated for use in a regional aircraft, a narrow body aircraft, or a wide body aircraft. A turbofan engine rated for use on a regional aircraft will have a maximum takeoff thrust in a range from ten thousand pound-force to twenty thousand pound-force (10,000 lbf to 20,000 lbf). A turbofan engine rated for use on a narrow body aircraft will have a maximum takeoff thrust in a range from fifteen thousand pound-force to thirty thousand pound-force (15,000 lbf to 30,000 lbf). A turbofan engine rated for use on a wide body aircraft will have a maximum takeoff thrust in a range from forty thousand pound-force to one hundred ten thousand pound-force (40,000 lbf to 110,000 lbf).

As used herein, the term “cruise” or “cruising speed” refers to operation of a turbofan engine utilized to power an aircraft that may operate at a cruising speed when the aircraft levels after climbing to a specified altitude. A turbofan engine may operate at a cruising speed that is from 50% to 90% of a rated speed, such as from 70% to 80% of the rated speed. In some aspects, a cruising speed may be achieved at about 80% of full throttle, such as from about 50% to about 90% of full throttle, such as from about 70% to about 80% full throttle. As used herein, the term “cruise flight” refers to a phase of flight in which an aircraft levels in altitude after a climb phase and prior to descending to an approach phase. In various examples, cruise flight may take place at a cruise altitude up to approximately 65,000 ft. In certain examples, cruise altitude is in a range from approximately 28,000 ft. to approximately 45,000 ft. In yet other examples, cruise altitude is expressed in flight levels (FL) based on a standard air pressure at sea level, in which cruise flight is between FL280 and FL650. In another example, cruise flight is between FL280 and FL450. In still certain examples, cruise altitude is defined based at least on a barometric pressure, in which cruise altitude is in a range from approximately 4.85 psia to approximately 0.82 psia based on a sea-level pressure of approximately 14.70 psia and sea-level temperature at approximately 59 degrees Fahrenheit. In another example, cruise altitude is in a range from approximately 4.85 psia to approximately 2.14 psia. In certain examples, the ranges of cruise altitude defined by pressure may be adjusted based on a different reference sea-level pressure and/or sea-level temperature.

As used herein, the term “ducted engine” means a turbofan engine with a fan casing or nacelle that circumferentially surrounds the fan.

As used herein, an “unducted fan engine” or an “open fan engine” means a turbofan engine without a fan casing or a nacelle surrounding the fan.

Hereafter, the term “turbofan engine” will refer to either a “ducted engine” or an “open fan engine.”

As used herein, a “fan tip diameter” is defined as a diameter of a fan blade and is measured from the longitudinal centerline axis of the turbofan engine to a fan tip of the fan blade at an axial location of the blade where the diameter is a maximum.

As used herein, a Mach number is a ratio of the speed of the aircraft to the speed of sound in the surrounding airflow. The Mach number at cruise as defined herein is a maximum operating Mach number as provided by a Type Certificate Data Sheet (TCDS) for the turbofan engine.

An aircraft's quoted cruise Mach number is generally known in the industry to be applied during a “standard day” temperature day. Therefore, the temperature is a fixed value based on altitude according to the established International Standard Atmosphere (ISA) tables. High speed civil gas turbine powered transport aircraft quote their speed by Mach number and have set cruising altitudes based on their size and mission profile (e.g., smaller aircraft fly at lower altitudes). Turboprops and smaller aircraft may have their cruising speed quoted in knots such as VTAS (velocity true airspeed) or KCAS (knots calibrated air speed), where ambient temperature is considered. Engine performance can be modeled for “hot days” or “cold days” where the ambient temperature is hotter or cooler than standard day by a prescribed amount, but this is part of off-design performance. Further, between 36,000 and 80,000 feet, where most commercial aircraft cruise, the ambient temperature is actually constant.

As used herein, a “thrust bearing radius” of a radial thrust bearing is defined in the radial direction from the longitudinal centerline axis to a radial center of the radial thrust bearing. Particularly, the radial center of the radial thrust bearing is a radial center of the rolling elements of the radial thrust bearing.

As used herein, a “fan hub axial length” is an axial length, in the axial direction (e.g., parallel with the longitudinal centerline axis 112) from a fan hub tip of the fan hub to a pitch axis P of the fan blades of the fan.

As used herein, a “fan actuation system axial length” is an axial length, in the axial direction (e.g., parallel with the longitudinal centerline axis 112), from an axially forward-most surface of the fan actuation system to the pitch axis P of the fan blades of the fan.

As used herein, a “fan bearing axial length” is an axial length, in the axial direction (e.g., parallel with the longitudinal centerline axis 112) from the pitch axis P of the fan blades of the fan to an axial center of one or more fan bearings that support rotation of the fan shaft.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

As used herein, a “rolling element diameter” of a rolling element of the fan bearing is a distance of a straight line passing from side to side through a center of the rolling element.

As used herein, a “fan hub trailing edge radius” or “R_{FHTE}” of a fan hub is defined in the radial direction from the longitudinal centerline axis to the fan hub at a trailing edge of the fan blades.

As used herein, a “fan tip radius” of a fan blade is defined in the radial direction from the longitudinal centerline axis to the fan tip at the trailing edge of the fan blade.

As used herein, a “fan hub radius ratio” is defined as a ratio of the fan hub trailing edge radius R_{FHTE} to the fan tip radius of the fan blades.

As used herein, a “fan hub leading edge radius” or “R_{FHLE}” of a fan hub is defined in the radial direction from the longitudinal centerline axis to the fan hub at a leading edge of the fan blades.

As used herein, a “fan bearing radius” or “R_{FBRG}” of a fan bearing is defined as a distance along the radial direction from the longitudinal centerline axis of the turbofan engine to a central axis or a center point of the fan bearing.

As used herein, a “fan bearing radius ratio” or “R_{FHLE}:R_{FBRG}” is a ratio of the fan hub leading edge radius R_{FHLE} to the fan bearing radius R_{FBRG}.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides for turbofan engines that have a variable pitch fan. Such engines include a fan actuation system that includes one or more actuators for changing a pitch of fan blades of the variable pitch fan. The fan actuation system typically includes a hydraulic system that supplies hydraulic fluid to one or more chambers to actuate the actuators. The actuators are coupled to the fan blades and actuation of the actuators causes the fan blades to rotate about a pitch axis P to change the pitch of the fan blades. Some fan actuation systems are designed for turboprop engines that include a propeller, rather than a fan.

Turboprop engines produce less thrust than turbofan engines. Turboprop engines typically provide cruise speeds for an aircraft with a Mach number that is less than 0.7 and have fewer than ten propeller blades, such as fewer than eight propeller blades or fewer than five propeller blades. Turbofan engines include ten or more fan blades that extend from a disk and provide cruise speeds for an aircraft with a Mach number that is 0.7 or greater. To achieve these higher speeds, the fan aerodynamics for the turbofan engines are different than the propeller aerodynamics for turboprop engines, resulting in the turbofan engines having more fan blades for aerodynamic efficiency at higher Mach speeds. Turbofan engines with variable pitch fan blades also benefit from guide vanes, such as outlet guide vanes behind the fan blades, and/or inlet guide vanes forward of the fan, to reduce losses at higher speeds.

The loading environment associated with the variable pitch mechanism for turboprop engines is less than the loading environment presented for a variable pitch turbofan engine. There is a lower disk loading capability requirement on parts (e.g., trunnion, bearings, gearing, actuators, etc.) and associated less actuation force resources needed (e.g., hydraulic fluid) to operate a variable pitch turboprop as compared to a variable pitch turbofan engine. At the same time, the available space, the desirable space, or the volume in that part of the engine for the higher-load-carrying fan blade pitch actuation system and the greater number of blades of a turbofan engine is not correspondingly larger than the space available for the lower-load-carrying fan blade pitch actuation system with fewer fan blades of a turboprop. Turbofan engines having variable pitch fan blades require more compactness for the pitch change system, relative to a turboprop, when considering the larger space requirements assumed if one were to simply scale-up a pitch actuation system for a turboprop for use in a turbofan engine. This can be realized when one considers that a larger, stronger structure is needed to support the more numerous blades and react the higher pitch loads associated with a turbofan engine. One cannot simply scale-up the space available for a pitch change mechanism and associated structure, and also scale up to account for the impact of a significantly increased number of blades when designing a variable pitch turbofan engine. Accommodation of the pitch change mechanism, trunnion, and associated structure for holding and articulating the fan blades within an engine housing therefore presents unique challenges for the turbofan engine in terms of the available space. The existing pitch change mechanisms and structure used to support blades in turboprop engines are not faced with similar challenges and therefore provide limited insight into how to implement a variable pitch mechanism within the more limited space, and more numerous fan blade system of a turbofan engine.

Many actuation systems for turboprop engines include a counterweight system to help pitch the propeller blades (e.g., the weight counteracts inertial loading associated with turning the propeller blade). For turbofan engines, a counterweight system may not be feasible because there is not the space available to accommodate the counterweight system. Thus, an alternative is needed to articulate the blades without exceeding load limits, which implies more compactness given the limited space available. Additionally, it was realized that pitch lock devices to lock the more-numerous fan blades in a feather position for turbofan engines, in case of fan actuation system failure, need to be considered when determining the minimum size needed for the turbofan engine fan actuation system. Additionally, it should be realized the very different types of inlets between a turboprop engine, on the one hand, and turbofan engine on the other hand, impact the amount of available space within the engine housing. Inlets to the turbofan engine (e.g., inlet to the hot gas path through the compressor section, the combustion section, and the turbine section) of a turboprop engine have a relatively narrow circumferential extent (sometimes called “chin” inlets). As such, there is more space available for a pitch change mechanism. Inlets to turbofan engines, however, have annular inlets, which take up more space within the engine housing than the more limited circumferential extent occupied by a turboprop inlet. Accommodating both a pitch change mechanism and annular inlet poses a unique challenge for a turbofan engine with variable pitch fan blades.

For at least these reasons, the loading on a pitch change mechanism and packaging of this system for a turbofan engine having greater number of blades than a turboprop engine presents challenges. It is not simply a matter of scaling-up the space available and size of component parts used in a turboprop engine fan actuation system. Indeed, it has been found that the problem is both unique to the engine type and complex—not amenable to a ready solution based on pre-existing variable pitch turboprop engine design. The inventors, seeking a need to find a solution to this problem, designed and tested several different turbofan engine architectures in an effort to arrive at a fan actuation system that met both the higher loading and more compact space requirements of a turbofan engine.

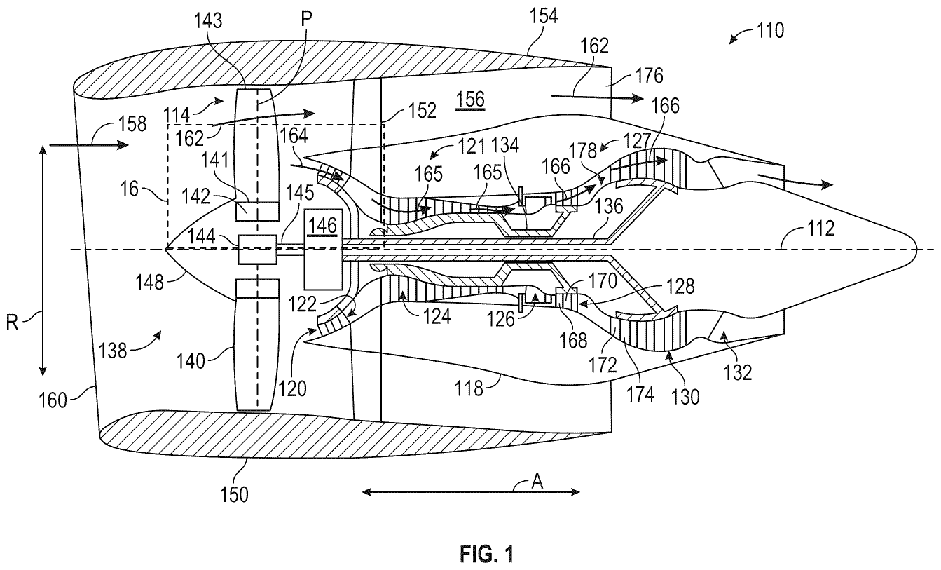

Referring now to the drawings, FIG. 1 is a schematic cross-sectional diagram of a turbofan engine 110, taken along a longitudinal centerline axis 112 of the turbofan engine 110, according to an aspect of the present disclosure. As shown in FIG. 1, the turbofan engine 110 defines an axial direction A (extending parallel to the longitudinal centerline axis 112 provided for reference) and a radial direction R that is normal to the axial direction A. In general, the turbofan engine 110 includes, in serial flow relationship, a fan assembly 114, a compressor section 121, a combustion section 126, and a turbine section 127. The compressor section 121, the combustion section 126, and the turbine section 127 are substantially enclosed within a core cowl 118 that is substantially tubular and defines a core inlet 120 having an annular shape that is annular about the longitudinal centerline axis 112. As schematically shown in FIG. 1, the compressor section 121 includes a booster or a low-pressure (LP) compressor 122 followed downstream by a high-pressure (HP) compressor 124. The combustion section 126 is downstream of the compressor section 121 and includes a combustor. The turbine section 127 is downstream of the combustion section 126 and includes a high-pressure (HP) turbine 128 followed downstream by a low-pressure (LP) turbine 130, also referred to as a power turbine. The turbofan engine 110 also includes a core exhaust nozzle 132 that is downstream of the turbine section 127. The turbofan engine 110 further includes a high-pressure (HP) shaft 134, also referred to as a high-speed shaft, that drivingly connects the HP turbine 128 to the HP compressor 124. The HP turbine 128 and the HP compressor 124 rotate in unison through the HP shaft 134. The turbofan engine 110 includes a low-pressure (LP) shaft 136, also referred to as a low-speed shaft, that drivingly connects the LP turbine 130 to the LP compressor 122. The LP turbine 130 and the LP compressor 122 rotate in unison through the LP shaft 136. The compressor section 121, the combustion section 126, the turbine section 127, and the core exhaust nozzle 132 together define a core air flow path.

In FIG. 1, the fan assembly 114 includes a fan 138 (e.g., a variable pitch fan) having a plurality of fan blades 140 coupled to a fan disk 142 in a spaced apart manner. As depicted in FIG. 1, the fan blades 140 extend outwardly from the fan disk 142 generally along the radial direction R from a fan root 141 to a fan tip 143. Each fan blade 140 is rotatable relative to the fan disk 142 about a pitch axis P by virtue of the fan blades 140 being operatively coupled to a fan actuation system 144 configured to collectively vary the pitch of the fan blades 140 in unison, as detailed further below. The fan actuation system 144 is disposed within a fan hub 148. The fan blades 140, the fan disk 142, and the fan actuation system 144 are together rotatable about the longitudinal centerline axis 112 via a fan shaft 145 that is powered by the LP shaft 136 across a power gearbox, also referred to as a gearbox assembly 146.

The gearbox assembly 146 is shown schematically in FIG. 1. The gearbox assembly 146 includes a plurality of gears for adjusting the rotational speed of the fan shaft 145 and, thus, the fan 138 relative to the LP shaft 136. The gearbox assembly 146 has a gear ratio in a range from 3.5:1 to 5:1 for a ducted engine (e.g., the turbofan engine 110). The LP shaft 136, the gearbox assembly 146, and the fan shaft 145 are disposed in an in-line configuration such that the LP shaft 136, the gearbox assembly 146, and the fan shaft 145 are coaxial and are each disposed about the longitudinal centerline axis 112. The in-line configuration helps to reduce the space needed within the turbofan engine 110 for the gearbox assembly 146 and allows a greater amount of torque to be transferred from the LP shaft 136 to the fan shaft 145 through the gearbox assembly 146 as compared to turboprop engines in which the gearbox assembly is typically disposed in a stepped configuration and is not coaxial with the LP shaft and the fan shaft.

The fan disk 142 is covered by a fan hub 148 that rotates and is aerodynamically contoured to promote an airflow through the plurality of fan blades 140. In addition, the fan assembly 114 includes an annular fan casing or a nacelle 150 that circumferentially surrounds the fan 138 and at least a portion of the core cowl 118. In this way, the turbofan engine 110 is a ducted engine. The nacelle 150 is supported relative to the core cowl 118 by a plurality of fan guide vanes 152, also referred to as outlet guide vanes, that is spaced circumferentially about the nacelle 150. Moreover, a downstream section 154 of the nacelle 150 extends over an outer portion of the core cowl 118 to define a bypass airflow passage 156 therebetween.

During operation of the turbofan engine 110, a volume of air 158 enters the turbofan engine 110 through an inlet 160 of the nacelle 150 or the fan assembly 114. As the volume of air 158 passes across the fan blades 140, a first portion of air, referred to as bypass air 162, is directed or routed into the bypass airflow passage 156, and a second portion of air, referred to as core air 164, is directed or is routed into the upstream section of the core air flow path, or, more specifically, into the core inlet 120 of the LP compressor 122. The ratio between the bypass air 162 and the core air 164 is commonly known as a bypass ratio. The pressure of the core air 164 is then increased by the LP compressor 122 to form compressed air 165, and the compressed air 165 is routed through the HP compressor 124 and into the combustion section 126, where the compressed air 165 is mixed with fuel and burned to generate combustion gases 166.

The combustion gases 166 are routed into the HP turbine 128 and expanded through the HP turbine 128 where a portion of thermal energy and kinetic energy from the combustion gases 166 is extracted via one or more stages of HP turbine stator vanes 168 that are coupled to the core cowl 118 and HP turbine rotor blades 170 that are coupled to the HP shaft 134. This causes the HP shaft 134 to rotate, thereby supporting operation of the HP compressor 124 (e.g., a self-sustaining cycle). In this way, the combustion gases 166 do work in the HP turbine 128 to cause the HP turbine rotor blades 170 (and the HP shaft 134) to rotate at a sufficient rate to maintain the compression ratio of the HP compressor 124 (e.g., self-sustaining cycle). The combustion gases 166 are then routed into the LP turbine 130 and expanded through the LP turbine 130. Here, a second portion of the thermal energy and the kinetic energy is extracted from the combustion gases 166 via one or more stages of LP turbine stator vanes 172 that are coupled to the core cowl 118 and LP turbine blades 174 that are coupled to the LP shaft 136. This causes the LP shaft 136 to rotate, thereby supporting operation of the LP compressor 122 and rotation of the fan 138 via the gearbox assembly 146 (e.g., a self-sustaining cycle). In this way, the combustion gases 166 do work in the LP turbine 130 to cause the LP turbine blades 174 (and the LP shaft 136) to rotate.

The combustion gases 166 are subsequently routed through the core exhaust nozzle 132 to provide propulsive thrust at a thrust level of the turbofan engine 110. The thrust level of the turbofan engine 110 includes a cruise thrust level defined by a cruise Mach number M_{cruise} that is the Mach number of the turbofan engine 110 at cruise conditions, or mid-level power conditions. Simultaneously, the bypass air 162 is directed through the bypass airflow passage 156 before being exhausted from a fan exhaust nozzle 176 of the turbofan engine 110, also providing propulsive thrust. The HP turbine 128, the LP turbine 130, and the core exhaust nozzle 132 at least partially define a hot gas path 178 for routing the combustion gases 166 through the turbofan engine 110.

The turbofan engine 110 depicted in FIG. 1 is by way of example only. In other aspects, the turbofan engine 110 may have other suitable configurations. In other aspects, any other suitable number or configuration of compressors, turbines, shafts, or a combination thereof may be provided. The turbofan engine 110 may also be a direct drive engine, which does not have a power gearbox. The fan speed is the same as the LP shaft speed for a direct drive engine. In still other aspects, aspects of the present disclosure may be incorporated into other suitable turbofan engines, such as, for example, propfan (e.g., unducted fan) engines.

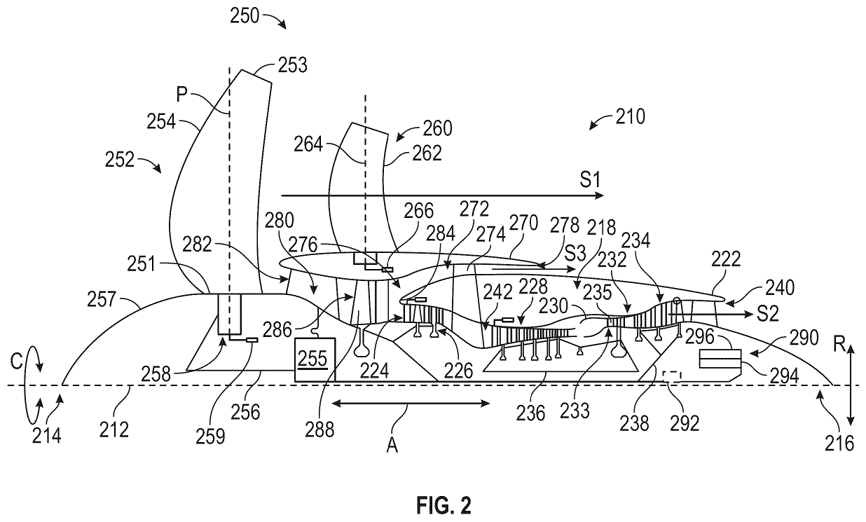

FIG. 2 shows a schematic view of an unducted, three-stream, turbofan engine 210 for an aircraft, that may incorporate one or more aspects of the present disclosure. In this way, the turbofan engine 210 is an unducted fan engine or an open fan engine. The turbofan engine 210 is a “three-stream engine” in that its architecture provides three distinct streams (labeled S1, S2, and S3) of thrust-producing airflow during operation, as detailed further below.

As shown in FIG. 2, the turbofan engine 210 defines an axial direction A, a radial direction R, and a circumferential direction C. Moreover, the turbofan engine 210 defines a longitudinal centerline axis 212 that extends along the axial direction A. In general, the axial direction A extends parallel to the longitudinal centerline axis 212, the radial direction R extends outward from, and inward to, the longitudinal centerline axis 212 in a direction orthogonal to the axial direction A, and the circumferential direction C extends three hundred sixty degrees (360°) around the longitudinal centerline axis 212. The turbofan engine 210 extends between a forward end 214 and an aft end 216, e.g., along the axial direction A.

The turbofan engine 210 includes a fan assembly 250, a compressor section, a combustion section, a turbine section, and an exhaust section. Particularly, as shown in FIG. 2, the turbofan engine 210 includes an engine core 218 and a core cowl 222 that annularly surrounds the compressor section, the combustion section, and the turbine section. The core cowl 222 define a core inlet 224 having an annular shape that is annular about the longitudinal centerline axis 212. The core cowl 222 further encloses and supports a low-pressure (LP) compressor 226 (also referred to as a booster) for pressurizing the air that enters the turbofan engine 210 through the core inlet 224. A high-pressure (HP) compressor 228 receives pressurized air from the LP compressor 226 and further increases the pressure of the air. The pressurized air flows downstream to a combustor 230 where fuel is injected into the pressurized air and ignited to raise the temperature and the energy level of the pressurized air, thereby generating combustion gases.

The combustion gases flow from the combustor 230 downstream to a high-pressure (HP) turbine 232. The HP turbine 232 drives the HP compressor 228 through a first shaft, also referred to as a high-pressure (HP) shaft 236 (also referred to as a “high-speed shaft”). In this regard, the HP turbine 232 is drivingly coupled with the HP compressor 228. Together, the HP compressor 228, the combustor 230, and the HP turbine 232 define the engine core 218. The combustion gases then flow to a power turbine or a low-pressure (LP) turbine 234. The LP turbine 234 drives the LP compressor 226 and components of the fan assembly 250 through a second shaft, also referred to as a low-pressure (LP) shaft 238 (also referred to as a “low-speed shaft”). In this regard, the LP turbine 234 is drivingly coupled with the LP compressor 226 and components of the fan assembly 250. The LP shaft 238 is coaxial with the HP shaft 236 in FIG. 2. After driving each of the HP turbine 232 and the LP turbine 234, the combustion gases exit the turbofan engine 210 through a core exhaust nozzle 240. The turbofan engine 210 defines a core flowpath, also referred to as a core duct 242, that extends between the core inlet 224 and the core exhaust nozzle 240. The core duct 242 is an annular duct positioned generally inward of the core cowl 222 along the radial direction R.

The fan assembly 250 includes a fan 252, also referred to as a primary fan. In FIG. 2, the fan 252 is an open rotor fan, also referred to as an unducted fan. However, in other aspects, the fan 252 may be ducted, e.g., by a fan casing or a nacelle circumferentially surrounding the fan 252, similar to the aspect of FIG. 1. The fan 252 includes a plurality of fan blades 254 (only one shown in FIG. 2) that extends in the radial direction R from a fan root 251 to a fan tip 253. The plurality of fan blades 254 is rotatable about the longitudinal centerline axis 212 via a fan shaft 256. As shown in FIG. 2, the fan shaft 256 is coupled with the LP shaft 238 via a speed reduction gearbox or a power gearbox, also referred to as a gearbox assembly 255, e.g., in an indirect-drive configuration.

The gearbox assembly 255 is shown schematically in FIG. 2. The gearbox assembly 255 includes a plurality of gears for adjusting the rotational speed of the fan shaft 256 and, thus, the fan 252 relative to the LP shaft 238 to a more efficient rotational fan speed. The gearbox assembly may have a gear ratio of 4:1 to 12:1, or 7:1 to 12:1, or 4:1 to 10:1, or 5:1 to 9:1, or 6:1 to 9:1, and may be configured in an epicyclic star or a planet gear configuration. Preferably, the gearbox assembly has a gear ratio of 4:1 to 10:1 for an unducted fan engine (e.g., the turbofan engine 210). The gearbox may be a single stage gearbox or a compound gearbox (e.g., having a plurality of stages). The LP shaft 238, the gearbox assembly 255, and the fan shaft 256 are disposed in an in-line configuration such that the LP shaft 238, the gearbox assembly 255, and the fan shaft 256 are coaxial and are each disposed about the longitudinal centerline axis 212.

The fan blades 254 can be arranged in equal spacing around the longitudinal centerline axis 212. Each fan blade 254 extends outwardly from a disk (not shown in FIG. 2) generally along the radial direction R. The disk is covered by a fan hub 257 that is rotatable and aerodynamically contoured to promote an airflow through the plurality of fan blades 254. Each fan blade 254 has a root and a tip, and a span defined therebetween. Each of the plurality of fan blades 254 defines a pitch axis P. In FIG. 2, each of the plurality of fan blades 254 of the fan 252 is rotatable about their respective pitch axis P, e.g., in unison with one another. A fan actuation system 258 controls one or more actuators 259 to pitch the fan blades 254 about their respective pitch axis P. The fan actuation system 258 is disposed within the fan hub 257.

The fan assembly 250 further includes a fan guide vane array 260 that includes a plurality of fan guide vanes 262 (only one shown in FIG. 2) disposed around the longitudinal centerline axis 212. In FIG. 2, the plurality of fan guide vanes 262 is not rotatable about the longitudinal centerline axis 212. Each of the plurality of fan guide vanes 262 has a root and a tip, and a span defined therebetween. The plurality of fan guide vanes 262 can be unshrouded as shown in FIG. 2 or can be shrouded, e.g., by an annular shroud spaced outward from the tips of the fan guide vanes 262 along the radial direction R. Each of the plurality of fan guide vanes 262 defines a vane pitch axis 264. In FIG. 2, each of the plurality of fan guide vanes 262 of the fan guide vane array 260 is rotatable about their respective vane pitch axis 264, e.g., in unison with one another. One or more actuators 266 are controlled to pitch the plurality of fan guide vanes 262 about their respective vane pitch axis 264. In other aspects, each of the plurality of fan guide vanes 262 is fixed or is unable to be pitched about the vane pitch axis 264. The plurality of fan guide vanes 262 is mounted to a fan cowl 270.

The fan cowl 270 annularly encases at least a portion of the core cowl 222 and is generally positioned outward of the core cowl 222 along the radial direction R. Particularly, a downstream section of the fan cowl 270 extends over a forward portion of the core cowl 222 to define a fan flowpath, also referred to as a fan duct 272. Incoming air enters through the fan duct 272 through a fan duct inlet 276 and exits through a fan exhaust nozzle 278 to produce propulsive thrust. The fan duct 272 is an annular duct positioned generally outward of the core duct 242 along the radial direction R. The fan cowl 270 and the core cowl 222 are connected together and supported by a plurality of struts 274 (only one shown in FIG. 2) that extends substantially radially and are circumferentially spaced about the longitudinal centerline axis 212. The plurality of struts 274 is each aerodynamically contoured to direct air flowing thereby. Other struts, in addition to the plurality of struts 274, can be used to connect and to support the fan cowl 270 and the core cowl 222.

The turbofan engine 210 also defines or includes an inlet duct 280. The inlet duct 280 extends between an engine inlet 282 and the core inlet 224 and the fan duct inlet 276. The engine inlet 282 is defined generally at the forward end of the fan cowl 270 and is positioned between the fan 252 and the fan guide vane array 260 along the axial direction A. The inlet duct 280 is an annular duct that is positioned inward of the fan cowl 270 along the radial direction R. Air flowing downstream along the inlet duct 280 is split, not necessarily evenly, into the core duct 242 and the fan duct 272 by a splitter 284 of the core cowl 222. The inlet duct 280 is wider than the core duct 242 along the radial direction R. The inlet duct 280 is also wider than the fan duct 272 along the radial direction R.

The fan assembly 250 also includes a mid-fan 286. The mid-fan 286 includes a plurality of mid-fan blades 288 (only one shown in FIG. 2). The plurality of mid-fan blades 288 is rotatable, e.g., about the longitudinal centerline axis 212. The mid-fan 286 is drivingly coupled with the LP turbine 234 via the LP shaft 238. The plurality of mid-fan blades 288 can be arranged in equal circumferential spacing about the longitudinal centerline axis 212. The plurality of mid-fan blades 288 is annularly surrounded (e.g., ducted) by the fan cowl 270. In this regard, the mid-fan 286 is positioned inward of the fan cowl 270 along the radial direction R. The mid-fan 286 is positioned within the inlet duct 280 upstream of both the core duct 242 and the fan duct 272. A ratio of a span of a fan blade 254 to that of a mid-fan blade 288 (a span is measured from a root to tip of the respective blade) is greater than 2 and less than 10, to achieve the desired benefits of the third stream (S3), particularly, the additional thrust it offers to the engine, which can enable a smaller diameter fan blade 254 (benefits engine installation).

Accordingly, air flowing through the inlet duct 280 flows across the plurality of mid-fan blades 288 and is accelerated downstream thereof. At least a portion of the air accelerated by the mid-fan blades 288 flows into the fan duct 272 and is ultimately exhausted through the fan exhaust nozzle 278 to produce propulsive thrust. Also, at least a portion of the air accelerated by the plurality of mid-fan blades 288 flows into the core duct 242 and is ultimately exhausted through the core exhaust nozzle 240 to produce propulsive thrust. Generally, the mid-fan 286 is a compression device positioned downstream of the engine inlet 282. The mid-fan 286 is operable to accelerate air into the fan duct 272, also referred to as a secondary bypass passage.

During operation of the turbofan engine 210, an initial airflow or an incoming airflow passes through the fan blades 254 of the fan 252 and splits into a first airflow and a second airflow. The first airflow bypasses the engine inlet 282 and flows generally along the axial direction A outward of the fan cowl 270 along the radial direction R. The first airflow accelerated by the fan blades 254 passes through the fan guide vanes 262 and continues downstream thereafter to produce a primary propulsion stream or a first thrust stream S1. A majority of the net thrust produced by the turbofan engine 210 is produced by the first thrust stream S1. The second airflow enters the inlet duct 280 through the engine inlet 282.

The second airflow flowing downstream through the inlet duct 280 flows through the plurality of mid-fan blades 288 of the mid-fan 286 and is consequently compressed. The second airflow flowing downstream of the mid-fan blades 288 is split by the splitter 284 located at the forward end of the core cowl 222. Particularly, a portion of the second airflow flowing downstream of the mid-fan 286 flows into the core duct 242 through the core inlet 224. The portion of the second airflow that flows into the core duct 242 is progressively compressed by the LP compressor 226 and the HP compressor 228, and is ultimately discharged into the combustion section. The discharged pressurized air stream flows downstream to the combustor 230 where fuel is introduced to generate combustion gases or products.

The combustor 230 defines an annular combustion chamber that is generally coaxial with the longitudinal centerline axis 212. The combustor 230 receives pressurized air from the HP compressor 228 via a pressure compressor discharge outlet. A portion of the pressurized air flows into a mixer. Fuel is injected by a fuel nozzle (omitted for clarity) to mix with the pressurized air thereby forming a fuel-air mixture that is provided to the combustion chamber for combustion. Ignition of the fuel-air mixture is accomplished by one or more igniters (omitted for clarity), and the resulting combustion gases flow along the axial direction A toward, and into, a first stage turbine nozzle 233 of the HP turbine 232. The first stage turbine nozzle 233 is defined by an annular flow channel that includes a plurality of radially extending, circumferentially spaced nozzle vanes 235 that turn the combustion gases so that the combustion gases flow angularly and impinge upon first stage turbine blades of the HP turbine 232. The combustion gases exit the HP turbine 232 and flow through the LP turbine 234, and exit the core duct 242 through the core exhaust nozzle 240 to produce a core air stream, also referred to as a second thrust stream S2. As noted above, the HP turbine 232 drives the HP compressor 228 via the HP shaft 236, and the LP turbine 234 drives the LP compressor 226, the fan 252, and the mid-fan 286 via the LP shaft 238.

The other portion of the second airflow flowing downstream of the mid-fan 286 is split by the splitter 284 into the fan duct 272. The air enters the fan duct 272 through the fan duct inlet 276. The air flows generally along the axial direction A through the fan duct 272 and is ultimately exhausted from the fan duct 272 through the fan exhaust nozzle 278 to produce a third stream, also referred to as a third thrust stream S3.

The third thrust stream S3 is a secondary air stream that increases fluid energy to produce a minority of total propulsion system thrust. In some aspects, a pressure ratio of the third stream is higher than that of the primary propulsion stream (e.g., a bypass or a propeller driven propulsion stream). The thrust may be produced through a dedicated nozzle or through mixing of the secondary air stream with the primary propulsion stream or a core air stream, e.g., into a common nozzle. In certain aspects, an operating temperature of the secondary air stream is less than a maximum compressor discharge temperature for the engine. Furthermore, aspects of the third stream (e.g., airstream properties, mixing properties, or exhaust properties), and thereby a percent contribution to total thrust, are passively adjusted during engine operation or can be modified purposefully through the use of engine control features (such as fuel flow, electric machine power, variable stators, variable inlet guide vanes, valves, variable exhaust geometry, or fluidic features) to adjust or to improve overall system performance across a broad range of potential operating conditions.

The turbofan engine 210 depicted in FIG. 2 is by way of example only. In other aspects, the turbofan engine 210 may have other suitable configurations. For example, the fan 252 can be ducted by a fan casing or a nacelle such that a bypass passage is defined between the fan casing and the fan cowl 270. Moreover, in other aspects, any other suitable number or configuration of compressors, turbines, shafts, or a combination thereof may be provided. Further, aspects of the present disclosure may be incorporated into any other suitable turbofan engine, such as, for example, turbofan engines defining two streams (e.g., a bypass stream and a core air stream).

Further, in FIG. 2, the turbofan engine 210 includes an electric machine 290 (e.g., a motor-generator) operably coupled with a rotating component thereof. In this regard, the turbofan engine 210 is a hybrid-electric propulsion machine. Particularly, as shown in FIG. 2, the electric machine 290 is operatively coupled with the LP shaft 238. The electric machine 290 can be mechanically connected to the LP shaft 238, either directly, or indirectly, e.g., by way of a gearbox assembly 292 (shown schematically in FIG. 2). Further, although the electric machine 290 is operatively coupled with the LP shaft 238 at an aft end of the LP shaft 238, the electric machine 290 can be coupled with the LP shaft 238 at any suitable location or can be coupled to other rotating components of the turbofan engine 210, such as the HP shaft 236 or the LP shaft 238. For instance, in some aspects, the electric machine 290 can be coupled with the LP shaft 238 and positioned forward of the mid-fan 286 along the axial direction A. In some aspects, the turbofan engine of FIG. 1 also includes an electric machine coupled to the LP shaft and located in the tail cone of the engine.

In some aspects, the electric machine 290 can be an electric motor operable to drive or to motor the LP shaft 238. In other aspects, the electric machine 290 can be an electric generator operable to convert mechanical energy into electrical energy. In this way, electrical power generated by the electric machine 290 can be directed to various engine systems or aircraft systems. In some aspects, the electric machine 290 can be a motor/generator with dual functionality. The electric machine 290 includes a rotor 294 and a stator 296. The rotor 294 is coupled to the LP shaft 238 and rotates with rotation of the LP shaft 238. In this way, the rotor 294 rotates with respect to the stator 296, thereby generating electrical power. Although the electric machine 290 has been described and illustrated in FIG. 2 as having a particular configuration, the present disclosure may apply to electric machines having alternative configurations. For instance, the rotor 294 or the stator 296 may have different configurations or may be arranged in a different manner than illustrated in FIG. 2.

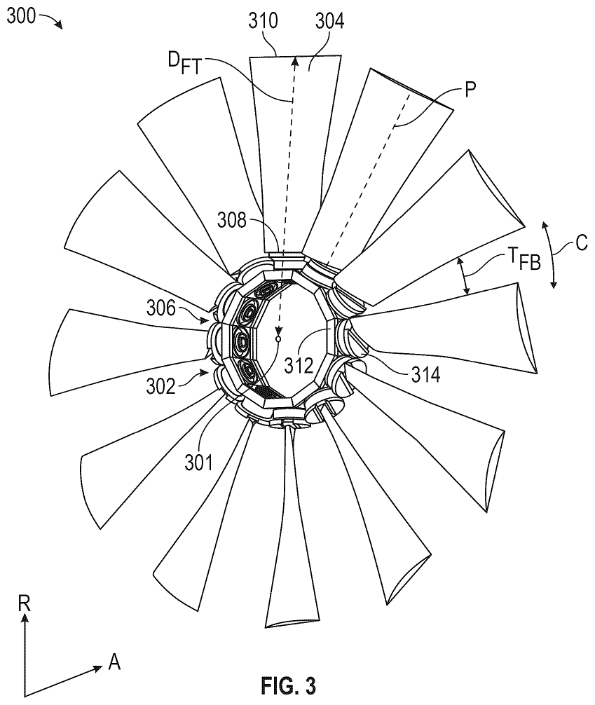

FIG. 3 shows a fan 300 having a fan actuation system 302, according to the present disclosure. The fan 300 can be utilized as the fan 138 of FIG. 1 or as the fan 252 of FIG. 2. The fan 300 includes a plurality of fan blades 304 that is coupled to a disk 306 and is spaced circumferentially about a longitudinal centerline axis 301 of the fan 300. The fan 300 includes a number of fan blades, and, in particular, includes ten to eighteen fan blades 304. In FIG. 3, the fan 300 includes twelve fan blades 304. Each fan blade 304 extends in the radial direction R along a span of the fan blade 304 and from a fan root 308 to a fan tip 310. Each fan blade 304 has a fan tip diameter D_{FT} that extends from the longitudinal centerline axis 301 to the fan tip 310 of each fan blade 304. While the fan tip diameter D_{FT} is detailed with respect to the plurality of fan blades 304, the fan tip diameter D_{FT} is a measurement of any of the fan blades detailed herein. The fan tip diameter D_{FT} is in a range from seven feet to fourteen feet (7 ft. to 14 ft.), as detailed further below. A tangential fan blade distance TFB is defined in the circumferential direction C as a circumferential distance or a tangential distance between adjacent fan blades 304. As used herein, adjacent means two fan blades with no intervening fan blade therebetween.

The disk 306 includes a plurality of disk segments 312 that is rigidly coupled together or integrally molded together in a generally annular shape. One fan blade 304 is coupled to each disk segment 312 at a trunnion mechanism 314 of the fan actuation system 302. The trunnion mechanism 314 facilitates retaining the respective fan blade 304 on the disk 306 during rotation of the disk 306, while still rendering the respective fan blade 304 rotatable relative to the disk 306 about a pitch axis P of the fan blade 304. For example, the trunnion mechanism 314 provides a load path to the disk 306 for the centrifugal load generated by the fan blade 304 during rotation of the fan blade 304 about the longitudinal centerline axis 301. The trunnion mechanism 314 includes a plurality of bearings disposed within the disk segment 312 that allows the fan blade 304 to rotate about the pitch axis P.

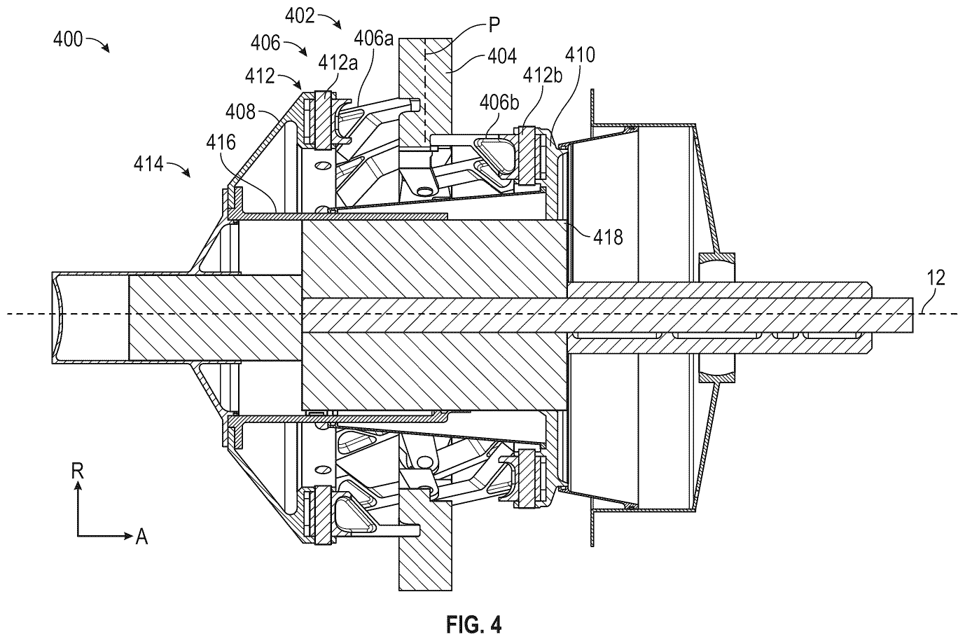

FIG. 4 is a schematic cross-sectional diagram of a fan actuation system 400 for a turbofan engine, taken along a longitudinal centerline axis 112 of the turbofan engine, according to the present disclosure. The fan actuation system 400 can be utilized for any of the fans detailed herein. The fan actuation system 400 includes a trunnion mechanism 402 and one or more actuators 414. The trunnion mechanism 402 includes a plurality of trunnions 404. Each fan blade of the fan is coupled to a respective trunnion 404. Each of the plurality of trunnions 404 is rotatable about a pitch axis P to pitch the fan blades of the fan. The trunnion mechanism 402 includes a plurality of trunnion links 406 that is coupled to the plurality of trunnions 404. For example, a respective trunnion link 406 is coupled to a respective trunnion 404. The plurality of trunnion links 406 includes a plurality of forward trunnion links 406a and a plurality of aft trunnion links 406b that are coupled to the plurality of trunnions 404. The plurality of forward trunnion links 406a is pivotably coupled to the plurality of trunnions 404.

The trunnion mechanism 402 includes a plurality of unison rings 408, 410 including a forward unison ring 408 positioned forward of the plurality of trunnions 404 and an aft unison ring 410 positioned aft of the plurality of trunnions 404. The forward unison ring 408 and the aft unison ring 410 couple the plurality of trunnions 404 together. The plurality of trunnion links 406 is coupled to the forward unison ring 408 or the aft unison ring 410 via a plurality of pins 412. The plurality of forward trunnion links 406a is pivotably coupled to the forward unison ring 408 by a plurality of forward pins 412a such that the plurality of trunnions 404 is coupled to the forward unison ring 408. For example, each forward trunnion link 406a extends forward from a respective trunnion 404 to the forward unison ring 408 and a respective forward pin 412a is disposed through the forward trunnion link 406a at the forward unison ring 408 to pivotably couple the forward trunnion link 406a to the forward unison ring 408. Each aft trunnion link 406b extends aftward from the respective trunnion 404 to the aft unison ring 410 and a respective aft pin 412b is disposed through the aft trunnion link 406b at the aft unison ring 410 to pivotably couple the aft trunnion link 406b to the aft unison ring 410. In this way, each of the plurality of trunnions 404 is pivotably coupled to the forward unison ring 408 and to the aft unison ring 410 such that the plurality of trunnions 404 can pivot about the pitch axis P in unison.

The one or more actuators 414 include a hydraulic cylinder 416 and a piston 418 disposed within the hydraulic cylinder 416. The hydraulic cylinder 416 and the piston 418 are movable along the axial direction A. In this way, the one or more actuators 414 are hydraulic linear actuators such that the hydraulic cylinder 416 and the piston 418 move linearly along the axial direction A (e.g., in opposite directions along the longitudinal centerline axis 112). The forward unison ring 408 is coupled to the hydraulic cylinder 416 such that the forward unison ring 408 moves when the hydraulic cylinder 416 moves. The aft unison ring 410 is coupled to the piston 418 such that aft unison ring 410 moves when the piston 418 moves.

In operation, the fan actuation system 400 moves the plurality of fan blades 140 (FIG. 1) between a first end position and a second end position. The first end position, referred to herein as a feather position, corresponds to a position in which the plurality of fan blades 140 produces the least (e.g., minimal) amount of resistance or drag. In some examples, this position corresponds to a position in which the plurality of fan blades 140 is aligned or substantially aligned (e.g., ±5°) with the flow of the volume of air (e.g., the volume of air 158 of FIG. 1). The second end position is a reverse position in which the plurality of fan blades 140 exceeds, for example, a plane that is transverse to the longitudinal centerline axis 112 (the direction of forward movement of the aircraft) by a certain degree (e.g., 30°) so as to assist with the braking of the aircraft. Therefore, in some examples, the angular stroke of the plurality of fan blades 140 between the feather position and the reverse position is, for example, approximately 120°. The plurality of fan blades 140 can be moved to any position or any angle between the feather position and the reverse position depending on the phase of flight to improve (e.g., optimize) efficiency of the turbofan engine 110 (FIG. 1). In some examples, one or more stops or limits are provided to prevent the plurality of fan blades 140 from being rotated beyond the two end positions. In other examples, the fan actuation system 400 can be configured to provide a greater stroke or a lesser stroke and/or the end positions may be different.

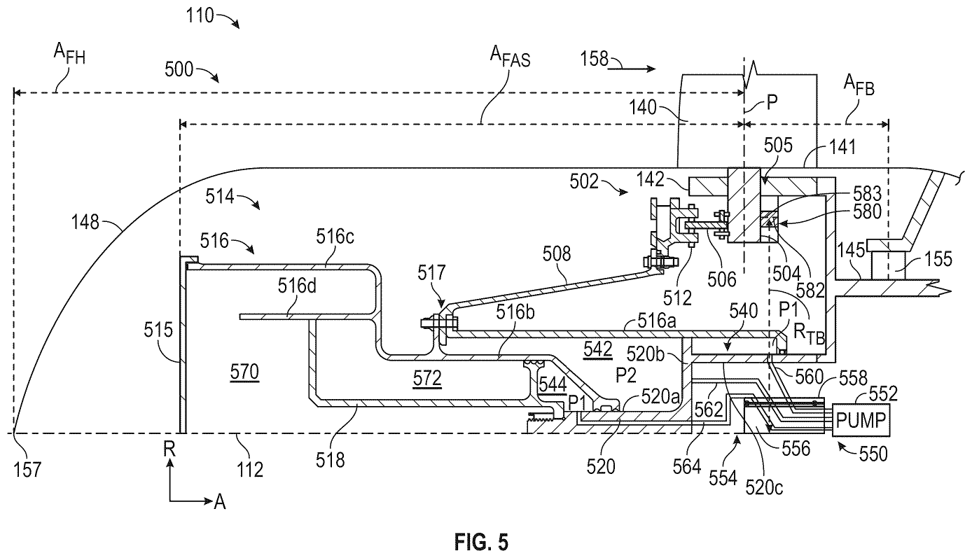

A hydraulic system supplies a hydraulic fluid (e.g., oil) to one or more hydraulic chambers of the one or more actuators 414 to move the hydraulic cylinder 416 and the piston 418 to pitch the plurality of fan blades 140. An exemplary hydraulic system and hydraulic chambers are detailed below with respect to FIG. 5. The plurality of trunnions 404 is disposed in FIG. 4 such that the plurality of fan blades 140 is in the first end position (e.g., the feather position). The pressure of the hydraulic fluid in the one or more hydraulic chambers can be increased to move the hydraulic cylinder 416 in a first direction and to move the piston 418 in a second direction such that the plurality of trunnions 404 move the plurality of fan blades 140 from the feather position towards the reverse position (e.g., the second end position). For example, the hydraulic cylinder 416 can move axially aftward (e.g., to the right in FIG. 4) and the piston 418 can move axially forward (e.g., to the left in FIG. 4) when the pressure of the hydraulic fluid is increased. To move the plurality of fan blades 140 from the reverse position to the feather position, the pressure of the hydraulic fluid in the one or more hydraulic chambers can be decreased to move the hydraulic cylinder 416 in the second direction (e.g., axially forward) and to move the piston 418 in the first direction (e.g., axially aftward).

As the hydraulic cylinder 416 moves axially along the axial direction A, the hydraulic cylinder 416 causes the forward unison ring 408 to move, thereby causing the plurality of forward trunnion links 406a to pivot and to pitch the plurality of trunnions 404, and, therefore, pitching the plurality of fan blades 140 about the pitch axis P. At the same time, movement of the piston 418 along the axial direction A causes the aft unison ring 410 to move, thereby, causing the plurality of aft trunnion links 406b to pivot in an opposite direction as the forward trunnion links 406a, and, therefore, pitching the plurality of fan blades 140 about the pitch axis P. In this way, the fan actuation system 400 translates linear motion of the one or more actuators 414 (e.g., along the axial direction A) into rotational motion of the plurality of fan blades 140. Such a configuration enables a compact and lightweight design of the fan actuation system 400. Further, each of the hydraulic cylinder 416 and the piston 418 provides only half of the force needed to actuate the plurality of trunnions 404 and provides a redundant path in the event that one of the hydraulic cylinder 416 or the piston 418 fails.

FIG. 5 is a schematic cross-sectional view of a fan actuation system 500 for a turbofan engine, according to another aspect. The fan actuation system 500 is shown as being utilized in the turbofan engine 110, but can be utilized in the turbofan engine 210. Only the top half of the fan actuation system 500 is shown in FIG. 5. However, the fan actuation system 500 is symmetrical about the longitudinal centerline axis 112. The fan actuation system 500 may also be referred to as a fan pitch actuation system (FPAS). The fan actuation system 500 controls the pitch (e.g., angle, orientation) of the plurality of fan blades 140 about the pitch axis P. In some examples, the fan actuation system 500 can move the fan blades 140 between a first end position and a second end position.

FIG. 5 shows the fan shaft 145 of the turbofan engine 110 (FIG. 1). The fan shaft 145 is coupled to, and driven by, the LP shaft 136 (FIG. 1). One or more fan bearings 155 support rotation of the fan shaft 145. The one or more fan bearings 155 can include roller bearings, tapered roller bearings, ball bearings, or the like. The one or more fan bearings 155 are disposed aft of the fan disk 142. As shown in FIG. 5, the fan disk 142 is coupled to (e.g., directly or indirectly), and driven by, the fan shaft 145. Each of the plurality of fan blades 140 is coupled to, and extends radially outward from, the fan disk 142. Therefore, as the fan shaft 145 is rotated (via the LP shaft 136), the fan shaft 145 rotates the fan disk 142, which rotates the plurality of fan blades 140 to generate thrust. The fan hub 148 (shown schematically in FIG. 5) includes a fan hub tip 157 that defines an axially forward-most point of the fan hub 148.

The fan actuation system 500 includes a trunnion mechanism 502 including a plurality of trunnions 504. Each fan blade 140 is coupled to a respective one of the plurality of trunnions 504. The plurality of trunnions 504 extends through an opening 505 in the fan disk 142. The plurality of trunnions 504 is rotatable in the opening 505. This enables the plurality of fan blades 140 to rotate about the pitch axis P. As such, the pitch of the plurality of fan blades 140 can be changed relative to the flow of the volume of air 158. In particular, the plurality of fan blades 140 can be rotated (e.g., pitched) to any position between the first end position (e.g., the feather position) and the second end position (e.g., the reverse position). In FIG. 5, the plurality of fan blades 140 is shown in the feather position. In the feather position, the plurality of fan blades 140 is substantially aligned with the flow of the volume of air 158, which reduces resistance or drag. The plurality of fan blades 140 is typically held in the feather position when the turbofan engine 110 (FIG. 1) is not operating.

The fan actuation system 500 includes a plurality of trunnion links 506 and a unison ring 508. The plurality of trunnion links 506 is pivotably coupled to the plurality of trunnions 504. For example, each trunnion link 506 is coupled to a respective trunnion 504 and to the unison ring 508. In this way, the unison ring 508 couples the plurality of trunnions 504 together. The plurality of trunnion links 506 is coupled to the unison ring 508 via a plurality of pins 512. In this way, the plurality of trunnions 504 is pivotably coupled to the unison ring 508 such that the plurality of trunnions 504, and, thus, the plurality of fan blades 140, can pivot about the pitch axis P in unison, as detailed further below.

The fan actuation system 500 includes one or more actuators 514 that include a hydraulic cylinder 516, a piston 518, and a piston retainer 520. The piston retainer 520 is coupled (e.g., bolted) to the fan shaft 145 such that the piston retainer 520 rotates with the fan shaft 145. Therefore, the piston retainer 520 is coupled (e.g., indirectly) to, and rotated by, the LP shaft 136 (FIG. 1). Also, the piston 518 is coupled to, and extends in a forward direction, from the piston retainer 520. Therefore, the piston 518 also rotates with the piston retainer 520 and the fan shaft 145. The hydraulic cylinder 516 also rotate with the piston retainer 520 and the piston 518, but is axially slidable relative to the piston retainer 520 and the piston 518, as disclosed in further detail herein. In some examples, the hydraulic cylinder 516 is disposed within the fan hub 148 (FIG. 1) of the turbofan engine 110 (FIG. 1).

In the illustrated example of FIG. 5, the piston retainer 520 has a first portion 520a (e.g., a post), a second portion 520b (e.g., a flange) that extends radially outward from the first portion 520a, and a third portion 520c (e.g., a shaft) that extends axially from the second portion 520b. The third portion 520c is coupled (e.g., bolted) to the fan shaft 145. The piston retainer 520 can be constructed as multiple parts coupled (e.g., welded) together or as a single unitary part or component (e.g., a monolithic structure). The piston 518 is coupled to, and extends forward from, the first portion 520a of the piston retainer 520.

The hydraulic cylinder 516 is disposed radially outward of (e.g., around, surrounding) the piston retainer 520 and the piston 518. The hydraulic cylinder 516 is keyed to the piston retainer 520. As such, the piston retainer 520 rotates the hydraulic cylinder 516. However, the hydraulic cylinder 516 is slidable along the piston retainer 520 in the axial direction A (left and right in FIG. 5). This movement is used to change the pitch of the plurality of fan blades 140. The hydraulic cylinder 516 is coupled to the unison ring 508 at a joint 517 such that the hydraulic cylinder 516 is coupled to the plurality of fan blades 140 via the trunnion mechanism 502. The fan actuation system 500 can be activated to move the hydraulic cylinder 516 axially (left or right in FIG. 5), which causes the plurality of trunnion links 506 to rotate the plurality of trunnions 504, which rotates the plurality of fan blades 140 about the pitch axis P. As such, movement of the hydraulic cylinder 516 causes all of the fan blades 140 to rotate (e.g., pitch) simultaneously. When the hydraulic cylinder 516 is moved in a first axial direction (the forward direction, or to the left in FIG. 5), the plurality of fan blades 140 is rotated to the feather position, and when the hydraulic cylinder 516 is moved in a second axial direction (the rearward direction, or to the right in FIG. 5), the plurality of fan blades 140 is rotated away from the feather position and toward the reverse position. However, in other examples, the fan actuation system 500 can be configured so that the movement of the hydraulic cylinder 516 is reversed.

The hydraulic cylinder 516 has a first portion 516a, a second portion 516b, a third portion 516c, and a fourth portion 516d. The first portion 516a extends generally in the axial direction A and is coupled to the unison ring 508 at the joint 517 (e.g., a bolted joint). The second portion 516b is disposed radially inward of the first portion 516a and is coupled to the first portion 516a and to the unison ring 508 at the joint 517. The third portion 516c extends forward from the joint 517 (e.g., from the first portion 516a, the second portion 516b, and the unison ring 508) and forms a pressurized pneumatic chamber 570, disclosed in further detail herein. The fourth portion 516d is coupled to, and extends axially within, the third portion 516c. The first portion 516a, the second portion 516b, the third portion 516c, and the fourth portion 516d form the hydraulic cylinder 516. In some examples, the first portion 516a, the second portion 516b, the third portion 516c, and the fourth portion 516d are separate parts or components that are coupled (e.g., welded, bolted) together. In other examples, one or more of the first portion 516a, the second portion 516b, the third portion 516c, and the fourth portion 516d can be constructed as a single unitary part or component (e.g., a monolithic structure). In some aspects, the hydraulic cylinder 516 and the unison ring 508 form a single unitary part or component.

The first portion 516a of the hydraulic cylinder 516 is sealingly engaged with (e.g., engaged with a seal to prevent fluid leakage) the third portion 520c of the piston retainer 520. The second portion 520b of the piston retainer 520 is sealingly engaged with the first portion 516a of the hydraulic cylinder 516. The second portion 516b of the hydraulic cylinder 516 is sealingly engaged with the first portion 520a of the piston retainer 520. The piston 518 is sealingly engaged with the second portion 516b and with the fourth portion 516d of the hydraulic cylinder 516.

The fan actuation system 500 includes one or more hydraulic chambers defined between the hydraulic cylinder 516, the piston 518, and the piston retainer 520. These hydraulic chamber(s) are used to control the position of the hydraulic cylinder 516, and, thus, to control the pitch of the plurality of fan blades 140. As shown in FIG. 5, the fan actuation system 500 includes a first hydraulic chamber 540, a second hydraulic chamber 542, and a third hydraulic chamber 544. The first hydraulic chamber 540 is formed or is defined between the first portion 516a of the hydraulic cylinder 516, the second portion 520b of the piston retainer 520, and the third portion 520c of the piston retainer 520. The second hydraulic chamber 542 is formed or is defined between the first portion 516a of the hydraulic cylinder 516, the second portion 516b of the hydraulic cylinder 516, the first portion 520a of the piston retainer 520, and the second portion 520b of the piston retainer 520. The third hydraulic chamber 544 is formed or is defined between second portion 516b of the hydraulic cylinder 516, an aft end of the piston 518, and the first portion 520a of the piston retainer 520. In this example, the first hydraulic chamber 540 and third hydraulic chamber 544 are provided with hydraulic fluid at a first pressure, referred to herein as P1, and the second hydraulic chamber 542 is provided with hydraulic fluid at a second pressure, referred to herein as P2. The first pressure P1 and the second pressure P2 can be any amount depending on the specific design. In some examples, the first pressure P1 and the second pressure P2 can be as high as one thousand pounds per square inch (1000 psi) or even higher. The first pressure P1 and the second pressure P2 can be increased or can be decreased to cause the hydraulic cylinder 516 to move axially forward or axially rearward, thus changing the pitch of the plurality of fan blades 140. For example, if the force acting on the hydraulic cylinder 516 from the first pressure P1 in the first hydraulic chamber 540 and the third hydraulic chamber 544 is greater than the force acting on the hydraulic cylinder 516 from the second pressure P2 in the second hydraulic chamber 542, the hydraulic cylinder 516 moves (e.g., slides) rearward (axially aftward, or to the right in FIG. 5) along the piston 518 and the piston retainer 520. Conversely, if the force acting on the hydraulic cylinder 516 from the first pressure P1 in the first hydraulic chamber 540 and the third hydraulic chamber 544 is less than the force acting on the hydraulic cylinder 516 from the second pressure P2 in the second hydraulic chamber 542, the hydraulic cylinder 516 moves (e.g., slides) axially forward (to the left in FIG. 5) along the piston 518 and the piston retainer 520. Therefore, the first hydraulic chamber 540 and the third hydraulic chamber 544 receive hydraulic fluid to move the hydraulic cylinder 516 in the rearward direction (e.g., aftward direction) while the second hydraulic chamber 542 receives hydraulic fluid to move the hydraulic cylinder 516 in the forward direction.

The fan actuation system 500 includes a hydraulic system 550 to provide hydraulic fluid, such as oil, to one or more of the hydraulic chambers 540, 542, 544 to control the movement of the hydraulic cylinder 516. The hydraulic system 550 includes a pump 552 to control the first pressure P1 and the second pressure P2. The pump 552 is activated to move the hydraulic fluid into, or out of, the hydraulic chambers 540, 542, 544 to increase or to decrease the first pressure P1 and the second pressure P2, and, therefore, to cause the hydraulic cylinder 516 to move forward or to move rearward. In the illustrated example, the hydraulic system 550 includes an oil transfer bearing 554. The oil transfer bearing 554 includes a fixed portion 556 (e.g., a shaft) with fluid passageways fluidly coupled to the pump 552. The fixed portion 556 is a static component and does not rotate or move axially. The oil transfer bearing 554 includes a sleeve 558 that is rotatable about the fixed portion 556. The hydraulic system 550 includes a first fluid line 560, a second fluid line 562, and a third fluid line 564 fluidly coupled between the oil transfer bearing 554 and the respective hydraulic chambers 540, 542, and 544. The first fluid line 560 is in fluid communication with the first hydraulic chamber 540, the second fluid line 562 is in fluid communication with the second hydraulic chamber 542, and the third fluid line 564 is in fluid communication with the third hydraulic chamber 544. The first fluid line 560, the second fluid line 562, and the third fluid line 564 are coupled to the sleeve 558. The sleeve 558 enables fluid communication among the first fluid line 560, the second fluid line 562, and the third fluid line 564, which are rotating with the fan actuation system 500, and the fixed portion 556 of the oil transfer bearing 554. Thus, the oil transfer bearing 554 enables the hydraulic fluid to be transferred between a stationary component and a rotating component. As disclosed above, the first hydraulic chamber 540 and the third hydraulic chamber 544 are provided with the hydraulic fluid at the same first pressure P1. The oil transfer bearing 554 fluidly couples the hydraulic fluid in the first fluid line 560 and the third fluid lines 564 such that the first hydraulic chamber 540 and the third hydraulic chamber 544 remain at the same first pressure P1.

To move the plurality of fan blades 140 away from the feather position and toward the reverse position, the pump 552 is activated to increase the first pressure P1 in the first hydraulic chamber 540 and the third hydraulic chamber 544 and to reduce the second pressure P2 in the second hydraulic chamber 542. As a result, the hydraulic cylinder 516 moves in the rearward direction (to the right in FIG. 5). The hydraulic cylinder 516 pushes the plurality of trunnion links 506 rearward (to the right in FIG. 5), which causes the plurality of fan blades 140 to rotate away from the feather position and toward the reverse position. In this way, the plurality of fan blades 140 can be moved between the feather position and the reverse position. When the desired position is reached, the pump 552 is deactivated or can otherwise balance the loads on the hydraulic cylinder 516 to maintain the current position. The pump 552 can further increase the first pressure P1 or decrease the second pressure P2 to further move the plurality of fan blades 140 toward the reverse position. Otherwise, to move the plurality of fan blades 140 back to the feather position, the pump 552 is activated to reduce the first pressure P1 in the first hydraulic chamber 540 and the third hydraulic chamber 544 or to increase the second pressure P2 in the second hydraulic chamber 542. Thus, the hydraulic system 550 is used to control the position of the hydraulic cylinder 516 for controlling the pitch of the plurality of fan blades 140 along the pitch axis P. The first pressure P1 being the same in the first hydraulic chamber 540 and the third hydraulic chambers 544 reduces the overall first pressure P1 required to control the hydraulic cylinder 516. In other examples, however, the first hydraulic chamber 540 and the third hydraulic chamber 544 can be pressurized at different pressures.

The pressurized pneumatic chamber 570 is formed or is defined by the third portion 516c of the hydraulic cylinder 516 and the piston 518. The pressurized pneumatic chamber 570 is filled with a pressurized gas. In some examples, the pressurized pneumatic chamber 570 contains pressurized nitrogen. In other examples, the pressurized pneumatic chamber 570 can be filled with another pressurized gas (e.g., air). The pressurized pneumatic chamber 570 is sealed. A such, the volume of the pressurized gas (e.g., nitrogen) in the pressurized pneumatic chamber 570 does not change. During manufacture or assembly of the fan actuation system 500, the pressurized pneumatic chamber 570 can be charged with gas (e.g., nitrogen) and then sealed. The pressurized pneumatic chamber 570 can be pressurized to any amount depending on the size of the pressurized pneumatic chamber 570 and on the size of the hydraulic chambers 540, 542, 544 and the desired biasing force. In some examples, the pressure in the pressurized pneumatic chamber 570 is in a range from seven hundred twenty pounds per square inch to nine hundred twenty pounds per square inch (720 psi to 920 psi). In other examples, however, the pressure may be less than, or greater than, these exemplary values.

The pressurized gas in the pressurized pneumatic chamber 570 generates a constant force or a constant load that biases the hydraulic cylinder 516 in the forward direction (to the left in FIG. 5), which corresponds to the feather position of the plurality of fan blades 140. This provides a failsafe to move the plurality of fan blades 140 to the feather position in an event of failure of the hydraulic system 550 or a shutdown of the turbofan engine 110. For example, if the hydraulic system 550 or the turbofan engine 110 fails or is shut down, the hydraulic system 550 is not able to provide pressurized hydraulic fluid to the hydraulic chambers 540, 542, and 544 to control or to maintain the position of the hydraulic cylinder 516. In such an instance, the force on the hydraulic cylinder 516 from the pressurized gas in the pressurized pneumatic chamber 570 overcomes the force on the hydraulic cylinder 516 from the first hydraulic chamber 540 and the third hydraulic chamber 544. As such, the hydraulic cylinder 516 moves in the forward direction (to the left in FIG. 5), which moves the plurality of fan blades 140 to the feather position shown in FIG. 5. As such, the pressurized pneumatic chamber 570 provides a passive system that moves the plurality of fan blades 140 to the feather position in the event of a failure or a deactivation of the hydraulic system 550, which may occur if the turbofan engine 110 fails or is shut down. Therefore, if one of the turbofan engines of an aircraft fails or is deactivated during flight, the fan actuation system 500 automatically moves the plurality of fan blades 140 to the feather position (FIG. 5). This is advantageous because, in the feather position, the plurality of fan blades 140 produces less resistance, which reduces drag on the turbofan engine 110 and on the aircraft. This also reduces or prevents the plurality of fan blades 140 from spinning (due to incoming airflow) the internal turbo-machinery parts of the turbofan engine 110.

The example pressurized pneumatic chamber 570 is advantageous because it has a high load capability due to the compressibility of the pneumatic gas (e.g., nitrogen). Further, the pressurized pneumatic chamber 570 enables a longer travel of the hydraulic cylinder 516 with relatively little change in load. Therefore, the pressurized pneumatic chamber 570 provides a relatively constant load throughout the stroke. Also, the volume and areas of the pressurized pneumatic chamber 570 and the piston 518 can be varied to optimize the load versus travel of the hydraulic cylinder 516.

Therefore, during normal operation of the fan actuation system 500, the first hydraulic chamber 540 and the third hydraulic chamber 544 act to bias the hydraulic cylinder 516 in the rearward direction, while the second hydraulic chamber 542 and the pressurized pneumatic chamber 570 act to bias the hydraulic cylinder 516 in the forward direction. The pressures in the hydraulic chambers 540, 542, and 544 and in the pressurized pneumatic chamber 570 can be controlled to substantially balance the forces and to maintain the hydraulic cylinder 516 in a desired position. In the illustrated example of FIG. 5, a chamber 572 is formed or is defined between the hydraulic cylinder 516 and the piston 518. The chamber 572 is vented to the atmosphere. As such, the chamber 572 does not provide a force in either direction. In this example, the pressurized pneumatic chamber 570 is forward of the piston retainer 520 and the piston 518. In some examples, this is beneficial because there is additional space forward of these components. In other examples, however, the pressurized pneumatic chamber 570 can be disposed rearward of the piston 518 and the piston retainer 520.

In the example of FIG. 5, the fan actuation system 500 is devoid of a pitch lock device and counterweights for reducing inertial loading associated with rotation of fan blades. In particular, in known fan actuation systems, a separate pitch lock device is required to hold the plurality of fan blades 140 once the plurality of fan blades 140 is in the feather position. Further, in known fan actuation systems, a counterweight is used to provide additional force to help pitch the fan blades. However, with the fan actuation system 500, the pressurized pneumatic chamber 570 provides a constant biasing force to hold the plurality of fan blades 140 in the feather position, which eliminates the need for a separate pitch lock device. Further, the hydraulic system 550 provides the first pressure P1 in both the first hydraulic chamber 540 and the third hydraulic chamber 544 to provide a higher pressure to pitch the fan blades 140, which eliminates the need for a counterweight. This reduces parts, complexity, weight, and costs of the fan actuation system 500.

Examples have been disclosed herein that improve the ability for the fan actuation system 500 to move the fan blades 140 to the feather position in the event of failure of the fan actuation system 500 or a shutdown of the turbofan engine 110. The example systems disclosed herein are passive and, thus, do not require complicated activation components or control systems. The example pressurized pneumatic chamber 570 is capable of handling high rotational speeds and a large variation in operating temperatures, such as encountered during use on aircraft. The examples disclosed herein also eliminate the need for a pitch lock device. As such, the example systems can result in fewer parts, less complexity, reduced weight, and lower costs compared to known systems. The fan actuation system 500 is particularly useful in turbofan engines (e.g., the turbofan engine 110 of FIG. 1 or the turbofan engine 210 of FIG. 2) in which the space for the fan actuation system 500 is smaller as compared to turboprop engines. Components of the fan actuation system 500 can be used in combination with any of the fan actuation systems disclosed herein.

The turbofan engine 110 also includes one or more thrust bearings, also referred to as one or more radial thrust (radial blade load) bearings 580, disposed between the trunnion 504 and the fan disk 142 such that the trunnion 504 rotates about the pitch axis P with respect to the fan disk 142. The one or more radial thrust bearings 580 transmit the load (the radial blade load) from the respective fan blade 140 to a static structure of the turbofan engine 110. In particular, the radial thrust bearings 580 include a plurality of rolling elements 582. The rolling elements 582 can include, for example, ball bearings, tapered roller bearings, or the like, for transmitting the radial blade load from the fan blade 140 to the static structure.

The one or more radial thrust bearings 580 are disposed radially at a thrust bearing radius R_{TB}. The thrust bearing radius R_{TB} is defined in the radial direction R from the longitudinal centerline axis 112 to a radial center 583 of the one or more radial thrust bearings 580. The radial center 583 is a center of the radial thrust bearings 580 in the radial direction R. Particularly, the radial center 583 is defined as a radial center of the rolling elements 582. The amount of space, or the volume, beneath the fan 138 that is available for the fan actuation system 500 is defined by the thrust bearing radius R_{TB}. The fan actuation system 500 needs to be accommodated radially below the one or more radial thrust bearings 580 and within the thrust bearing radius R_{TB}.

The turbofan engine 110 includes a fan hub axial length A_{FH}, a fan actuation system axial length A_{FAS}, and a fan bearing axial length A_{FB}. The fan hub axial length A_{FH} is an axial length, in the axial direction (e.g., parallel with the longitudinal centerline axis 112) from the fan hub tip 157 to the pitch axis P of the fan blades 140. The fan actuation system axial length A_{FAS} is an axial length, in the axial direction (e.g., parallel with the longitudinal centerline axis 112), from an axially forward-most surface 515 of the fan actuation system 500 to the pitch axis P of the fan blades 140. In FIG. 5, the axially forward-most surface 515 is defined by an axially forward-most surface of the actuators 514 (e.g., of the hydraulic cylinder 516). The fan actuation system axial length A_{FAS} is a maximum of 80% of the fan hub axial length A_{FH}. In this way, the fan actuation system 500 fits within the fan hub 148 such that the actuators 514 can move axially without contacting the fan hub 148. The fan bearing axial length A_{FB} is an axial length, in the axial direction (e.g., parallel with the longitudinal centerline axis 112) from the pitch axis P of the fan blades 140 to an axial center of the fan bearings 155.

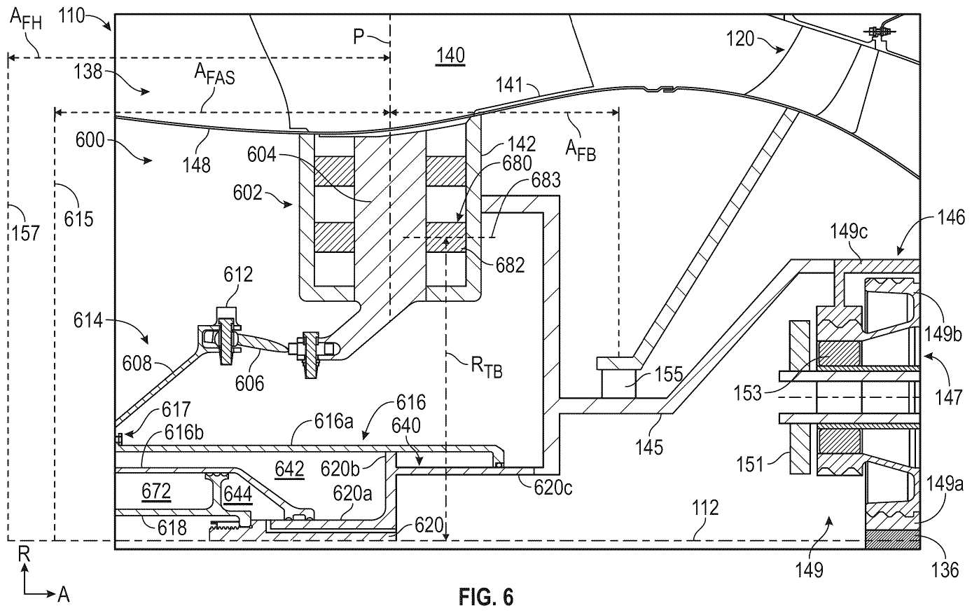

FIG. 6 is a schematic cross-sectional view of a fan actuation system 600 for the turbofan engine 110, taken along the longitudinal centerline axis 112 of the turbofan engine 110, according to the present disclosure. While the fan actuation system 600 is described as being utilized in the turbofan engine 110, the fan actuation system 600 can be utilized in the turbofan engine 210 of FIG. 2. The fan actuation system 600 is substantially similar to the fan actuation system 500 of FIG. 5. The same reference numerals will be used for components of the fan actuation system 600 that are the same as or similar to the components of the fan actuation system 500 discussed above. The description of these components above also applies to this aspect, and a detailed description of these components is omitted here.

The fan actuation system 600 includes a trunnion mechanism 602, a plurality of trunnions 604, a plurality of trunnion links 606, a unison ring 608, a plurality of pins 612, one or more actuators 614, a hydraulic cylinder 616, a joint 617, a piston 618, and a piston retainer 620. The hydraulic cylinder 616 has a first portion 616a and a second portion 616b. Although not shown in the view of FIG. 6, the hydraulic cylinder 616 also includes a third portion and a fourth portion similar to the third portion 516c and the fourth portion 516d of the hydraulic cylinder 516 of FIG. 5. The piston retainer 620 has a first portion 620a, a second portion 620b, and a third portion 620c. The fan actuation system 600 also includes a first hydraulic chamber 640, a second hydraulic chamber 642, a third hydraulic chamber 644, and a pressurized pneumatic chamber (not shown in the view of FIG. 6), and a chamber 672. The first hydraulic chamber 640 and the third hydraulic chamber 644 receive the hydraulic fluid at a first pressure P1, and the second hydraulic chamber 642 receives the hydraulic fluid at a second pressure P2, as detailed above with respect to FIG. 5. The fan actuation system 600 operates substantially similar as to the fan actuation system 500 of FIG. 5.

FIG. 6 shows one fan blade 140 of the fan 138, the core inlet 120, and the gearbox assembly 146. The gearbox assembly 146 includes a gear assembly 147 having a plurality of gears 149 including a first gear 149a, one or more second gears 149b secured by a planet carrier 151, and a third gear 149c. In FIG. 6, the first gear 149a is a sun gear, the one or more second gears 149b are planet gears, and the third gear 149c is a ring gear. The gear assembly 147 is an epicyclic gear assembly. When the gear assembly 147 is an epicyclic gear assembly, the one or more second gears 149b include a plurality of second gears 149b (e.g., two or more second gears 149b).

In the epicyclic gear assembly, the gear assembly 147 can be in a star arrangement or a rotating ring gear type gear assembly (e.g., the third gear 149c is rotating and the planet carrier 151 is fixed and stationary). In such an arrangement, the fan 138 is driven by the third gear 149c. For example, the third gear 149c is coupled to the fan shaft 145 such that rotation of the third gear 149c causes the fan shaft 145, and, thus, the fan 138, to rotate. In this way, the third gear 149c is an output of the gear assembly 147. However, other suitable types of gear assemblies may be employed. In one non-limiting aspect, the gear assembly 147 is a planetary arrangement, in which the third gear 149c is held fixed, with the planet carrier 151 allowed to rotate. In such an arrangement, the fan 138 is driven by the planet carrier 151. For example, the planet carrier 151 is coupled to the fan shaft 145 such that rotation of the planet carrier 151 causes the fan shaft 145, and, thus, the fan 138, to rotate. In this way, the one or more second gears 149b (e.g., via the planet carrier 151) are the output of the gear assembly 147. In another non-limiting aspect, the gear assembly 147 may be a differential gear assembly in which the third gear 149c and the planet carrier 151 are both allowed to rotate. While an epicyclic gear assembly is detailed herein, the gear assembly can include any type of gear assembly including, for example, a single stage gear assembly or a compound gear assembly (e.g., a gear assembly having a plurality of stages).

The plurality of gears 149 includes one or more gear bearings 153 disposed therein. For example, the one or more second gears 149b each includes one or more gear bearings 153 disposed therein. The one or more gear bearings 153 enable the plurality of gears 149 to rotate about the one or more gear bearings 153 such that the plurality of gears 149 rotates. The one or more gear bearings 153 can include any type of bearing for a gear, such as, for example, journal bearings, roller bearings, or the like. The gearbox assembly 146 can include a plurality of gear bearings that includes a forward gear bearing and an aft gear bearing. The one or more gear bearings 153 shown in the view of FIG. 6 are the forward gear bearing.

The first gear 149a is coupled to an input shaft of the turbofan engine 110. For example, the first gear 149a is coupled to the LP shaft 136 such that rotation of the LP shaft 136 causes the first gear 149a to rotate. Radially outward of the first gear 149a, and intermeshing therewith, is the one or more second gears 149b that are coupled together and supported by the planet carrier 151. The planet carrier 151 supports and constrains the one or more second gears 149b such that the each of the one or more second gears 149b is enabled to rotate about a corresponding axis of each second gear 149b without rotating about the periphery of the first gear 149a. Radially outwardly of the one or more second gears 149b, and intermeshing therewith, is the third gear 149c, which is an annular ring gear. The third gear 149c is coupled via an output shaft to the fan 138 and rotates to drive rotation of the fan 138 about the longitudinal centerline axis 112. For example, the fan shaft 145 is coupled to the third gear 149c.

The fan shaft 145 is coupled to the fan disk 142 such that rotation of the fan shaft 145 causes the plurality of fan blades 140 to rotate about the longitudinal centerline axis 112. The turbofan engine 110 also includes one or more radial thrust bearings 680, disposed between the trunnion 604 and the fan disk 142 such that the trunnion 604 rotates about the pitch axis P with respect to the fan disk 142. In particular, the radial thrust bearings 680 include a plurality of rolling elements 682.

The one or more radial thrust bearings 680 are disposed radially at the thrust bearing radius R_{TB} defined in the radial direction R from the longitudinal centerline axis 112 to a radial center 683 of the one or more radial thrust bearings 680, as discussed above. The fan actuation system axial length A_{FAS} is an axial length, in the axial direction (e.g., parallel with the longitudinal centerline axis 112), from an axially forward-most surface 615 (shown schematically in FIG. 6) of the fan actuation system 600 to the pitch axis P of the fan blades 140.

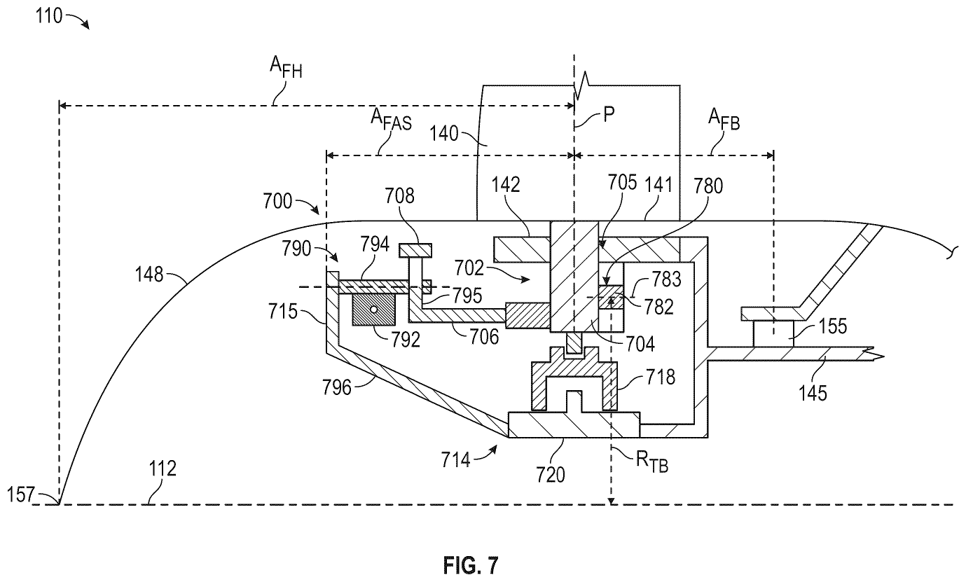

FIG. 7 is a schematic cross-sectional view of a fan actuation system 700 for the turbofan engine 110, taken along the longitudinal centerline axis 112 of the turbofan engine 110, according to the present disclosure. While the fan actuation system 700 is described as being utilized in the turbofan engine 110, the fan actuation system 700 can be utilized in the turbofan engine 210 of FIG. 2. The fan actuation system 700 is substantially similar to the fan actuation system 500 of FIG. 5. The same or similar reference numerals will be used for components of the fan actuation system 700 that are the same as or similar to the components of the fan actuation system 500 discussed above. The description of these components above also applies to this aspect, and a detailed description of these components is omitted here.

The fan actuation system 700 includes a trunnion mechanism 702, a plurality of trunnions 704, an opening 705, one or more trunnion links 706, a unison ring 708, one or more actuators 714, an axially forward-most surface 715, a piston 718, a piston retainer 720, and one or more radial thrust bearings 780. The piston retainer 720 is stationary (e.g., coupled to a static structure of the turbofan engine 110) and the piston 718 moves with respect to the piston retainer 720 to change a pitch of the fan blades 140. For example, the piston 718 can be coupled to a hydraulic cylinder that receives hydraulic fluid for moving the piston 718, as detailed above. The one or more trunnion links 706 include one or more ring gears that mesh with a corresponding gear of the trunnions 704.

The fan actuation system 700 also includes a counterweight assembly 790 including one or more counterweights 792. The counterweights 792 are axially spaced from the trunnions 704 to counter a centrifugal twisting moment of the fan blades 140. The counterweights 792 can be any high-density mass that can rotate about a counterweight centerline. The counterweights 792 can have offset masses that are movable relative to the counterweight centerline. In particular, the counterweights 792 are coupled to one or more counterweight shafts 794 that are drivingly coupled to the trunnion links 706 via one or more counterweight gears 795. The counterweight shafts 794 are supported by one or more counterweight support members 796 that are coupled to the piston retainer 720. In FIG. 7, the axially forward-most surface 715 is defined by an axially forward-most surface of the counterweight support member 796. In this way, the axially forward-most surface 715 is defined by the counterweight assembly 790.

As the trunnions 704 rotate, the trunnions 704 cause the trunnion links 706 to rotate with respect to the unison ring 708, and in turn, the trunnion links 706 cause the counterweight shafts 794 to rotate. As the trunnion links 706 and the counterweight shafts 794 rotate, the counterweights 792 rotate via the counterweight shafts 794. In this way, the counterweights 792 change position relative to the counterweight centerline. Thus, the counterweight assembly 790 counters a centrifugal twisting moment of the fan blades 140 to help rotate the fan blades 140 when the pitch of the fan blades 140 changes.

A mass of the counterweights 792 can be changed based on a length of the counterweight shafts 794. In particular, the counterweights 792 can have less mass with longer counterweight shafts 794 and can have more mass with shorter counterweight shafts 794. In this way, the axially further the counterweights 792 are disposed from the pitch axis P of the fan blades 140, the lesser mass the counterweights 792 can have, while still countering the centrifugal twisting moment of the fan blades 140 and helping to rotate the fan blades 140 when the pitch of the fan blades 140 changes. Accordingly, the mass of the counterweights 792 needed to pitch the fan blades 140 and counter the twisting moment is a function of the axial position of the counterweights 792 with respect to the pitch axis P.

The one or more radial thrust bearings 780 are disposed radially at the thrust bearing radius R_{TB} defined in the radial direction R from the longitudinal centerline axis 112 to a radial center 783 of a plurality of rolling elements 782 of the radial thrust bearings 780, as discussed above. The fan actuation system axial length A_{FAS} is an axial length, in the axial direction (e.g., parallel with the longitudinal centerline axis 112), from an axially forward-most surface 715 of the fan actuation system 700 to the pitch axis P of the fan blades 140.

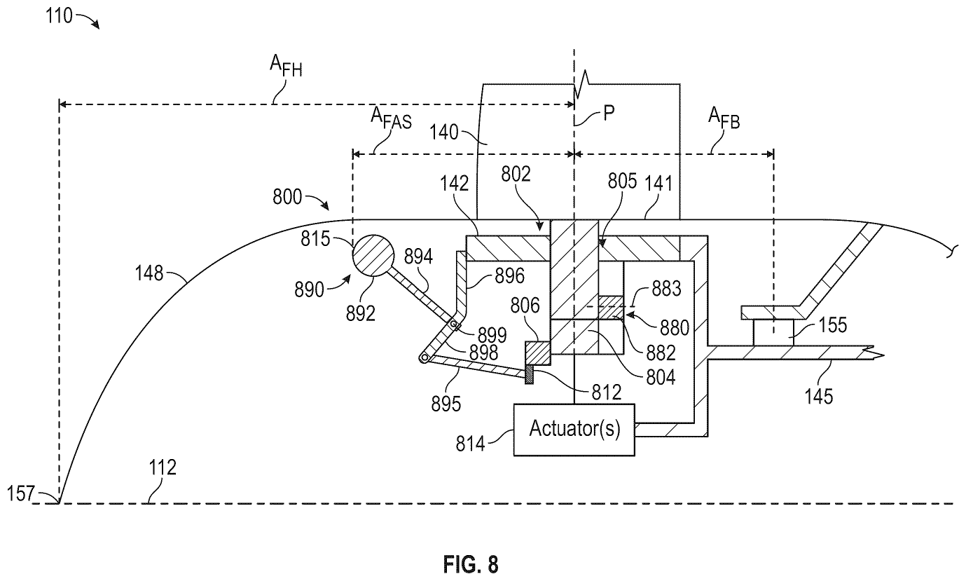

FIG. 8 is a schematic cross-sectional view of a fan actuation system 800 for the turbofan engine 110, taken along the longitudinal centerline axis 112 of the turbofan engine 110, according to the present disclosure. While the fan actuation system 800 is described as being utilized in the turbofan engine 110, the fan actuation system 800 can be utilized in the turbofan engine 210 of FIG. 2. The fan actuation system 800 is substantially similar to the fan actuation system 700 of FIG. 7. The same or similar reference numerals will be used for components of the fan actuation system 800 that are the same as or similar to the components of the fan actuation system 700 discussed above. The description of these components above also applies to this aspect, and a detailed description of these components is omitted here.

The fan actuation system 800 includes a trunnion mechanism 802, a plurality of trunnions 804, an opening 805, one or more trunnion links 806, a plurality of pins 812, one or more actuators 814 (shown schematically in FIG. 8), an axially forward-most surface 815, and one or more radial thrust bearings 880. The actuators 814 can include any of the actuators disclosed herein for changing a pitch of the fan blades 140. The one or more trunnion links 806 include arms that extend from the trunnions 804. The pins 812 extend through the arms and are coupled to a counterweight assembly 890.

The counterweight assembly 890 includes one or more counterweights 892, one or more counterweight shafts 894, and one or more counterweight support members 896. The one or more counterweight support members 896 are coupled to the fan disk 142 such that the counterweight assembly 890 rotates about the longitudinal centerline axis 112 with rotation of the fan 138. The counterweight assembly 890 also includes one or more link arms 895 and one or more lever arms 898. The one or more lever arms 898 are pivotably coupled to the counterweight support members 896 via a pivot 899. The link arms 895 are coupled to the trunnion links 806 via the pins 812 and are pivotably coupled to the lever arms 898. The counterweight shafts 894 are pivotably coupled to the lever arms 898 at the pivot 899.

In FIG. 8, the axially forward-most surface 815 is defined by an axially forward-most surface of the counterweights 892 at a maximum axial extent of the counterweights 892, as detailed further below. In this way, the axially forward-most surface 815 is defined by the counterweight assembly 890.

As the trunnions 804 rotate, the trunnions 804 cause the trunnion links 806 to rotate, and in turn, the trunnion links 806 cause the pins 812 to rotate, and, thus, cause the link arms 895 to pivot. As the link arms 895 pivot, the link arms 895 cause the lever arms 898 to pivot, and, thus, cause the counterweight shafts 894 to pivot about the pivot 899. In this way, the counterweight shafts 894 cause the counterweights 892 to travel along a partially circular arc radially outward away from the longitudinal centerline axis 112 or radially inward towards the longitudinal centerline axis 112. Thus, the counterweight assembly 890 counters a centrifugal twisting moment of the fan blades 140 to help rotate the fan blades 140 when the pitch of the fan blades 140 changes.

The one or more radial thrust bearings 880 are disposed radially at the thrust bearing radius R_{TB} defined in the radial direction R from the longitudinal centerline axis 112 to a radial center 883 of a plurality of rolling elements 882 of the radial thrust bearings 880, as discussed above. The fan actuation system axial length A_{FAS} is an axial length, in the axial direction (e.g., parallel with the longitudinal centerline axis 112), from an axially forward-most surface 815 of the fan actuation system 800 to the pitch axis P of the fan blades 140.

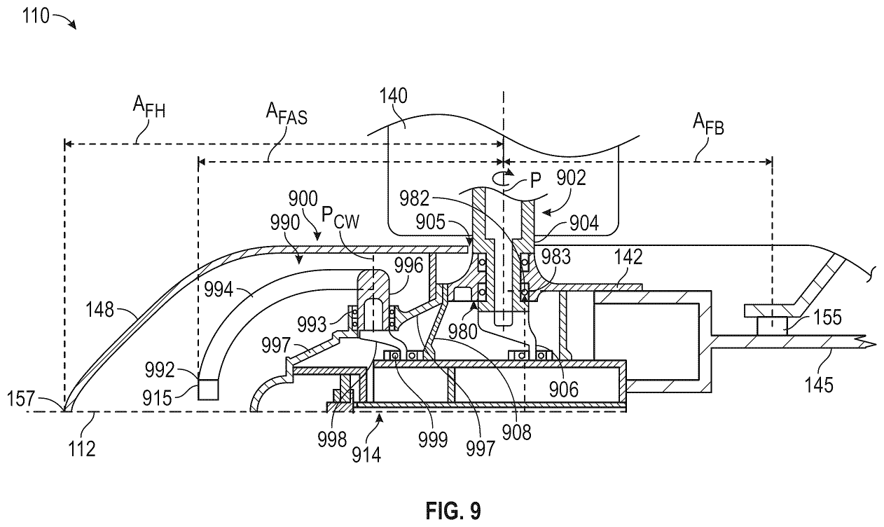

FIG. 9 is a schematic cross-sectional view of a fan actuation system 900 for the turbofan engine 110, taken along the longitudinal centerline axis 112 of the turbofan engine 110, according to the present disclosure. While the fan actuation system 900 is described as being utilized in the turbofan engine 110, the fan actuation system 900 can be utilized in the turbofan engine 210 of FIG. 2. The fan actuation system 900 is substantially similar to the fan actuation system 700 of FIG. 7. The same or similar reference numerals will be used for components of the fan actuation system 900 that are the same as or similar to the components of the fan actuation system 700 discussed above. The description of these components above also applies to this aspect, and a detailed description of these components is omitted here.

The fan actuation system 900 includes a trunnion mechanism 902, a plurality of trunnions 904, an opening 905, one or more trunnion links 906, a unison ring 908, one or more actuators 914, an axially forward-most surface 915, and one or more radial thrust bearings 980. The actuators 914 can include any of the actuators disclosed herein for changing a pitch of the fan blades 140. The one or more trunnion links 906 and the unison ring 908 couple the trunnions 904 to the actuators 914 such that movement of the actuators 914 causes the trunnions 904 to rotate, thus, causing the fan blades 140 to rotate about the pitch axis P.

The counterweight assembly 990 includes one or more counterweights 992, one or more counterweight shafts 994, one or more counterweight support members 996, and one or more lever arms 998. In FIG. 9, the counterweight shafts 994 are counterweight levers and the counterweight support members 996 are counterweight trunnions.

The counterweight assembly 990 includes a counterweight hub 997 that may be connected to the fan disk 142, such that rotation of the fan disk 142 about the longitudinal centerline axis 112 drives rotation of the counterweight hub 997 about the longitudinal centerline axis 112. The counterweight shafts 994 are rotationally connected to the counterweight hub 997. For example, each of the counterweight shafts 994 may be mounted to the counterweight hub 997 via one or more counterweight bearings 993 that provide the ability for the counterweight shafts 994 to rotate about a counterweight lever rotational axis P_{CW}. The counterweight bearings 993 may be any type of bearing (e.g., tapered roller bearings, spherical roller bearings, cylindrical roller bearings, needle roller bearings, thrust ball bearings, angular contact roller bearings, deep groove ball bearings, etc.), and are not limited to any particular type of bearing Each of the counterweight support members 996 are rotational about a counterweight lever rotational axis P_{CW} that extends through a respective counterweight support member 996 and extends radially (i.e., in the radial direction R) from the longitudinal centerline axis 112.

Each counterweight shaft 994 is a cantilever arm having a first end connected to a respective counterweight support member 996 and a second end offset from the respective counterweight lever rotational axis P_{CW}. A respective counterweight 992 is connected to the second end of the counterweight shaft 994. Each counterweight 992 has a counterweight center-of-gravity that is utilized in locating the counterweight 992 within the counterweight assembly 990.

The one or more counterweight support members 996 are coupled to the fan disk 142 such that the counterweight assembly 990 rotates about the longitudinal centerline axis 112 with rotation of the fan 138. The counterweight assembly 990 also includes one or more lever arms 998 that are rotationally connected to the actuators 914 via one or more lever bearings 999. The lever arms 998 are connected to the counterweight support members 996 such that axial translation of the actuators 914 along the longitudinal centerline axis 112 drives the lever arms 998 and the counterweight support members 996 about the respective counterweight lever rotational axis P_{CW} so as to rotate the counterweight shafts 994. In FIG. 9, the counterweight shafts 994 are at a ninety-degree rotated position.

In FIG. 9, the axially forward-most surface 915 is defined by an axially forward-most surface of the counterweights 992 at a maximum axial extent of the counterweights 992 (e.g., at the ninety-degree rotated position). In this way, the axially forward-most surface 915 is defined by the counterweight assembly 990.

As the actuators 914 move axially, the actuators 914 cause the trunnions 904 and the counterweight support members 996 to rotate. In turn, the counterweight support members 996 cause the counterweight shafts 994 to rotate about the counterweight lever rotational axis P_{CW}, and, thus, cause the counterweights 992 to rotate. In particular, the counterweight shafts 994, and the counterweights 992, rotate in to or out of the page between the ninety-degree rotated position that defines a maximum axial extent of the counterweights 992 and a zero-degree rotated position that defines a minimum axial extend of the counterweights 992. Thus, the counterweight assembly 990 counters a centrifugal twisting moment of the fan blades 140 to help rotate the fan blades 140 when the pitch of the fan blades 140 changes.

The one or more radial thrust bearings 980 are disposed radially at the thrust bearing radius R_{TB} defined in the radial direction R from the longitudinal centerline axis 112 to a radial center 983 of a plurality of rolling elements 982 of the radial thrust bearings 980, as discussed above. The fan actuation system axial length A_{FAS} is an axial length, in the axial direction (e.g., parallel with the longitudinal centerline axis 112), from an axially forward-most surface 915 of the fan actuation system 900 to the pitch axis P of the fan blades 140.

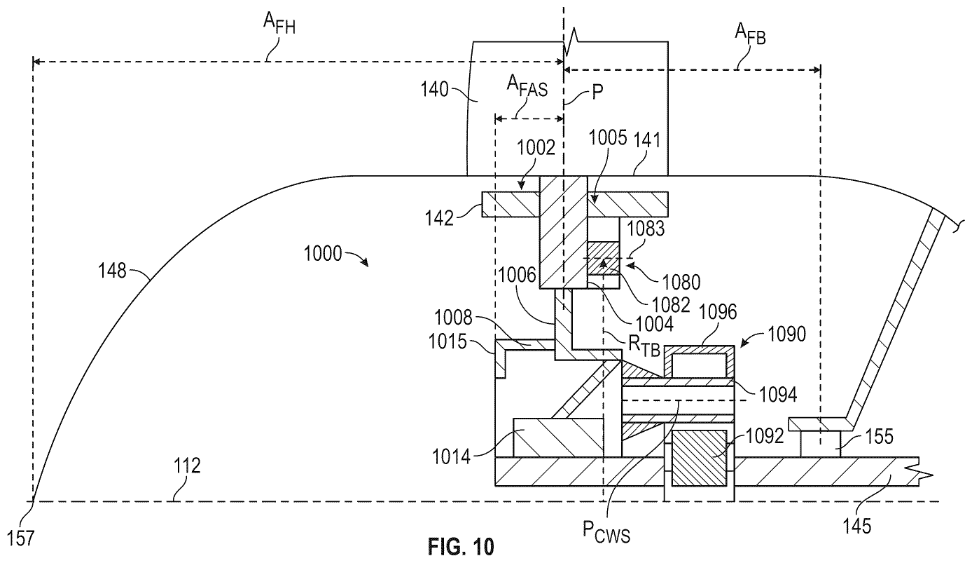

FIG. 10 is a schematic cross-sectional view of a fan actuation system 1000 for the turbofan engine 110, taken along the longitudinal centerline axis 112 of the turbofan engine 110, according to the present disclosure. While the fan actuation system 1000 is described as being utilized in the turbofan engine 110, the fan actuation system 1000 can be utilized in the turbofan engine 210 of FIG. 2. The fan actuation system 1000 is substantially similar to the fan actuation system 500 of FIG. 5. The same or similar reference numerals will be used for components of the fan actuation system 1000 that are the same as or similar to the components of the fan actuation system 500 discussed above. The description of these components above also applies to this aspect, and a detailed description of these components is omitted here.

The fan actuation system 1000 includes a trunnion mechanism 1002, a plurality of trunnions 1004, an opening 1005, one or more trunnion links 1006, a unison ring 1008, one or more actuators 1014, an axially forward-most surface 1015, one or more radial thrust bearings 1080, and a counterweight assembly 1090. The actuators 1014 can include any of the actuators disclosed herein for changing a pitch of the fan blades 140. The one or more trunnion links 1006 and the unison ring 1008 couple the trunnions 1004 to the actuators 1014 such that movement of the actuators 1014 causes the trunnions 1004 to rotate, thus, causing the fan blades 140 to rotate about the pitch axis P. In FIG. 10, the axially forward-most surface 1015 is defined by an axially forward-most surface of the unison ring 1008.

The counterweight assembly 1090 includes one or more counterweights 1092, one or more counterweight shafts 1094, and one or more counterweight support members 1096. The one or more counterweight support members 1096 are coupled to the fan disk 142 via the unison ring 1008 such that the counterweight assembly 1090 rotates about the longitudinal centerline axis 112 with rotation of the fan 138. The counterweights 1092 are positioned axially aft of the fan blades 140, particularly, axially aft of the pitch axis P. For example, the counterweights 1092 are positioned axially between the pitch axis P and the fan bearings 155.

The counterweight support members 1096 act as a carrier for the counterweight shafts 1094. The counterweight shafts 1094 are aligned generally parallel to the longitudinal centerline axis 112 and pass through the counterweight support members 1096. The counterweight shafts 1094 are rotatably connected (e.g., via one or more gears) at a first end to the unison ring 1008. The counterweights 1092 are connected to a second end of the counterweight shafts 1094. The counterweight shafts 1094, and the counterweights 1092, are rotatable relative to the counterweight support members 1096, about a respective counterweight shaft axis P_{CWS}.

All of the counterweight shafts 1094 are meshed via one or more gears with the unison ring 1008. Thus connected, the movement of the fan blades 140, unison ring 1008, and the counterweights 1092 are linked together such that rotary motion of the unison ring 1008, for example, caused by the actuators 1014, will cause a simultaneous change in the pitch angle of all of the fan blades 140, and of the angular orientation of the counterweights 1092. The unison ring 1008 transmits forces between the fan blades 140 and the counterweights 1092. In this way, the counterweight shafts 1094 cause the counterweights 1092 to travel along a partially circular arc radially outward away from the longitudinal centerline axis 112 or radially inward towards the longitudinal centerline axis 112, and axially closer to, or axially further from, the pitch axis P. Thus, the counterweight assembly 1090 counters a centrifugal twisting moment of the fan blades 140 to help rotate the fan blades 140 when the pitch of the fan blades 140 changes.

The one or more radial thrust bearings 1080 are disposed radially at the thrust bearing radius R_{TB} defined in the radial direction R from the longitudinal centerline axis 112 to a radial center 1083 of a plurality of rolling elements 1082 of the radial thrust bearings 1080, as discussed above. The fan actuation system axial length A_{FAS} is an axial length, in the axial direction (e.g., parallel with the longitudinal centerline axis 112), from an axially forward-most surface 1015 of the fan actuation system 1000 to the pitch axis P of the fan blades 140.

As mentioned earlier, the inventors sought to address the problem implementing a variable pitch actuation system within the more limited packaging space available in a turbofan engine and while accounting for the significantly higher loading environment and more numerous blades relative to a turboprop engine. By way of testing various engine architectures the inventors experimented with different configurations of the pitch actuation system, fine and coarse pitch actuators, hydraulic actuators, and bearing placement that could sustain the higher loading associated with more numerous blades, higher disk loading, and Mach speed sufficient to satisfy operational and safety requirements in the event of, e.g., loss of hydraulic pressure. Additionally, while it was possible to arrive at such a system after experiments and testing, there was a challenge to determine how to fit the system within a comparatively more limited space of a turbofan engine.

During the course of evaluating the different embodiments as set forth herein, with the goal of providing the necessary force to pitch the fan blades, taking due account for the number of blades, accounting for loss in fluid pressure or generally lost power conditions, aerodynamic performance, cooling, aeromechanics, and disc loading/fan blade loading, etc., the inventors had discovered there was indeed much less space available for this system to operate as required for the engine's pitch actuation system. After evaluating several different architectures of pitch change mechanisms (with and without counterweight, oil transfer devices, fine and coarse pitch system, torque transfer load path for pitching blades and delivery of shaft power from gearbox, etc.—both for a ducted engine and an open fan engine—it was discovered, unexpectedly, that there is relationships among the number of fan blades, the fan tip diameter D_{FT}, the cruise Mach number, and the thrust bearing radius R_{TB}, and an axial length L_{AXIAL} capable of differentiating an architecture that satisfies operational and packaging requirements from an architecture that does not satisfy these requirements. These relationships moreover are capable of uniquely identifying a finite and readily ascertainable number of embodiments suitable for a particular architecture that accounts for the size and the loading requirements needed to pitch the fan blades without overly sacrificing the aerodynamic performance, cooling aeromechanics, and load margins on the fan blades. For example, the cruise Mach number was not expected to be a significant factor, but as discussed further below, the cruise Mach number was found to be a factor and particularly in conjunction with fan diameter at higher Mach numbers. The inventors submit that the relationships enable one to select a size for the fan pitch actuation system that can reduce the size and the weight of the fan pitch actuation system, while accounting for the factors discussed above. The inventors further submit that the relationships can help identify an improved fan efficiency, or penalties to efficiency by choosing one fan pitch actuation system architecture over another. A relationship is referred to as a fan actuation system (FAS) envelope, in relationship (1):

$$FAS envelope = \frac{{N}_{FB} \times {D}_{FT} \times {M}_{cruise}}{( \frac{{R}_{TB}}{{N}_{FB}} )} . \qquad ( 1 )$$

N_{FB} is the number of fan blades of the fan, D_{FT} is the fan tip diameter, M_{cruise} is the Mach number at cruise (mid-level power operation), and R_{TB} is the thrust bearing radius of the radial thrust bearings (any of the radial thrust bearings detailed herein). N_{FB}×D_{FT}×M_{cruise} is referred to as a loading envelope, and R_{TB}/N_{FB} is referred to as a spacing envelope. Accordingly, the FAS envelope is given by the loading envelope divided by the spacing envelope.

A second relationship is referred to as a fan actuation system length (FASL) envelope, in relationship (2):

$$FASL envelope = \frac{{N}_{FB} \times {D}_{FT}}{{L}_{AXIAL} ( \frac{{R}_{TB}}{{N}_{FB}} )} . \qquad ( 2 )$$

N_{FB} is the number of fan blades of the fan, D_{FT} is the fan tip diameter, R_{TB} is the thrust bearing radius of the radial thrust bearings, and L_{AXIAL} is an axial length, along the longitudinal centerline axis 112 from the fan hub tip 157 to the fan bearings 155. In particular, L_{AXIAL} is a summation of the fan hub axial length A_{FH} and the fan bearing axial length A_{FB}. N_{FB}×D_{FT} is referred to as a loading envelope, and L_{AXIAL}×(R_{TB}/N_{FB}) is referred to as a spacing envelope. Accordingly, the FASL envelope is given by the loading envelope divided by the spacing envelope.

As discussed further below, the inventors identified a range for the FAS envelope and the FASL envelope that enables a fan actuation system design for different turbofan engine architectures that accounts for the integrity/reliability of load paths needed to pitch the fan blades within the space constraints imposed by a turbofan engine (vs. a turboprop's space constraints). Fan pitch actuation system architectures that fall within this range are believed to satisfy packaging requirements for a turbofan engine, while those architectures that do not fall within the FAS envelope range or the FASL envelope range are believed to not satisfy the packaging requirements, which indicate that the system would be unacceptably large and not result in an aircraft engine that met aero efficiency and weight requirements (i.e., an undesirable engine architecture). Using these unique relationships, the size of the fan actuation system can be selected to achieve a more compact fan pitch actuation system for a turbofan engine. Using the FAS envelope or the FASL envelope as a guide, a fan pitch actuation system can be developed that takes into account the loading associated with pitching of the fan blades based on the size of the fan blades, the number of fan blades, the size of thrust bearing, the cruise Mach number, or the axial length, which factors were found—as a result of the extensive number of architectures considered for different thrust class engines, some successful and some not successful—to largely define the packaging size needed to accommodate a pitch actuation system capable of handling the fan loading environment.

Table 1 represents exemplary embodiments 1 to 14 and their corresponding FAS envelope and FASL envelope values for various turbofan engines at various cruise Mach numbers. Embodiments 1 to 14 may represent the turbofan engine 110 of FIG. 1 (e.g., ducted engine) or the turbofan engine 210 of FIG. 2 (e.g., unducted fan engine) and can be applied to any of the pitch actuation systems detailed herein. In particular, embodiments 7, 9, and 13 are ducted engines (e.g., such as the turbofan engine 110 of FIG. 1), and embodiments 1 to 6, 8, 10 to 12, and 14 are unducted fan engines (e.g., such as the turbofan engine 210 of FIG. 2). In Table 1, the FAS envelope values were determined based on relationship (1) described above, the FASL envelope values were determined based on relationship (2) described above, and using fan tip diameters D_{FT}, thrust bearing radiuses R_{TB}, and axial lengths L_{AXIAL} in inches.

TABLE 1

| | | D_{FT} | R_{TB} | A_{FH} | A_{FB} | | FAS | FASL |
|---|---|---|---|---|---|---|---|---|
| Emb. | N_{FB} | (in.) | (in.) | (in.) | (in.) | M_{cruise} | Envelope | Envelope |
| 1 | 12 | 156.0 | 26.9 | 60.60 | 21.60 | 0.8 | 668 | 10.2 |
| 2 | 14 | 156.0 | 24.9 | 60.60 | 20.98 | 0.8 | 982 | 15.1 |
| 3 | 14 | 154.0 | 24.7 | 59.82 | 20.92 | 0.8 | 978 | 15.1 |
| 4 | 14 | 153.8 | 24.3 | 59.75 | 20.79 | 0.8 | 992 | 15.4 |
| 5 | 14 | 164.3 | 24.6 | 63.82 | 20.89 | 0.8 | 1047 | 15.5 |
| 6 | 14 | 110.4 | 19.5 | 42.89 | 19.31 | 0.8 | 888 | 17.8 |
| 7 | 12 | 88.7 | 19.0 | 34.46 | 19.15 | 0.9 | 605 | 12.5 |
| 8 | 10 | 120.0 | 14.8 | 46.62 | 17.85 | 0.9 | 730 | 12.6 |
| 9 | 10 | 84.0 | 14.0 | 32.63 | 17.61 | 0.75 | 450 | 11.9 |
| 10 | 18 | 168.0 | 27.0 | 65.26 | 21.63 | 0.9 | 1814 | 23.2 |
| 11 | 10 | 120 | 14.0 | 46.62 | 17.61 | 0.8 | 686 | 13.3 |
| 12 | 14 | 168.0 | 19.0 | 65.26 | 19.15 | 0.88 | 1525 | 20.5 |
| 13 | 10 | 84.0 | 19.0 | 32.63 | 19.15 | 0.8 | 354 | 8.5 |
| 14 | 14 | 120.0 | 27.0 | 46.62 | 21.63 | 0.88 | 767 | 12.8 |
| 15 | 14 | 180.0 | 19.0 | 69.92 | 19.15 | 0.92 | 1708 | 20.8 |

The FAS envelope and the FASL envelope are only valid for an engine with fan blades N_{FB} in a range from ten to eighteen for a ducted engine, and from ten to sixteen for an open fan engine. In some aspects, the number of fan blades N_{FB} is in ten to fourteen for an open fan engine. The number of fan blades N_{FB} affects the volume (e.g., amount of space) circumscribed by the fan blades. Increasing the number of fan blades N_{FB} increases the amount of airflow that the fan can produce for a particular fan tip diameter and fan rotation speed, but a higher N_{FB} also reduces the tangential distance TFB between fan blades at the fan hub, which impacts the available space for pitch actuation of each individual blade, referring to the space needed per blade for pitch levers, gearing, oil transfer devices, related mechanisms for pitching fan blades and size of load bearing parts of the trunnion and related supporting structure capable of carrying the fan blade loads. This space is at a premium because with an increased number of fan blades the loading capability per blade needs to be satisfied within a smaller space compared to an engine with fewer blades (e.g., such as a turboprop engine). The FAS envelope values and the FASL envelope values account for the number of fan blades N_{FB} selected to increase the amount of airflow but without imposing an unrealistically narrow tangential fan blade distance TFB between adjacent fan blades in order to fit within the desired packaging envelope.

The FAS envelope and the FASL envelope are only valid for a fan tip diameter D_{FT} in a range from eighty-four inches to one hundred ninety-two inches (84.0 in. to 192.0 in.). In some aspects, the FAS envelope and the FASL envelope are valid for a fan tip diameter D_{FT} in a range from eighty-four inches to one hundred eighty inches (84.0 in. to 180.0 in.). In some aspects, the FAS envelope and the FASL envelope are valid for a fan tip diameter D_{FT} in a range from eighty-four inches to one hundred sixty-eight inches (84.0 in. to 168.0 in.). The fan tip diameter D_{FT} also affects the volume needed for supporting the fan blades during operation. Increasing the fan tip diameter D_{FT} increases the fan tip speed for a given rotational speed and therefore the load that needs to get reacted at the trunnion, and torque needed in the pitching mechanism for pitching the blade. The radial spacing between blades and within the volume circumscribed by the fan blades (e.g., within the space circumscribed by the radial thrust bearings) decreases, thereby decreasing the volume beneath the fan and providing less space for the load bearing structure that can react the blade loads. Furthermore, as the bearing radius R_{TB} is extended out, the structure supporting the blade at its root needs to be capable of sustaining higher loads because the blade is disposed further from the fan rotation axis. The more robust root results in a larger fan disk, further providing less space underneath the fan for the fan actuation system. In view of these weight and size considerations, as well as the ability to install such fan blades and fans without resulting in unacceptable aero efficiency penalties, the inventors determined that a fan tip diameter D_{FT} should be less than one hundred ninety-two inches (192.0 in.). In some aspects, the fan tip diameter D_{FT} should be less than one hundred eighty inches (180.0 in.). In some aspects, the fan tip diameter D_{FT} should be less than one hundred sixty-eight inches (168.0 in.). The fan tip diameter D_{FT} may therefore be limited as it impacts the space available for a pitch actuation system suitable for carrying fan blade loads. The size of the fan blades in ducted engines is limited by the duct (e.g., the nacelle). In embodiments for a ducted engine (e.g., the turbofan engine 110 of FIG. 1), the fan tip diameter D_{FT} is in a range from eighty-four inches to one hundred twenty inches (84.0 in. to 120.0 in.). In embodiments for an open fan engine (e.g., the turbofan engine 210 of FIG. 2), the fan tip diameter D_{FT} is in a range from one hundred twenty inches to one hundred ninety-two inches (120.0 in. to 192.0 in.). In some aspects for an open fan engine (e.g., the turbofan engine 210 of FIG. 2), the fan tip diameter D_{FT} is in a range from one hundred twenty inches to one hundred eighty inches (120.0 in. to 180.0 in.). In some aspects for an open fan engine (e.g., the turbofan engine 210 of FIG. 2), the fan tip diameter D_{FT} is in a range from one hundred twenty inches to one hundred sixty-eight inches (120.0 in. to 168.0 in.).

The FAS envelope and the FASL envelope are only valid for a thrust bearing radius R_{TB} in a range from ten inches to twenty-seven inches (10 in. to 27 in.). In some aspects, the thrust bearing radius R_{TB} is in a range from twelve inches to twenty-seven inches (12 in. to 27 in.). In some aspects, the thrust bearing radius R_{TB} is in a range from fourteen inches to twenty-seven inches (14 in. to 27 in.). The thrust bearing radius R_{TB} defines the amount of space, or the volume available for the fan actuation system. Increasing the thrust bearing radius R_{TB} provides more space for the fan actuation system but sacrifices aerodynamic performance by making the fan hub radius ratio (i.e., the ratio of the fan hub radius to the fan blade radius) larger. Decreasing the thrust bearing radius R_{TB} reduces the fan hub radius ratio and reduces the size of the turbofan engine but provides less space to carry the loads from the fan blades. The thrust bearing radius R_{TB} reflects the need for adequately accommodating the diameter needed for packaging the fan actuation system but without overly sacrificing aerodynamic performance of the turbofan engine. In embodiments for a ducted engine (e.g., the turbofan engine 110 of FIG. 1), the thrust bearing radius R_{TB} is in a range from twelve inches to nineteen inches (12 in. to 19 in.). In some aspects for a ducted engine, the thrust bearing radius R_{TB} is in a range from fourteen inches to nineteen inches (14 in. to 19 in.). In embodiments for an open fan engine (e.g., the turbofan engine 210 of FIG. 2), the thrust bearing radius R_{TB} is in a range from ten inches to twenty-seven inches (10 in. to 27 in.). In some aspects for an open fan engine (e.g., the turbofan engine 210 of FIG. 2), the thrust bearing radius R_{TB} is in a range from twelve inches to twenty-seven inches (12 in. to 27 in.). In some aspects for an open fan engine, the thrust bearing radius R_{TB} is in a range from nineteen inches to twenty-seven inches (19 in. to 27 in).

The FAS envelope and the FASL envelope are valid for a cruise Mach number M_{cruise} in a range from 0.7 to 0.92. In some aspects, the FAS envelope and the FASL envelope are valid for a cruise Mach number M_{cruise} in a range from 0.7 to 0.9. As mentioned above, turbofan engines operate at higher cruise speeds than turboprop engines. At higher cruise speeds, the aerodynamic loads on fan blades increase, thereby requiring more torque for actuating blades in pitch. This means a larger actuation system is needed to handle the higher reaction loads resulting when a torque is applied in flight to change the blade pitch, to move the blade to a feathered position, or coarse/fine pitch changes. The cruise Mach number M_{cruise} reflects this higher loading environment when pitching fan blades. In some aspects, the cruise Mach number M_{cruise} in a range from 0.75 to 0.9. In some aspects, the cruise Mach number M_{cruise} is in a range from 0.8 to 0.88.

The FAS envelope and the FASL envelope are only valid for a fan hub axial length A_{FH} of twenty-five inches to eighty-five inches (25 in. to 85 in.). In some aspects, the FAS envelope and the FASL envelope are only valid for a fan hub axial length A_{FH} of twenty-five inches to seventy-five inches (25 in. to 75 in.). In some aspects, the FAS envelope and the FASL envelope are only valid for a fan hub axial length A_{FH} of forty inches to eighty-five inches (40 in. to 85 in.). The fan hub axial length A_{FH} defines the amount of axial space, or the volume available for the fan actuation system, forward of the pitch axis P of the fan blades 140. Increasing the fan hub axial length A_{FH} provides more space for the fan actuation system but increases the overall weight of the turbofan engine. Decreasing the fan hub axial length A_{FH} reduces the fan performance and the pressure distribution to the fan due to a smaller axial length for the aerodynamic flow lines into the fan hub but provides less axial space to fit the fan actuation system within the fan hub 148. The fan hub axial length A_{FH} reflects the need for aerodynamic performance for the fan and adequately accommodating the axial length needed for packaging the fan actuation system but without overly sacrificing aerodynamic performance of the turbofan engine and allowing for a more efficient fan actuation system. In embodiments for a ducted engine (e.g., the turbofan engine 110 of FIG. 1), the fan hub axial length A_{FH} is in a range from twenty-five inches to forty inches (25 in. to 40 in.). In some aspects for an open fan engine (e.g., the turbofan engine 210 of FIG. 2), the fan hub axial length A_{FH} is in a range from twenty-five inches to seventy-five inches (25 in. to 75 in). In some aspects for an open fan engine (e.g., the turbofan engine 210 of FIG. 2), the fan hub axial length A_{FH} is in a range from forty inches to eighty-five inches (40 in. to 85 in). In this way, the fan hub axial length A_{FH} is greater for open fan engines as compared to ducted fan engines as more space is needed due to the longer fan blades of the open fan engines as compared to the ducted engines.

The FAS envelope and the FASL envelope are only valid for a fan bearing axial length A_{FB} of ten inches to twenty-three inches (10 in. to 23 in.). In some aspects, the FAS envelope and the FASL envelope are only valid for a fan bearing axial length A_{FB} of sixteen inches to twenty-three inches (16 in. to 23 in.). The fan bearing axial length A_{FB} defines the amount of axial space, or the volume available for the fan actuation system, aft of the pitch axis P of the fan blades 140. Increasing the fan bearing axial length A_{FB} provides more space for the fan actuation system but increases the overall weight of the engine and increases loads on the bearings. Decreasing the fan bearing axial length A_{FB} decreases overall engine weight and reduces loads on the bearings but provides less axial space to fit the fan actuation system within the fan hub 148. The fan bearing axial length A_{FB} reflects the need for adequately accommodating the axial length needed for packaging the fan actuation system while minimizing the fan bearing axial length A_{FB} to reduce loads on the bearings and reduce overall weight of the engine. In embodiments for a ducted engine (e.g., the turbofan engine 110 of FIG. 1), the fan hub axial length A_{FH} is in a range from seventeen inches to twenty inches (17 in. to 20 in.). In embodiments for an open fan engine (e.g., the turbofan engine 210 of FIG. 2), the fan hub axial length A_{FH} is in a range from ten inches to twenty-three inches (10 in. to 23 in). In some aspects for an open fan engine (e.g., the turbofan engine 210 of FIG. 2), the fan hub axial length A_{FH} is in a range from sixteen inches to twenty-three inches (16 in. to 23 in).

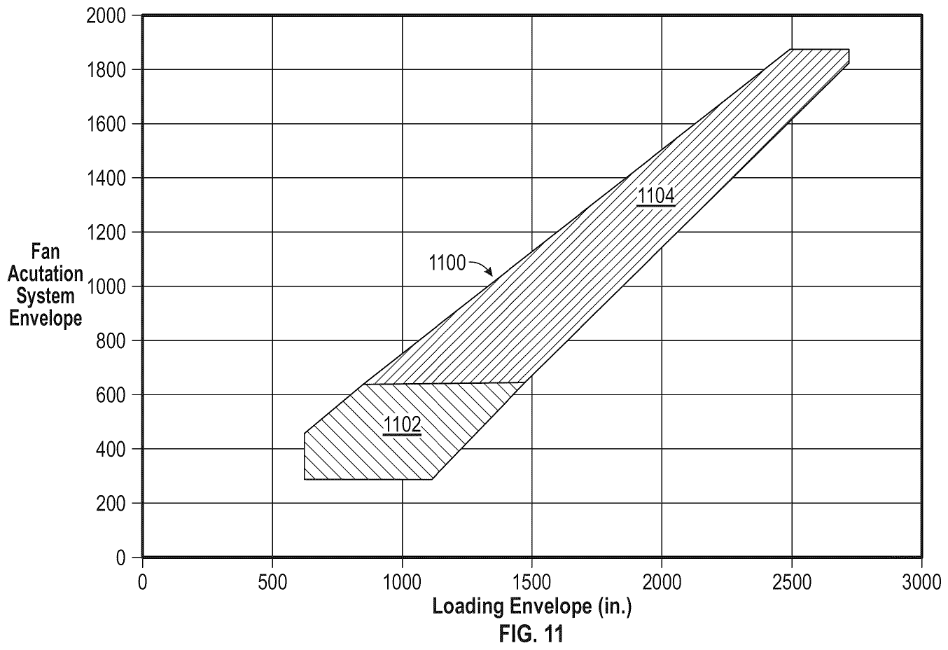

FIG. 11 represents, in graph form, the FAS envelope as a function of the loading envelope (N_{FB}×D_{FT}×M_{cruise}). An area 1100 represents the boundaries of the FAS envelope. The FAS envelope is in a range from three hundred to one thousand eight hundred sixty (300 to 1860) for a loading envelope in a range from five hundred eighty-eight inches to two thousand seven hundred twenty-two inches (588 in. to 2722 in.). Table 1 and FIG. 11 show that the FAS envelope increases as the loading envelope increases. In this way, the FAS envelope increases as the number of fan blades N_{FB}, the fan tip diameter D_{FT}, or the cruise Mach number M_{cruise} increase. The range of the FAS envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine.

A first area 1102 represents the boundaries of the FAS envelope for ducted engines, such as, for example, the turbofan engine 110 of FIG. 1. A second area 1104 represents the boundaries of the FAS envelope for unducted fan engines, such as, for example, the turbofan engine 210 of FIG. 2. Ducted engines tend to have more limited space for the fan actuation system due to the presence of a fan casing, fan duct, or outer nacelle. On the other hand, the fan actuation system of ducted engines are expected to experience lower loads associated with supporting fan blades and pitching fan blades due to the fan blades having a smaller diameter compared to an open fan engine. The FAS envelope, represented by the first area 1102, is in a range from three hundred to six hundred sixty (300 to 660) for ducted engines. The FAS envelope, represented by the second area 1104, is in a range from six hundred sixty to one thousand eight hundred sixty (660 to 1860) and, preferably, in a range from six hundred sixty to one thousand twenty (660 to 1020) and includes open fan engines.

FIG. 12 represents, in graph form, the FAS envelope as a function of the spacing envelope (R_{TB}/N_{FB}). An area 1200 represents the boundaries of the FAS envelope. The FAS envelope is in a range from three hundred to one thousand eight hundred sixty (300 to 1860) for a spacing envelope in a range from one point three five inches to two point two five inches (1.35 in. to 2.25 in.). Table 1 and FIG. 12 show that the FAS envelope decreases as the spacing envelope increases. In this way, the FAS envelope decreases as the thrust bearing radius R_{TB} increases or the number of fan blades N_{FB} decreases. A first area 1202 represents the boundaries of the FAS envelope for ducted engines, and is in a range from three hundred to six hundred sixty (300 to 660) for ducted engines, as detailed above. A second area 1204 represents the boundaries of the FAS envelope for unducted fan engines, and is in a range from six hundred sixty to one thousand eight hundred sixty (660 to 1860) and, preferably, in a range from six hundred sixty to one thousand twenty (660 to 1020), as detailed above.

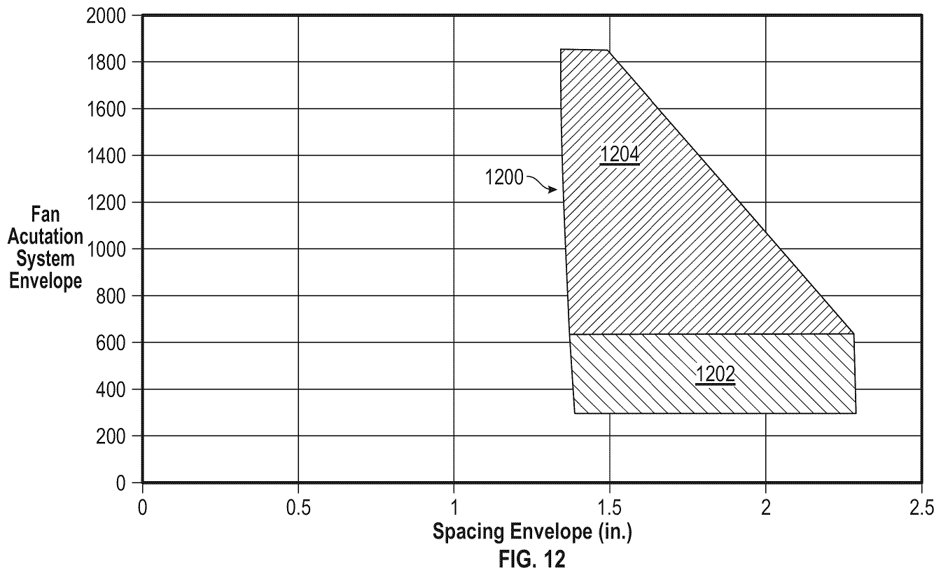

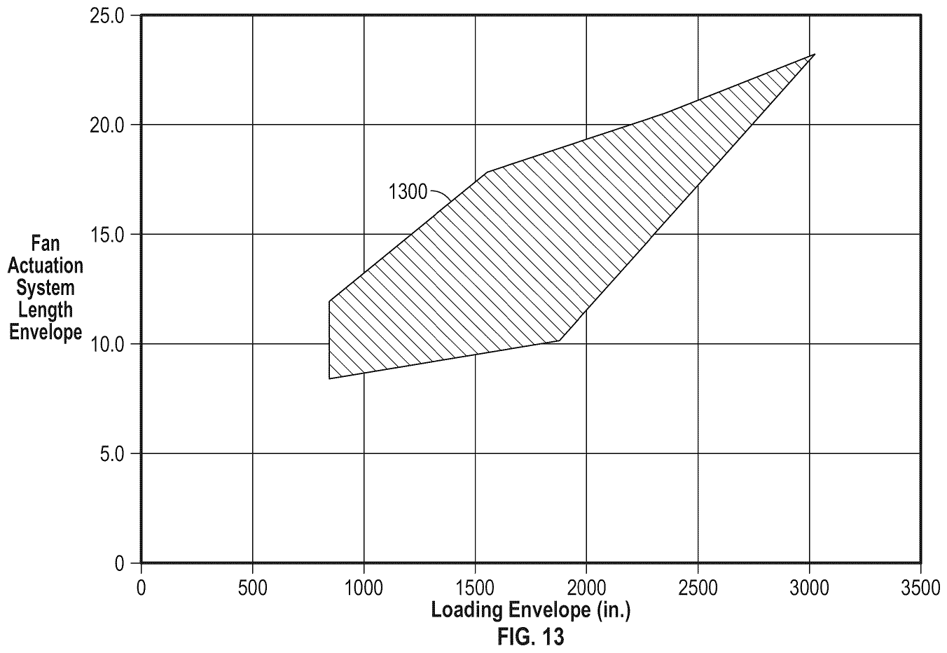

FIG. 13 represents, in graph form, the FASL envelope as a function of the loading envelope (N_{FB}×D_{FT}). An area 1300 represents the boundaries of the FASL envelope. The FASL envelope is in a range from eight point five to twenty-four (8.5 to 24) for a loading envelope in a range from eight hundred forty inches to three thousand twenty-four inches (840 in. to 3,024 in.). Table 1 and FIG. 13 show that the FASL envelope increases as the loading envelope increases. In this way, the FASL envelope increases as the number of fan blades N_{FB} or the fan tip diameter D_{FT} increase. The range of the FASL envelope identifies the specific architectures that can accommodate the fan pitch actuation system, accounting for both the mechanisms and structural load paths needed to pitch the fan blades under an aerodynamic loading, but without exceeding the volume available for packaging the pitch actuation system within the limited space of a turbofan engine. As mentioned above, ducted engines tend to have more limited space for the fan actuation system due to the presence of a fan casing, fan duct, or outer nacelle, while experiencing lower loads associated with supporting fan blades and pitching fan blades due to the fan blades having a smaller diameter compared to an open fan engine. For ducted engines, the FASL envelope is in a range from eight point five to thirteen (8.5 to 13).

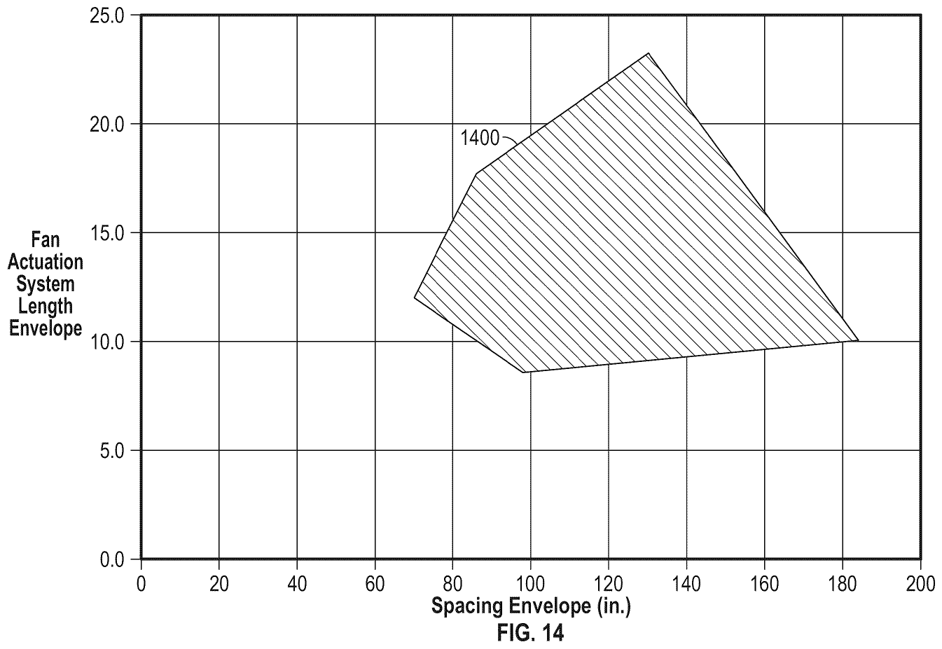

FIG. 14 represents, in graph form, the FASL envelope as a function of the spacing envelope L_{AXIAL}×(R_{TB}/N_{FB}). An area 1400 represents the boundaries of the FASL envelope. The FASL envelope is in a range from eight point five to twenty-four (8.5 to 24) for a spacing envelope in a range from seventy square inches to one hundred eighty-five square inches (70 in.² to 185 in.²). Table 1 and FIG. 14 show that the FASL envelope decreases as the spacing envelope increases. In this way, the FASL envelope decreases as the thrust bearing radius R_{TB} increases, or the number of fan blades N_{FB} or the axial length L_{AXIAL} decreases. As mentioned above, for ducted engines, the FASL envelope is in a range from eight point five to thirteen (8.5 to 13).

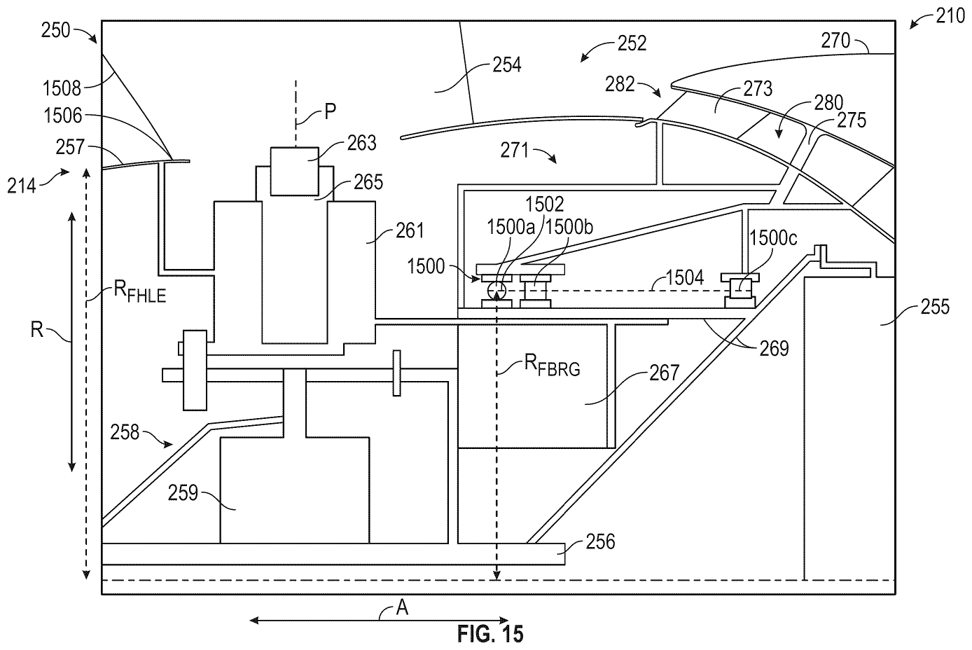

The FAS envelope and the FASL envelope herein provide a fan actuation system a low fan hub radius ratio (a ratio of the hub radius of the blades to the tip radius of the blades of the fan) and a high fan blade count. In one example, a low hub fan radius ratio is in a range from 0.22 to 0.30. This allows the fan diameter to be minimized to meet competing efficiency and installation requirements. To further enable a low fan hub radius ratio, the turbofan engine can include a relatively high fan bearing radius relative to the fan hub radius, as detailed further below with respect to FIGS. 15 to 20. Such a high fan bearing radius allows for a desired packaging of, e.g., the fan actuation system and the fan counterweights. The increased fan bearing radius allows the fan bearings to carry the forward thrust load of the turbofan engine while minimizing, e.g., any moments on the fan bearings in the event of a variation in a distribution of the forward thrust load on the fan bearings. In this way, the high fan bearing radius allows for a variable pitch fan (e.g., the inclusion of a fan actuation system) while maintaining a low fan hub radius ratio and a smaller outer casing, which provides for less drag and a larger frontal area for a given fan blade size.

FIG. 15 is a schematic view of the forward end 214 of the fan assembly 250 of the turbofan engine 210 of FIG. 2. As depicted in FIG. 15, each fan blade 254 defines a base 263 at an inner end along a radial direction R. Each fan blade 254 is coupled at the base 263 to a disk 261 via a trunnion mechanism 265. In FIG. 15, the base 263 is configured as a dovetail received within a correspondingly shaped dovetail slot of the trunnion mechanism 265. In other aspects, the base 263 may be attached to the trunnion mechanism 265 in any other suitable manner. For example, the base 263 may be attached to the trunnion mechanism 265 using a pinned connection, or any other suitable connection. In still other aspects, the base 263 may be formed integrally with the trunnion mechanism 265. Notably, the trunnion mechanism 265 facilitates rotation of a respective fan blade 254 about the pitch axis P of the respective fan blades 254. The fan assembly 250 can also include one or more fan counterweights 267 to balance the fan 252 during operation. Further, the disk 261 is attached to the gearbox assembly 255 through the fan shaft 256, which includes one or more individual structural members 269.

The fan assembly 250 includes a fan frame 271 that is connected to the fan cowl 270 through an inlet vane 273 and a strut 275. In this way, the fan frame 271 is a static or a stationary component that supports static components of the fan assembly 250. While the fan frame 271 is depicted as being connected to the fan cowl 270 through both the inlet vane 273 and the strut 275, the fan frame 271 can be connected to the fan cowl 270 through at least one of the inlet vane 273 or the strut 275.

The fan assembly 250 also includes one or more fan bearings 1500 for supporting rotation of the various rotating components of the fan assembly 250, such as the plurality of fan blades 254 via the fan shaft 256 and the disk 261. More particularly, the various rotating components of the fan assembly 250 rotate with respect to the fan frame 271 via the one or more fan bearings 1500. In FIG. 15, the one or more fan bearings 1500 includes a first fan bearing 1500a, a second fan bearing 1500b, and a third fan bearing 1500c. The first fan bearing 1500a is a ball bearing, the second fan bearing 1500b is a roller bearing, and the third fan bearing 1500c is a roller bearing. The first fan bearing 1500a is positioned forward of the second fan bearing 1500b and the third fan bearing 1500c. The fan bearings 1500 can include any other suitable number or type of bearings for supporting rotation of the plurality of fan blades 254. For example, the one or more fan bearings 1500 can include a pair (two) tapered roller bearings, or any other suitable bearings.

Referring still to FIG. 15, the one or more fan bearings 1500 are located axially aft of the disk 261 and the trunnion mechanisms 265 and radially outward of the one or more actuators 259 along the radial direction R and also outward of the one or more fan counterweights 267 along the radial direction R. In particular, the fan bearings 1500 are located axially between the disk 261 and the gearbox assembly 255. Such a configuration of the fan bearings 1500 allows for the actuators 259 to be axially aligned with the disk 261 and the trunnion mechanisms 265 along the axial direction A and radially inward of the disk 261 and the trunnion mechanisms 265 along the radial direction R. Moreover, such a configuration allows for the one or more fan counterweights 267 to be positioned adjacent to the one or more actuators 259.

As shown in FIG. 15, the one or more fan bearings 1500 define a fan bearing radius R_{FBRG} along the radial direction R. The fan bearing radius R_{FBRG} is defined as a distance along the radial direction R from the longitudinal centerline axis 212 of the turbofan engine 210 to a central axis or a center point of the one or more fan bearings 1500. More particularly, each of the first fan bearing 1500a, the second fan bearing 1500b, and the third fan bearing 1500c are radially aligned such that a center point 1502 of the first fan bearing 1500a and a central axis 1504 of the second fan bearing 1500b and the third fan bearing 1500c are each positioned at the same radial distance from the longitudinal centerline axis 212. In some aspects, one or more of the fan bearings 1500 may be stepped or otherwise positioned at different distances from the longitudinal centerline axis 212 along the radial direction R. In such aspects, the fan bearing radius R_{FBRG} refers to a radius of the innermost fan bearing 1500 along the radial direction R (i.e., a distance of the central point 1502 or the center axis 1504 of the innermost fan bearing 1500 along the radial direction R to the longitudinal centerline axis 212).

The fan hub 257 defines a fan hub leading edge radius R_{FHLE} along the radial direction R. The fan hub leading edge radius R_{FHLE} is defined as a radial distance of an outermost point of the fan hub 257 along the radial direction R to the longitudinal centerline axis 212 of the turbofan engine 210. In particular, the fan hub leading edge radius R_{FHLE} is a distance along the radial direction R from the longitudinal centerline axis 212 to a radially innermost point 1506 of a leading edge 1508 of the fan blades 254 (to the fan root 251 at the leading edge 1508. The fan hub leading edge radius R_{FHLE} is indicative of an overall size of a core portion of the fan assembly 250. Accordingly, the fan assembly 250 defines a fan bearing radius ratio R_{FHLE}:R_{FBRG} (i.e., a ratio of the fan hub leading edge radius R_{FHLE} to the fan bearing radius R_{FBRG}) in a range from 1.0 to 2.75. In some aspects, the fan bearing radius ratio is less than or equal to 2.75, such as less than or equal to 2.5, such as less than or equal to 2.0, such as less than or equal to 1.75. More particularly, the hub radius to fan bearing radius ratio R_{FHLE}:R_{FBRG} is greater than or equal to 1.0 and less than or equal to 1.5.

The plurality of fan blades 254 are rotatable about the axial direction A at a maximum rotational speed during operation of the fan assembly 250. The maximum rotational speed refers to a maximum speed at which the fan blades 254 are configured to rotate during a full power condition of the turbofan engine 210, such as when the turbofan engine 210 is generating a maximum takeoff thrust. The one or more fan bearings 1500 supporting rotation of the plurality of fan blades 254 may define a DN value during operation of the fan assembly 250 and rotation of the plurality of fan blades 254 at the maximum rotational speed of at least about 0.6 million. For example, in certain exemplary embodiments, the one or more fan bearings 1500 supporting rotation of the plurality of fan blades 254 may define a DN value during rotation of the plurality of fan blades 254 of at least 0.7 million, at least 0.8 million, at least 1 million, or at least 1.5 million. As used herein, the term “DN value” refers to a fan bearing speed quantifier calculated by multiplying a bore of the bearing in millimeters by a rotational speed in revolutions per minute (RPM). The bore of the one or more fan bearings 1500 supporting rotation of the plurality of fan blades 254 of the fan assembly 250 refers to a distance from the longitudinal centerline axis 112 to an inner race of the one or more fan bearings 1500.

Accordingly, in order to maintain the DN value of the one or more fan bearings 1500 below one or more of the above stated DN values, the fan assembly 250 may define a relatively low maximum rotational speed during operation. For example, in certain exemplary embodiments, the fan assembly 250 may define a maximum rotational speed in a range from 300 RPM to 8,500 RPM during operation. In some aspects, the maximum rotational speed is less than 8,500 RPM during operation. More specifically, in certain exemplary embodiments, the fan assembly 250 may define a maximum rotational speed of less than 8,000 RPM during operation, less than 7,500 rpm during operation, less than 7,000 RPM during operation, less than 6,500 rpm during operation, or less than 6,000 RPM during operation. In some aspects, the maximum rotational speed is in a range from 300 RPM to 1,100 RPM during operation.

As discussed above, inclusion of a relatively high fan bearing radius relative to a fan hub radius may allow for a desired packaging of, e.g., the fan actuation system and one or more fan counterweights in the fan assembly of the turbofan engine. Moreover, when the turbofan engine is an indirect drive turbofan engine (e.g., including a gearbox connecting a driveshaft and a fan shaft while reducing a rotational speed of the fan shaft relative to the driveshaft) the increased fan bearing radius may additionally provide for a more stable fan during operation. Specifically, with direct drive turbofan engine (e.g., without a gearbox), a forward thrust load generated by the fan during operation may be counteracted by a reverse thrust load generated by the turbine section of the turbofan engine (the turbine section being directly connected to the fan via a shaft in such a configuration). By contrast, within an indirect drive turbofan engine, such as the turbofan engine 110 depicted in FIG. 1 and the turbofan engine 210 in FIG. 2, the forward ball bearing (e.g., the first fan bearing 1500a) is required to carry substantially all of an amount of forward thrust generated by the fan during operation, as the gearbox assembly prevents the LP shaft from offsetting such forward thrust load of the fan with a reverse thrust load of the turbine section. Accordingly, the increased fan bearing radius allows the one or more fan bearings to carry the forward thrust load while minimizing, e.g., any moments on such one or more fan bearings in the event of a variation in a distribution of the forward thrust load on the one or more fan bearings.

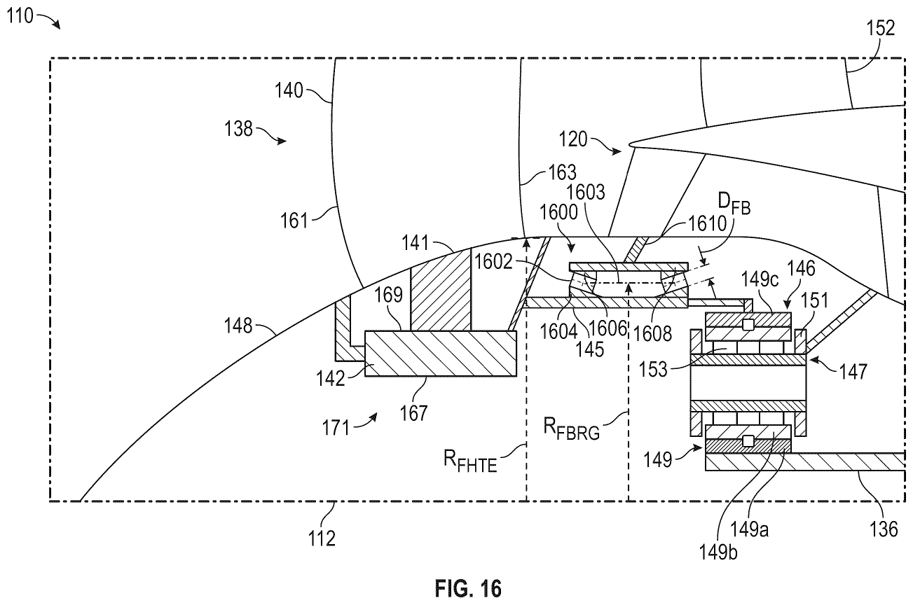

FIG. 16 is an enlarged, schematic, cross-sectional diagram of the turbofan engine 110 of FIG. 1 and having one or more fan bearings 1600, taken along the longitudinal centerline axis 112, according to the present disclosure. While FIG. 16 shows the turbofan engine 110 of FIG. 1, the fan bearings 1600 can also be implemented in the turbofan engine 210 of FIG. 2. FIG. 16 shows one fan blade 140 of the fan 138, the fan disk 142, the core inlet 120, and the gearbox assembly 146. Further, although not shown for clarity, the turbofan engine 110 can include any of the fan actuation systems disclosed herein.

The fan shaft 145 is coupled to the fan disk 142 such that rotation of the fan shaft 145 causes the plurality of fan blades 140 to rotate about the longitudinal centerline axis 112. Each of the fan blades 140 extends from a leading edge 161 and a trailing edge 163. The fan root 141 is at the fan hub 148. The fan disk 142 is defined between an inner surface 167 and an outer surface 169. The inner surface 167 is a radially-most inner surface of the fan disk 142 and the outer surface 169 is a radially-most outer surface of the fan disk 142. The fan disk 142 includes a disk bore 171 defined by the inner surface 167 of the fan disk 142. In particular, the disk bore 171 is defined from the longitudinal centerline axis 112 to the inner surface 167. The fan hub 148 includes a fan hub trailing edge radius R_{FHTE} that is defined in the radial direction from the longitudinal centerline axis 112 to the fan hub 148 at the trailing edge 163 of the fan blades 140.

The turbofan engine 110 also has a fan hub radius ratio that is defined as a ratio of the fan hub trailing edge radius R_{FHTE} to a fan tip radius of the fan blades 140 (e.g., the radius from the longitudinal centerline axis 112 to the fan tip 143 at the trailing edge 163 of the fan blades 140). The fan hub radius ratio is in a range from 0.1 to 0.4. Lower fan hub radius ratios result in lower core engine inlets. A lower fan hub radius and a lower core engine inlet radius result in a core engine with a lesser diameter (e.g., smaller core engine), and, thus, a reduced overall engine weight, as compared to turbofan engines with fan hub radius ratios greater than 0.4. In some aspects, the fan hub radius ratio is in a range from 0.15 to 0.32. In some aspects, the fan hub radius ratio is in a range from 0.2 to 0.35. In some aspects, the fan hub radius ratio is in a range from 0.2 to 0.3. The lower fan hub can also reduce the probability of foreign object damage (FOD), such as, for example, from bird strikes, in the core engine, as the fan tends to push the foreign objects radially outward by the centripetal force imparted to the foreign object by the spinning fan blades. A lower fan hub also improves aerodynamic efficiency of the fan. The lower fan hub radius ratios disclosed herein are enabled by the fan actuation system being characterized by the FASL as detailed above. In particular, the FASL enables a smaller fan actuation system to fit within a tighter packaging underneath the fan while ensuring the fan actuation system can provide an adequate force or torque to pitch the fan blades in the higher loading environment of a turbofan engine (as compared to a turboprop engine). In this way, if the fan actuation system has a FASL that falls within the ranges detailed above, the fan hub radius ratio can be made lower to achieve the improved aerodynamic efficiency of the fan in guiding the incoming airflow into the core inlet.

The fan bearings 1600 are radial thrust (radial shaft load) bearings that transmit a load (e.g., the radial shaft load) from the fan shaft 145 to a static structure of the turbofan engine 110. The fan bearings 1600 each includes one or more rolling elements 1602, an inner race 1604, and an outer race 1606. The fan bearings 1600 support rotation of the fan shaft 145. In FIG. 16, fan bearings 1600 include a forward fan bearing and an aft fan bearing. The rolling elements 1602 are tapered rolling elements that include tapered cylindrical bodies and are disposed between the inner race 1604 and the outer race 1606. In this way, the one or more fan bearings 1600 are roller bearings. The outer race 1606 of each of the fan bearings 1600 is connected to a fan bearing support member 1608. The fan bearing support member 1608 is connected to a fan bearing housing 1610 that is connected to a static component of the turbofan engine 110. The inner race 1604 is connected to the fan shaft 145. In this way, the fan bearings 1600 are connected to the static component and to the fan shaft 145 such that the inner race 1604, and the rolling elements 1602, rotates with respect to the outer race 1606, such that the fan bearings 1600 support rotation of the fan shaft 145.

The fan bearings 1600 are positioned aft, and radially outward, of the fan disk 142. In particular, the fan bearings 1600 are positioned entirely axially aft of the fan disk 142 and entirely radially outward of the fan disk 142 (e.g., radially outward of the outer surface 169 of the fan disk 142). In this way, the fan bearings 1600 are positioned radially outward of the disk bore 171 (e.g., of the inner surface 167) of the fan disk 142. The fan bearings 1600 are positioned axially between the fan disk 142 and the gearbox assembly 146. Further, the fan bearings 1600 are positioned radially outward of the gearbox assembly 146, particularly, radially outward of the third gear 149c.

The fan bearings 1600 have a fan bearing radius R_{FBRG} that is defined in the radial direction from the longitudinal centerline axis 112 to a radial center 1603 of the fan bearings 1600. Particularly, the radial center 1603 of the fan bearings 1600 is the radial center 1603 of the rolling elements 1602. The fan bearings 1600 also have a rolling element diameter DFB of the rolling elements 1602 that is defined as a distance of a straight line passing from side to side of a respective rolling element 1602 through a center (e.g., the radial center 1603) of the respective rolling element 1602.

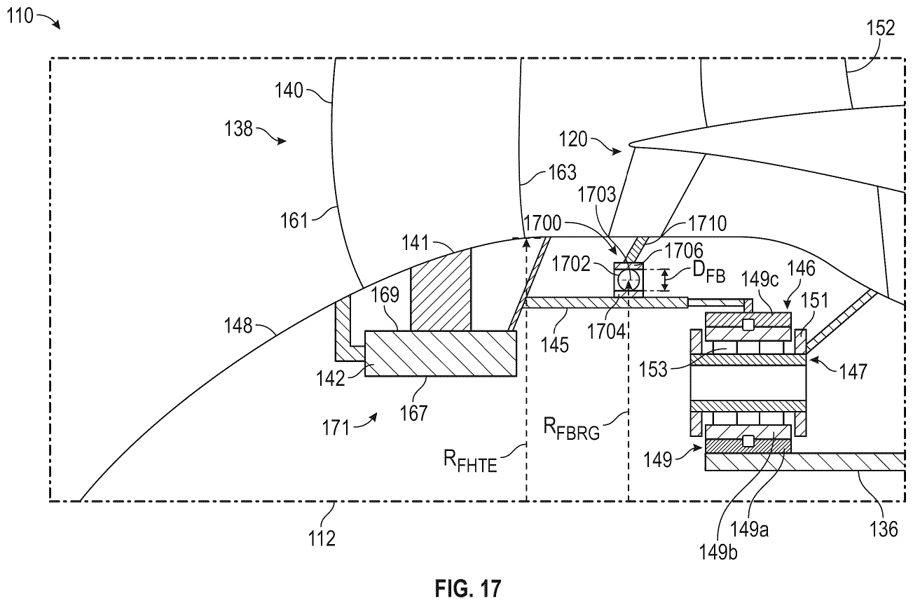

FIG. 17 is an enlarged, schematic, cross-sectional diagram of the turbofan engine 110 and having one or more fan bearings 1700, taken along the longitudinal centerline axis 112, according to another aspect. The fan bearings 1700 are substantially similar to the fan bearings 1600 of FIG. 16. The same reference numerals will be used for components of the fan bearings 1700 that are the same as or similar to the components of the fan bearings 1600 discussed above. The description of these components above also applies to this embodiment, and a detailed description of these components is omitted here.

The fan bearings 1700 each includes one or more rolling elements 1702, an inner race 1704, and an outer race 1706. The fan bearings 1700 support rotation of the fan shaft 145. The rolling elements 1702 are balls that are disposed between the inner race 1704 and the outer race 1706. In this way, the fan bearings 1700 are ball bearings. The turbofan engine 110 also includes a fan bearing housing 1710.

The fan bearings 1700 are positioned aft, and radially outward, of the fan disk 142. In particular, the fan bearings 1700 are positioned entirely axially aft of the fan disk 142 and entirely radially outward of the fan disk 142 (e.g., radially outward of the outer surface 169 of the fan disk 142). In this way, the fan bearings 1700 are positioned radially outward of the disk bore 171 (e.g., of the inner surface 167) of the fan disk 142. The fan bearings 1700 are positioned axially between the fan disk 142 and the gearbox assembly 146. Further, the fan bearings 1700 are positioned radially outward of the gearbox assembly 146, particularly, radially outward of the third gear 149c.

The fan bearings 1700 have a fan bearing radius R_{FBRG} that is defined in the radial direction from the longitudinal centerline axis 112 to a radial center 1703 of the fan bearings 1700 (e.g., of the rolling elements 1702). The fan bearings 1700 also have a rolling element diameter DFB of the rolling elements 1702 that is defined as a distance of a straight line passing from side to side of a respective rolling element 1702 through a center (e.g., the radial center 1703) of the respective rolling element 1702.

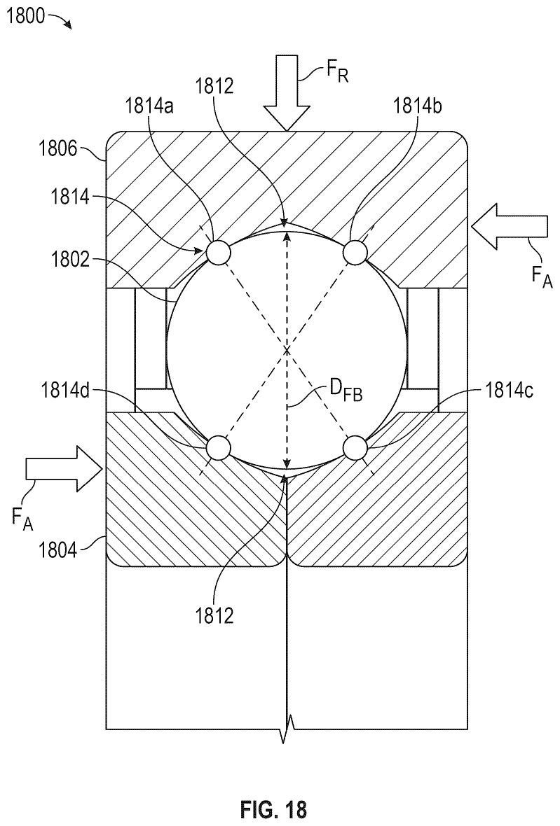

FIG. 18 is a schematic cross-sectional view of a fan bearing 1800 for the turbofan engine 110, according to another aspect. The fan bearing 1800 can be utilized as any of the fan bearings detailed herein. The fan bearing includes one or more rolling elements 1802, an inner race 1804, and an outer race 1806. In some embodiments, the inner race 1804 has a split ring configuration to facilitate easier mounting of the bearing and improved precision. In some embodiments, each of the inner race 1804 and the outer race 1806 defines a concavity having an arch 1812 to allow the rolling element 1802 to have four contact points 1814 with the inner race 1804 and the outer race 1806. In particular, the fan bearing 1800 has two contact points, including a first contact point 1814a and a second contact point 1814b, on the outer race 1806 and two contact points, including a third contact point 1814c and a fourth contact point 1814d, on the inner race 1804. In this way, the fan bearing 1800 is a four-point contact ball bearing. The four-point contact design allows the fan bearing 1800 to handle both radial loads FR and axial loads FA by transmitting the load between the second contact point 1814b and the fourth contact point 1814d, and between the first contact point 1814a and the third contact point 1814c.

In some embodiments, the fan bearing 1800 has a tight bearing configuration, i.e., there is minimal clearance between the rolling elements 1802 and the inner race 1804 and the outer race 1806. In particular, the clearance between the rolling elements 1802 and the inner race 1804 and the outer race 1806 is dimensioned to limit axial movement of the fan shaft 145 (FIG. 1) in relation to the gearbox assembly 146 (FIG. 1) to no greater than 0.010 inches or 10 mil. In some embodiments, the clearance between the rolling elements 1802 and the inner race 1804 and the outer race 1806 is dimensioned to limit axial movement of the fan shaft 145 to no greater than 0.007 inches or 7 mil. The fan bearing 1800 limits axial endplay, i.e., axial movement of the fan shaft 145 in relation to the gearbox assembly 146, thus protecting the gearbox assembly 146 from excessive stress and facilitating a reduction in size and extension of the life of the gearbox assembly 146.

The fan bearing 1800 is designed to withstand extreme conditions including high temperatures, high loads, and high rotational speeds. The materials used to construct the fan bearing 1800 are selected to maximize durability, temperature resistance, and fatigue life. In some embodiments, the fan bearing 1800 can be formed from steel, steel alloys, ceramic materials, cobalt and nickel-based superalloys, or polytetrafluoroethylene (PTFE) and phenolic resins. In addition, the fan bearing 1800 may include coatings, such as, for example, titanium nitride or other anti-friction coatings to further reduce wear and to minimize friction.

The fan bearings of FIGS. 15 to 18 are designed to address the problem of sizing the fan bearings to account for the stresses encountered from the fan shaft, while balancing for minimizing the space under the fan for the fan bearings and other fan components, as well as providing a required amount of thrust for a particular size of the turbofan engine. Additionally, the fan bearings address the challenge in reducing the inner radius of the engine flow path and lowering the fan hub radius ratio, while increasing the fan bearing radius.

Moving the fan bearings aft of the fan disk and increasing the fan bearing radius provide for a reduction in the inner radius of the flow path and the fan hub radius, without overly increasing the heat load on the fan bearings. Further, moving the fan bearings radially outward enables a greater number of rolling elements, which results in a reduced rolling element diameter.

The set of novel embodiments detailed herein include several different architectures of fan bearings and turbofan engines with various sizes and locations. A set of fan bearing designs, producing favorable results, can be characterized by a combination of the fan hub trailing edge radius, the fan bearing radius, the rolling element diameter, and the takeoff thrust, capable of differentiating an architecture that satisfies the operational requirements (e.g., fan bearings capable of handling the stresses from the fan shaft) and the packaging requirements (e.g., lowering the fan hub radius and the inner radius of the flow path) from an architecture that does not satisfy these requirements. As such, a finite and readily ascertainable number of embodiments of the fan bearings account for the operational requirements and the packaging requirements without overly increasing the fan bearing heat load. The novel designs are based on a size of the fan bearings, a size of the rolling elements, and a location of the fan bearings that can reduce the size and the weight of the turbofan engine, while accounting for the factors discussed above. These novel designs can be characterized as a fan bearing envelope (FBE), as set forth in expression (3):

$$FBE = ( \frac{{R}_{FBRG}}{{R}_{FHTE}} ) \times ( \frac{{D}_{FB}}{( \frac{{Thrust}_{TO}}{1000} )} ) . \qquad ( 3 )$$

In expression (3), R_{FBRG} is the fan bearing radius, R_{FHTE} is the fan hub trailing edge radius, DFB is the rolling element diameter, and Thrust_{TO} is the takeoff thrust of the turbofan engine. The takeoff thrust Thrust_{TO} is a high power operation (e.g., greater than 85% of the SLS maximum engine rated thrust) of the turbofan engine during a takeoff condition of the aircraft.

As discussed further below, the fan bearings include fan bearing designs for different turbofan engine architectures that accounts for handling the stresses from the fan shaft during operation, while reducing the fan hub radius, and, thus, providing for an improved specific flow through the fan and reducing the fan diameter required to achieve a certain thrust or reduces the fan pressure ratio and improves propulsive efficiency of the fan. These improved fan bearing designs can be characterized according to a defined range for the FBE.

Table 2 below represents exemplary embodiments 16 to 27 and their corresponding FBE values for various turbofan engines and fan bearings. Embodiments 16 to 27 may represent the turbofan engine 110 of FIG. 1 (e.g., ducted engine) or the turbofan engine 210 of FIG. 2 (e.g., unducted fan engine) and can be applied to any of the fan bearings detailed herein. In Table 2, the FBE values were determined based on expression (3) described above, and using fan hub trailing edge radius, fan bearing radius, fan bearing diameter values in millimeters and takeoff thrust values in kilo-Newtons. In particular, embodiments 16, 17, 22, 24, and 26 are tapered roller bearings (e.g., the fan bearings 1600 of FIG. 16). Embodiments 18 to 21, 23, 25, and 27 are ball bearings (e.g., the fan bearings 1700 of FIG. 17 or the fan bearing 1800 of FIG. 18).

TABLE 2

| | | | | | | Fan Bearing |
|---|---|---|---|---|---|---|
| | R_{FHTE} | R_{FBRG} | R_{FBRG}/ | D_{FB} | Thrust_{TO} | Envelope |
| Emb. | (mm) | (mm) | R_{FHTE} | (mm) | (kN) | (FBE) |
| 16 | 360.934 | 212.09 | 0.588 | 19.05 | 155.688 | 71.901 |
| 17 | 628.396 | 312.42 | 0.497 | 19.05 | 155.688 | 60.834 |
| 18 | 360.934 | 212.09 | 0.588 | 50.80 | 155.688 | 191.735 |
| 19 | 628.396 | 312.42 | 0.497 | 50.80 | 155.688 | 162.224 |
| 20 | 360.934 | 212.09 | 0.588 | 57.15 | 155.688 | 215.702 |
| 21 | 360.934 | 212.09 | 0.588 | 63.50 | 155.688 | 239.669 |
| 22 | 103.124 | 60.60 | 0.588 | 5.00 | 44.482 | 66.050 |
| 23 | 103.124 | 60.60 | 0.588 | 15.00 | 44.482 | 198.151 |
| 24 | 902.335 | 530.23 | 0.588 | 50.80 | 389.220 | 76.694 |
| 25 | 902.335 | 530.23 | 0.588 | 127.00 | 389.220 | 191.735 |
| 26 | 1191.082 | 699.90 | 0.588 | 63.50 | 513.770 | 72.627 |
| 27 | 1191.082 | 699.90 | 0.588 | 170.00 | 513.770 | 194.434 |

The fan bearing designs provide the aforementioned benefits including achieving a lower radius ratio (ratio of hub to fan tip radii) for a rated thrust, or a percentage thereof at takeoff. During the course of creating those designs it was determined what ranges would be suitable to achieve the desired results, while taking into account fan shaft stresses, packaging and accessibility, reliability and lubrication requirements for the engine. The values for terms used to compute an FBE value are strictly limited to certain ranges based on the various designs evaluated where those values had varied. Otherwise, the engine made will not produce the favorable results.

The FBE is only valid for a fan hub trailing edge radius R_{FHTE} in a range from ninety millimeters (90 mm) to one thousand two hundred millimeters (1,200 mm). In some embodiments, the fan hub trailing edge radius R_{FHTE} is in a range from one hundred millimeters (100 mm) to nine hundred millimeters (900 mm). The ranges of the fan hub trailing edge radius R_{FHTE} provide for a fan hub radius ratio that satisfies the operational requirements and the packaging requirements of a particular engine without overly increasing the fan bearing heat load. Values of the fan hub trailing edge radius R_{FHTE} outside of the ranges disclosed herein either have a fan hub radius ratio that is too small such that the fan bearings cannot be packaged under the fan disk or too great such that the aerodynamic efficiency of the fan is reduced.

The FBE is only valid for a fan bearing radius R_{FBRG} in a range from fifty millimeters (50 mm) to seven hundred millimeters (700 mm). In some embodiments, the fan bearing radius R_{FBRG} is in a range from sixty millimeters (60 mm) to five hundred fifty millimeters (550 mm). The ranges of the fan bearing radius R_{FBRG} provide for a lower fan hub radius ratio that satisfies the operational requirements and the packaging requirements of a particular engine without overly increasing the fan bearing heat load. Values of the fan bearing radius R_{FBRG} outside of the ranges disclosed herein either have a fan hub radius ratio that is too small such that the fan bearings cannot be packaged under the fan disk or too great such that the aerodynamic efficiency of the fan is reduced and the heat load on the fan bearings is increased so much that the fan bearings require a great amount of lubricant to cool the fan bearings. Thus, fan bearings having a fan bearing radius R_{FBRG} greater than seven hundred millimeters (700 mm) also result in a greater sized lubrication system, and, thus, results in a heavier turbofan engine.

The FBE is only valid for a radius ratio of the fan bearing radius to the fan hub trailing edge radius (R_{FBRG}/R_{FHTE}) in a range from 0.4 to 1.0. The range of R_{FBRG}/R_{FHTE} provides satisfies the operational requirements and the packaging requirements of a particular engine without overly increasing the fan bearing heat load. Values of the R_{FBRG}/R_{FHTE} outside of the ranges disclosed herein either have a fan hub radius ratio that is too small such that the fan bearings cannot be packaged under the fan disk or too great such that the aerodynamic efficiency of the fan is reduced. In particular, values of R_{FBRG}/R_{FHTE} greater than 1.0 provide for the fan bearings to be radially outward of the fan hub trailing edge, and, thus, reduce the radius of the core engine inlet. Values of R_{FBRG}/R_{FHTE} less than 0.4 provide for fan bearings that require larger rolling elements to account for the stresses, while also increasing the fan hub radius and the inner radius of the flow path.

The FBE is only valid for a rolling element diameter DFB in a range from three millimeters (3 mm) to one hundred fifty millimeters (150 mm). In some embodiments, the rolling element diameter DFB is in a range from five millimeters (5 mm) to one hundred twenty-seven millimeters (127 mm).

The FBE is only valid for a takeoff thrust Thrust_{TO} in a range from forty kilo-Newtons (40 kN) to five hundred twenty-five kilo-Newtons (525 kN). In some embodiments, the takeoff thrust Thrust_{TO} is in a range from forty-four kilo-Newtons (44 kN) to four hundred fifty kilo-Newtons (450 kN).

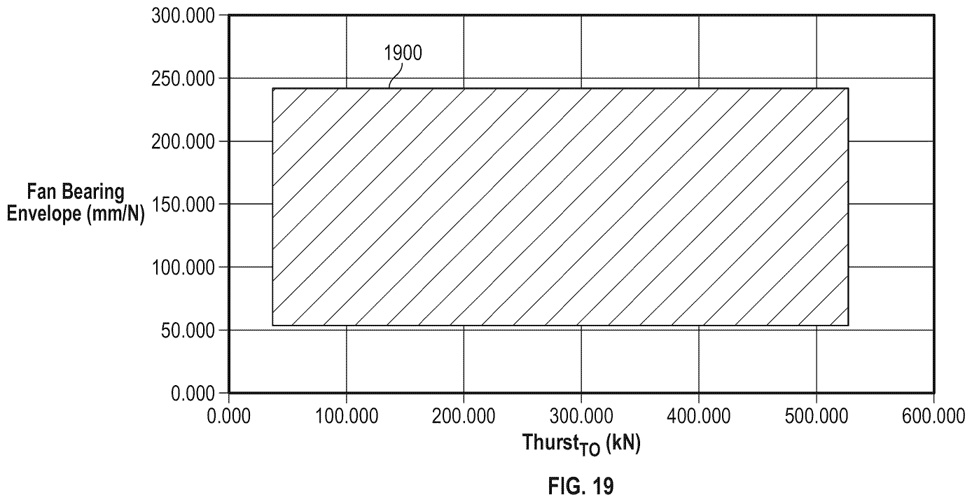

FIG. 19 represents, in graph form, the FBE as a function of the Thrust_{TO} of the turbofan engine, according to the present disclosure. An area 1900 represents the boundaries of the FBE. The FBE is in a range from fifty-four millimeters per Newton (54 mm/N) to two hundred forty millimeters per Newton (240 mm/N) for a takeoff thrust Thrust_{TO} in a range from forty kilo-Newtons (40 kN) to five hundred twenty-five kilo-Newtons (525 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 1900, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 1900, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 1900 provides for an improved fan bearing architecture that is capable of handling the stresses from the fan shaft, while accounting for the fan hub radius to improve propulsive efficiency and specific flow for achieving a certain thrust.

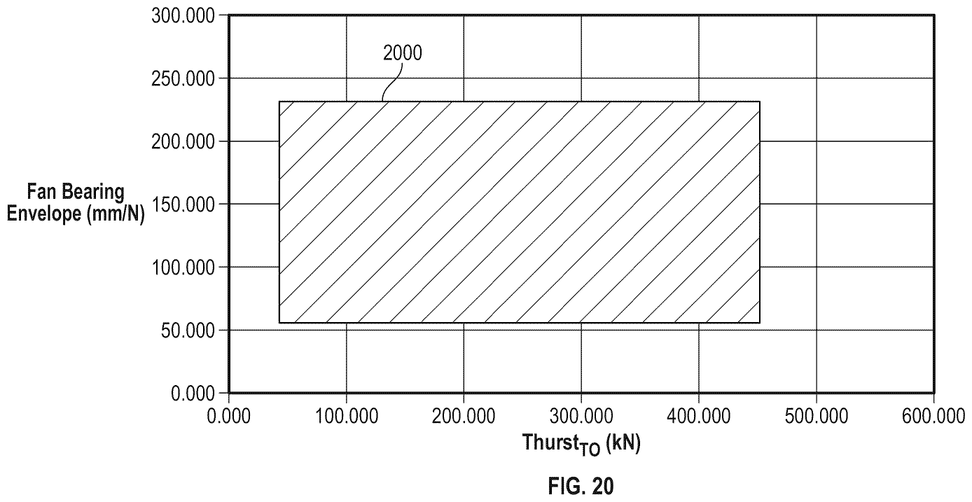

FIG. 20 represents, in graph form, the FBE as a function of the Thrust_{TO}, according to another aspect. An area 2000 represents the boundaries of the FBE. The FBE is in a range from fifty-eight millimeters per Newton (58 mm/N) to two hundred thirty millimeters per Newton (230 mm/N) for a takeoff thrust Thrust_{TO} in a range from forty-four kilo-Newtons (44 kN) to four hundred fifty kilo-Newtons (450 kN). The range of the FBE identifies the specific architectures (fan bearing sizing and location), rolling elements sizing, and takeoff thrusts, while accounting for the stresses from the fan shaft and the inner flow path radius and the fan hub radius. In particular, if the FBE is within the area 2000, then the fan bearing and the turbofan engine architecture are capable of handling the stresses from the fan shaft during operation, while reducing the fan hub radius, and, thus, providing for an improved specific flow through the fan and reducing the fan diameter required to achieve a certain thrust, or reduces the fan pressure ratio and improves propulsive efficiency of the fan. If the FBE is outside of the area 2000, then the fan bearings may become damaged or fail under the stresses from the fan shaft, or the fan hub radius (e.g., the inner radius of the flow path) is too great, such that the fan efficiency decreases or the specific flow through the fan is reduced for a certain thrust. Thus, the turbofan engine having an FBE within the area 2000 provides for an improved fan bearing architecture that is capable of handling the stresses from the fan shaft, while accounting for the fan hub radius to improve propulsive efficiency and specific flow for achieving a certain thrust.

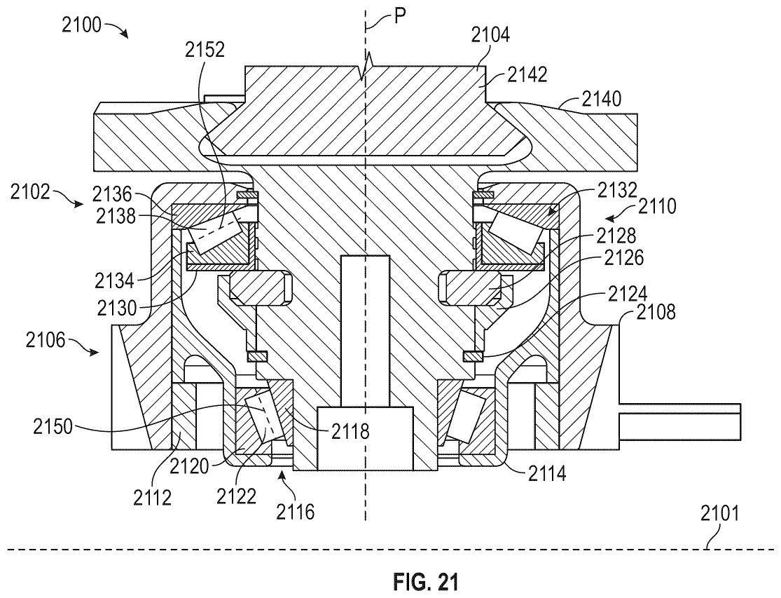

FIG. 21 is an enlarged schematic, cross-sectional view of a segment of a fan 2100 having a fan actuation system 2102, taken along a longitudinal centerline axis 2101 of the fan 2100, according to the present disclosure. The fan 2100 can be utilized as the fan 138 of FIG. 1 or as the fan 252 of FIG. 2. The fan 2100 includes a plurality of fan blades 2104 that is coupled to a disk 2106 and is spaced circumferentially about the longitudinal centerline axis 2101 of the fan 2100.

The disk 2106 includes a plurality of disk segments 2108 (only one shown in FIG. 21) that is rigidly coupled together or integrally molded together in a generally annular shape. One fan blade 2104 is coupled to each disk segment 2108 at a trunnion mechanism 2110 of the fan actuation system 2102. The trunnion mechanism 2110 facilitates retaining the respective fan blade 2104 on the disk 2106 during rotation of the disk 2106, while still rendering the respective fan blade 2104 rotatable relative to the disk 2106 about a pitch axis P of the fan blade 104. The trunnion mechanism 2110 includes a plurality of bearings disposed within the disk segment 2108 that allows the fan blade 2104 to rotate about the pitch axis P, as detailed above and below.

The trunnion mechanism 2110 extends through a respective disk segment 2108 and includes a coupling nut 2112, a lower bearing support 2114, a first radial thrust bearing 2116 (having, for example, an inner race 2118, an outer race 2120, and a plurality of rolling elements 2122), a snap ring 2124, a key hoop retainer 2126, a segmented key 2128, a bearing support 2130, a second radial thrust bearing 2132 (having, for example, an inner race 2134, an outer race 2136, and a plurality of rolling elements 2138), a trunnion 2140, and a base 2142 (e.g., a dovetail). The first radial thrust bearing 2116 and the second radial thrust bearing 2132 can include any type of roller bearings, including, for example, cylindrical roller radial thrust bearings, tapered roller radial thrust bearings, spherical roller radial thrust bearings (e.g., ball bearings), needle roller radial thrust bearings, or tapered roller needle radial thrust bearings. The coupling nut 2112 is threadedly engaged with the disk segment 2108 so as to sandwich the remaining components of the trunnion mechanism 2110 between the coupling nut 2112 and the disk segment 2108, thus, retaining the trunnion mechanism 2110 attached to the disk segment 2108.

The first radial thrust bearing 2116 is oriented at a different angle than the second radial thrust bearing 2132 (as measured from a rolling element longitudinal centerline axis 2150 of the plurality of rolling elements 2122 relative to the pitch axis P, and from a rolling element longitudinal centerline axis 2152 of the plurality of rolling elements 2138 relative to the pitch axis P). More specifically, the first radial thrust bearing 2116 and the second radial thrust bearing 2132 are preloaded against one another in a face-to-face (or duplex) arrangement, in which the rolling element longitudinal centerline axes 2150, 2152 are oriented substantially perpendicular to one another, as opposed to being arranged in tandem so as to be oriented substantially parallel to one another.

The centrifugal loads experienced closer to the pitch axis P are larger than the centrifugal loads experienced further away from the pitch axis P. As such, to facilitate making the trunnion mechanism 2110 more compact, the bearings of the trunnion mechanism 2110 are positioned closer to the pitch axis P. Such a configuration enables a greater number of trunnion mechanisms 2110 to be assembled on the disk 2106 and, thus, more fan blades 2104 to be coupled to the disk 2106 for a given diameter of the disk 2106. The trunnion mechanism 2110 herein is made more compact due to the first radial thrust bearing 2116 and the second radial thrust bearing 2132 being line contact bearings as compared to trunnion mechanisms that utilize angular point contact ball bearings. In this way, the trunnion mechanism 2110 is made more compact while being better able to withstand larger centrifugal loads associated with such a bearing placement without fracturing or plastically deforming. In particular, the first radial thrust bearing 2116 and the second radial thrust bearing 2132 being line contact bearings provide for larger contact surfaces, and, thus, can withstand larger centrifugal loads as compared to angular point contact ball bearings. Thus, line contact bearings (e.g., the first radial thrust bearing 2116 and the second radial thrust bearing 2132) can be spaced closer to the pitch axis P than angular point contact ball bearings.

In one aspect, the first radial thrust bearing 2116 and the second radial thrust bearing 2132 are a tapered roller bearings in which the rolling elements 2122 and the rolling elements 2138 are tapered. In one example, the first radial thrust bearing 2116 is fabricated from a steel material and has twenty rolling elements 2122 arranged at a 20° contact angle and a 3.6 inch pitch diameter, with each rolling element 2122 being 0.6 inches long and having a 0.525 inch minor diameter, a 0.585 inch major diameter, and a 6° taper angle. In the same example, the second radial thrust bearing 2132 is fabricated from a steel material and has 36 rolling elements 2138 arranged at a 65° contact angle and a 6 inch pitch diameter, with each rolling element 2138 being 0.8 inches long and having a 0.45 inch minor diameter, a 0.6 inch major diameter, and a 9° taper angle. In other aspects, the first radial thrust bearing 2116 and the second radial thrust bearing 2132 can be configured in any suitable manner that facilitates enabling the first radial thrust bearing 2116 and the second radial thrust bearing 2132 to function as described herein.

The first radial thrust bearing 2116 and the second radial thrust bearing 2132 facilitate providing a turbofan engine with a smaller variable pitch fan that can generate larger amounts of thrust. Particularly, the first radial thrust bearing 2116 and the second radial thrust bearing 2132 facilitate providing a turbofan engine with a variable pitch fan having a higher blade count and a lower blade length, while also providing the turbofan engine with a lower fan hub radius ratio. The first radial thrust bearing 2116 and the second radial thrust bearing 2132 further facilitate providing a trunnion mechanism that is more compact and is better able to withstand the higher centrifugal loads associated with higher blade counts, given that higher blade counts tend to yield a higher tip velocity and, therefore, a higher centrifugal loading. The first radial thrust bearing 2116 and the second radial thrust bearing 2132 further facilitate providing a smaller diameter disk for a variable pitch fan by providing the variable pitch fan with a fan counterweight device for the fan blades.

In various exemplary aspects of the present disclosure, a highly compact fan actuation system with a control system configured to maintain a substantially constant core engine speed across various flight phases is described. Such a control system that relies on continuous, dynamic blade and vane pitch adjustments to modulate thrust while the core runs at a constant speed traditionally demands a bulky, heavy actuation system. Conventionally, such high-duty-cycle pitch modulation requires an expanded fan hub radius to house the necessary actuators, which inherently degrades aerodynamic efficiency and increases drag.

The inventors of the present disclosure found that aerodynamic and structural benefits are realized when this dynamic constant-speed control scheme is implemented within the physical constraints of the Fan Actuation System Length (FASL) envelope described herein. For example, constraining the actuation system within the FASL envelope allows the engine to achieve the rapid thrust response associated with constant-speed core operation without drag penalties. Additionally, the compact actuators of the fan actuation system described herein withstand the high transient mechanical loads imposed by such aggressive pitch modulation. Because the actuation system utilizes a tightly optimized thrust bearing radius (RTB), the moment arms acting on the pitch change mechanisms are minimized, which prevents premature wear and mechanical fatigue while supporting the continuous actuation required by the controller.

In further exemplary embodiments of the present disclosure, an asynchronous pitching mechanism is described for providing reverse thrust. Moving high-solidity blades past flat pitch to a reverse position typically utilizes asynchronous pitching (via staggered scheduling slots in a scheduling ring) to prevent blade clash. Implementing such asynchronous mechanisms conventionally requires complex, physically large linkages that are difficult to package within modern, streamlined fan hubs.

The inventors of the present disclosure also found that by combining the asynchronous pitching mechanism with the highly compact trunnion mechanism and tight RTB of the present disclosure, the complex linkages can be accommodated within the compact space defined by the Fan Actuation System (FAS) envelope described herein. This integration ensures that the requisite mechanical clearances for asynchronous pitching are maintained in a remarkably dense footprint. Moreover, safety is improved by this combination. For example, the asynchronous maneuver through flat pitch into reverse thrust introduces elevated operational risks if hydraulic pressure is lost. By incorporating the present disclosure's pressurized pneumatic chamber, a passive failsafe is provided. In the event of hydraulic failure during the complex reverse-thrust maneuver, the pneumatic chamber passively forces the asynchronous linkage to safely return the fan blades to a feathered position, preventing aerodynamic drag and potential engine overspeed.

Another exemplary aspect of the present disclosure combines the tightly packaged fan actuation system described herein with a noise mitigation control system that dynamically shifts a thrust split to a ducted midfan. To mitigate community and cabin noise, a controller may dynamically close the pitch angle of outlet guide vanes or reduce fan speed in response to a noise sensitive condition, which shifts the thrust burden to a secondary ducted midfan stream. The effectiveness of this noise mitigation strategy is heavily dependent on maintaining unobstructed, high-quality airflow into the core and the midfan. Conventionally sized fan hubs can create aerodynamic blockage that limits the midfan's ability to efficiently absorb the shifted thrust without choking.

Because the present disclosure describes a FASL envelope that directly enables a low fan hub radius ratio, aerodynamic blockage forward of the core and midfan is drastically minimized. This low hub radius ratio allows the ducted midfan to absorb the shifted thrust split efficiently and smoothly. As a result, the acoustic benefits of the noise mitigation control scheme are amplified far beyond what would be achievable in an engine utilizing a conventionally sized fan hub.

Accordingly, the inventors found that designing a turbofan engine having a compact fan actuation system defined by the above relationship (e.g., a turbofan engine having a fan actuation system characterized by FAS, FASL, and FBE) enables incorporation of the various control systems defined herein, providing for a fan having improved efficiency.

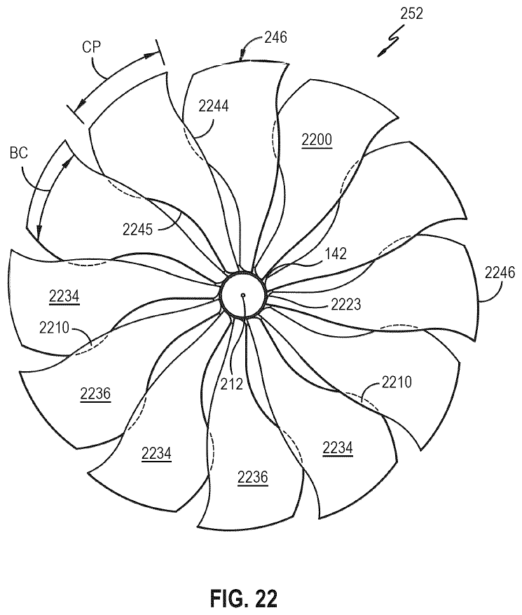

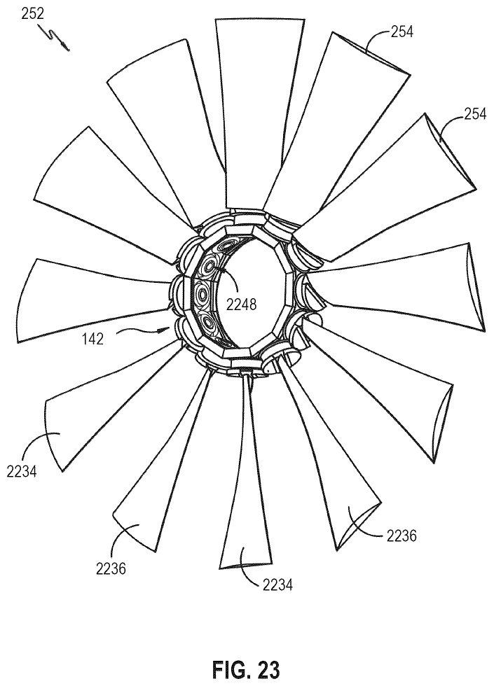

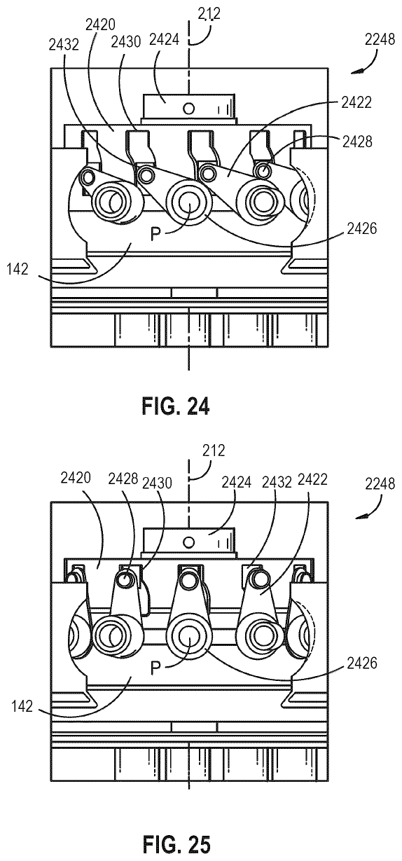

Referring now to FIGS. 22-27, the fan 252 includes a variable pitch fan 252 having the fan blades 245 plurality of fan blades 254 coupled to the fan disk 142 in a spaced apart manner. As depicted, the fan blades 245 extend outwardly from fan disk 142 generally along a radial direction R. Each of the plurality of fan blades 245 defines a leading edge 2244 and a tip 2246 defined at a radially outer edge of each respective fan blade 254245. Each fan blade 254 is also rotatable relative to the fan disk 142 about the pitch axis P by virtue of the fan blades 245 being operatively coupled to a suitable fan actuation system 2248 configured to vary the pitch of the fan blades 245 in a manner described in detail below. The fan actuation system 2248 may be similar or analogous to the fan actuation system 144 described hereinabove. The fan blades 245, fan disk 142, and fan actuation system 2248 are together rotatable about the longitudinal centerline axis 212.

Referring now to FIG. 22, the fan 252 will be described in greater detail. FIG. 22 provides a forward-facing-aft elevational view of the fan 252 of the exemplary turbofan engine 110 of FIG. 2. For the exemplary embodiment depicted, the fan 252 includes twelve (12) fan blades 245. From a loading standpoint, such a blade count allows the span of each fan blade 254 to be reduced such that the overall diameter of fan 252 is also able to be reduced (e.g., to about twelve feet in the exemplary embodiment). That said, in other example embodiments, fan 252 may have any suitable blade count and any suitable diameter, such as described herein.

Each fan blade 254 may have a suitable aerodynamic profile including a generally concave pressure side and a circumferentially opposite, generally convex suction side 2200. Each fan blade 254 extends from an inner root end 2223, which is rotatably coupled to fan disk 142, to a radially outer distal tip 2246. As shown, each fan blade 254 defines a chord length C that extends between opposite leading edge 2244 and trailing edge 2245, with the chord varying in length over the span of the fan blade 254.

The fan 252 also has a corresponding solidity which is a conventional parameter equal to the ratio of the blade chord BC, as represented by its length, divided by the circumferential pitch CP or spacing from blade to blade at the corresponding span position or radius. The circumferential pitch is equal to the circumferential length at the specific radial span divided by the total number of rotor blades in the blade row. Accordingly, the solidity is directly proportional to the number of blades and chord length and inversely proportional to the diameter.

Typical high solidity turbofan engines have adjacent fan blades 245 that substantially overlap each other circumferentially due to the high solidity and high stagger of the airfoils. For example, as shown in FIG. 22, the fan blades 245 have high solidity and adjacent blades would contact each other when passing through the flat pitch position. Due to the solidity of the fan blades 245, it can be seen that the fan blades 245 would overlap at least in region 2210 if they pass through flat pitch at the same time. In some example embodiments, in order to achieve reverse thrust from the fan 252, it is necessary that the fan blades 245 pass through flat pitch. However, given the configuration shown in FIG. 22, unacceptable blade contact will occur if the fan blades 245 rotate in unison through flat pitch. Therefore, a fan 252 configured for asynchronous blade pitching is described below with respect to FIGS. 22-27. Such a system can ensure that the fan blades 245 do not pass through flat pitch at the same time, as well as provide other performance-related improvements to fan 252 operation, as discussed below.

Referring now to FIGS. 22-27, the fan actuation system 2248 in accordance with at least one example embodiment of the present disclosure is depicted. As mentioned above, each fan blade 254 is rotatable relative to the fan disk 142 about the pitch axis P. The fan blades 245, fan disk 142, and fan actuation system 2248 are together rotatable about the longitudinal axis 212. In certain embodiments, the pitch actuation assembly described in regard to the fan actuation system 2248 is further included at one or more of the plurality of fan guide vanes 262 of the fan guide vane array 260 as a vane actuation system 3548. As such, at least a portion of the pitch actuation assembly shown and described in regard to FIGS. 22-27 may be applied to one or more of the plurality of fan guide vanes 262 such as to adjust the orientation of the fan guide vanes collectively or independently 262 about the vane pitch axis 264 of each respective fan guide vanes 262. Such independent or collective adjustment of pitch angle of the fan guide vanes 262 about vane pitch axis 264 may be utilized according to one or more methods further described herein, such as one or more methods for attenuating undesired acoustic noise, for producing a desired thrust vector, and/or for producing a desired thrust load.

The fan actuation system 2248 generally includes a scheduling ring 2420, plurality of linkage arms 2422, and one or more motors 2424 (e.g., an electric motor, a pneumatic or hydraulic actuation device, etc.). Each fan blade 254 may be rotatably coupled to the fan disk 142 through a first end 2426 of a corresponding linkage arm 2422 such that the first end 2426 and the corresponding fan blade 254 may rotate about pitch axis P (pitch axis 3791 shown in FIG. 2) relative to fan disk 142. In this regard, the fan blade 254 may be fixedly connected to the first end 2426 of the corresponding linkage arm 2422, such that rotation of the linkage arm 2422 causes the fan blade 254 to rotate relative to the fan disk 142.

A second end 2428 of the linkage arm 2422 may be slidably connected to one of a plurality of slots 2430 defined in scheduling ring 2420. For example, the second end 2428 may be rotatably connected to a sliding member 2432. The sliding member 2432 may be slidably received in a slot 2430 of the scheduling ring 2420. The scheduling ring 2420 is rotatable about the longitudinal centerline 212 relative to the fan disk 142 and is operatively coupled with the motor 2424, which is fixed relative to the fan disk 142.

Each of the plurality of slots 2430 on the scheduling ring 2420 defines an airfoil pitch schedule. In this regard, for a given angle of rotation of the scheduling ring 2420, the airfoil pitch schedule determines the actual pitch angle of the fan blades 245. In operation, the motor 2424 rotates the scheduling ring 2420 relative to the fan disk 142. As the scheduling ring 2420 rotates, sliding member 2432 moves along slot 2430 and the angular position of the linkage arm 2422 changes. As each linkage arm 2422 rotates, the corresponding fan blade 254 rotates as well, thus rotating each fan blade 254 about pitch axis P.

Therefore, by rotating the scheduling ring 2420 relative to the fan disk 142, each of the plurality of fan blades 245 rotates about its respective pitch axis P according to an airfoil schedule defined by the slot 2430 to which it is coupled by linkage arm 2422. By defining different airfoil pitch schedules, the rotation of the fan blades 245 may be controlled independently of each other. Therefore, for example, if alternating fan blades 245 are rotated according to different airfoil pitch scheduling, conflict through flat pitch may be avoided. Additionally, the pitch schedule may be adjusted to improve performance of the fan blade 254. In some example embodiments, improved performance of the fan blade 254 via different airfoil pitch scheduling may reduce undesired acoustics, or mitigate the production of undesired acoustics, from the fan blades 245 during rotation at one or more operational modes of the turbofan engine 110, or during one or more operational modes of an aircraft to which the turbofan engine 110 is attached (e.g., takeoff, climb, cruise, approach, etc.).

The airfoil pitch schedules may depend, for example, on whether the aircraft is in a normal flight phase, a flat pitch transition phase, or a reverse thrust configuration. For example, the variable pitch fan 252 may be configured for normal flight phase when the fan blades 245 have a pitch of greater than 8°. Additionally, when the fan blades 245 are within 8° of flat pitch (i.e., between −8° and) 8°, the variable pitch fan 252 may be operating in a flat pitch transition phase. The fan blades 245 may be in a reverse thrust phase when angled at −8° or less. One skilled in the art will appreciate that these ranges are used only for the purpose of explanation, and that phases and airfoil schedules may be defined in a variety of other ways to improve performance of the variable pitch fan 252 and turbofan engine 110.

In an example embodiment, the plurality of fan blades 245 rotate according to different pitch schedules in order to avoid conflict as the fan blades 245 rotate through flat pitch. More specifically, as shown in FIG. 22, a first set of blades 2234 may rotate according to a first airfoil pitch schedule, and an alternating, second set of blades 2236 may rotate according to a second airfoil pitch schedule. The first and second airfoil pitch schedule may be the same for a first phase of rotation, which may correspond to normal flight operation, but the pitch schedules may deviate from one another as the fan blades 245 enter flat pitch. For example, as soon as the pitch of the plurality of fan blades 245 reach within 8° of flat pitch, the rotational speed of the first set of blades 2234 may increase while the rotational speed of the second set of blades 2236 may decrease. In this manner, the first set of blades 2234 may pass through flat pitch sequentially ahead of the second set of blades 2236, thus avoiding contact through flat pitch. After all fan blades 245 have passed through flat pitch and begin to generate reverse thrust, the first and second airfoil pitch schedules may once again synchronize with each other so that all fan blades 245 rotate in unison. Alternatively, however, the airfoil schedules may remain offset in order to ensure reverse thrust is achieved without choking the air going to the core 16 of the turbofan engine 110, or to achieve other performance improvements.

One skilled in the art will appreciate that the airfoil pitch schedules discussed above are only exemplary, and that any other airfoil pitch schedule or schedules may be used as needed for performance. For example, more than two airfoil pitch schedules may be used. Indeed, every fan blade 254 could rotate according to its own pitch schedule. All such variations are contemplated as within the scope of the present disclosure.

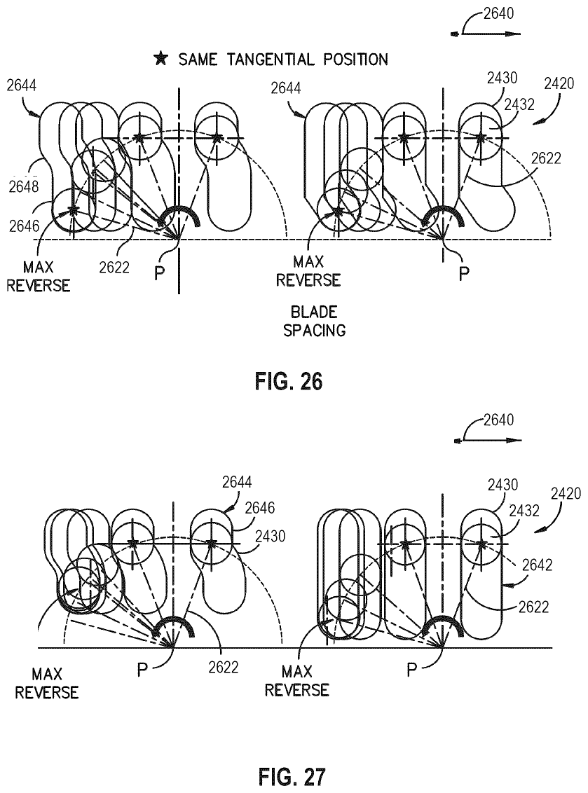

Now referring to FIGS. 26-27, a schematic representation of the displacement of the sliding member 2432 is shown. This representation depicts two adjacent fan blades 245 rotating according to airfoil schedules defined by scheduling slots 2430 in scheduling ring 2420. In the illustrated embodiment, each fan blade 254 is centered about respective pitch axis P, where it is rotatably coupled to fan disk 142. Each linkage arm 2422 is schematically represented by dotted line 2622 and rotates a fixed radial distance about its respective pitch axis P. Sliding member 2432 is rotatably connected to linkage arm 2422 and is slidably coupled to scheduling slot 2430.

As shown in the figures, as scheduling ring 2420 rotates relative to fan disk 142, the scheduling slots 2430 are generally translated in the direction indicated by arrow 2640. For each angular position of the scheduling ring 2420, the angular position of each fan blade 254 may be varied according to the shape of its respective scheduling slot 2430, such as a first scheduling slot 2642 and a second scheduling slot 2644. In various example embodiments, the first scheduling slot 2642 defines a different contour from the second scheduling slot 2644, such that each slot 2642, 2644 rotates the fan blade 254 to a different position, or at a different rate of change, relative to one another. For example, referring specifically to FIG. 26, some scheduling slots 2430 may be entirely linear in the vertical direction (e.g., the first scheduling slot 2642 defining a linear scheduling slot). By contrast, some scheduling slots 2430 may be non-linear (e.g., the second scheduling slot 2644 defining a non-linear scheduling slot), for example, by having one or more linear portions 2646 and one or more non-linear portions 2648. In other example embodiments, the scheduling slots 2430 may be bent, curved, serpentine, or any other suitable shape.

Notably, when the scheduling ring 2420 is rotated at a constant velocity, a linkage arm 2422 connected to the entirely linear scheduling slot 2642 will have a constant rotational speed about pitch axis P. By contrast, the rotational speed of a linkage arm 2422 connected to a non-linear slot will vary according to the shape of its respective scheduling slot 2430. In this manner, by alternately shaping each scheduling slot 2430, alternating fan blades 245 may rotate into flat pitch at different times, such that fan blade 254 contact will not occur through flat pitch. Additionally, adjacent scheduling slots 2430 may have a similar profile throughout the fan blade 254 angle range, such that the fan blades 245 rotate in unison throughout their range with the exception of the point where they enter flat pitch.

One skilled in the art will appreciate that the above-described mechanism for actuating the rotation of the rotor blades is only one exemplary mechanism for achieving asynchronous rotor blade pitching. Other mechanisms will be evident to a skilled artisan based on the present disclosure. Any such variations or modifications are contemplated as within the scope of the present disclosure.

The above-described embodiments facilitate thrust vector adjustment, including thrust reverse, thrust magnitude change and/or thrust direction change along the longitudinal direction, for a variable pitch fan 252 with the fan blade 254 solidity greater than one without a need for a heavy thrust reverse mechanism. Particularly, embodiments of the pitch change mechanism shown and described herein allows for at least two-phase asynchronous fan blade 254 pitching, such that each fan blade 254 rotates on a different schedule through flat pitch and/or reverse allowing the fan blades 245 to pass each other without contact. For example, the pitch change mechanism can rotate six out of twelve fan blades 245 on a different schedule through reverse, thus allowing reverse thrust to be achieved without contact between the fan blades 245 as they pass through flat pitch. All fan blades 245 may rotate on the same schedule throughout the entire flight envelope with the exception of the reverse condition. Benefits of asynchronous fan blade 254 pitching include improvements in engine efficiency and specific fuel consumption. Installation is also simplified as compared to prior designs, fan operability is improved, and stall margin is increased. Other advantages will be apparent to those of skill in the art.

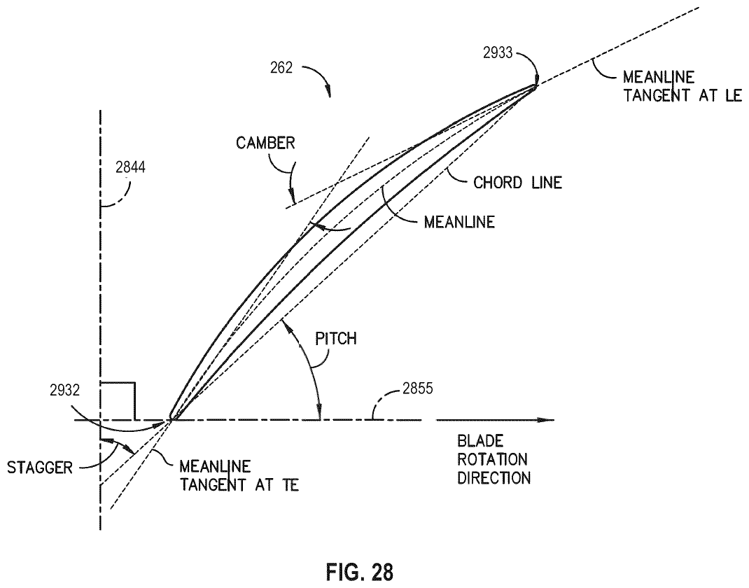

Referring back to FIG. 2, and further in conjunction with FIGS. 28-34, In some example embodiments, the fan guide vane array 260 includes a plurality of vane airfoils 262 arranged in a spaced apart manner. Referring briefly to FIG. 28, an exemplary vane airfoil 262 is provided graphically depicting how various parameters such as camber and stagger angle are defined with respect to the airfoil, such as the fan blade 254 (FIG. 2) or the fan guide vanes 262 (FIG. 2). An airfoil meanline is described as a line that bisects the airfoil thickness (or is equidistant from the suction surface and pressure surface) at all locations. The meanline intersects the airfoil at a leading edge (LE) and a trailing edge (TE). The camber of an airfoil is defined as the angle change between the tangent to the airfoil meanline at the leading edge and the tangent to the angle meanline at the trailing edge. The stagger angle is defined as the angle the chord line makes with the centerline axis (e.g., reference line 2844). Reference line 2844 is parallel to axis 212, and reference line 2855 is orthogonal to reference line 2844.

Referring generally to FIG. 2 and FIGS. 35-36, a vane actuation system 3548 in accordance with at least one example embodiment of the present disclosure is depicted. In some example embodiments, the turbofan engine 110 includes a fan actuation system 2248 at the fan 252 (e.g., such as depicted and described in regard to FIGS. 22-27) and a vane actuation system 3548 at the fan guide vane array 260 (e.g., such as depicted and described in regard to FIG. 2 and FIGS. 35-36) to desirably control thrust output, thrust vector, rotor speed, acoustic noise, or generally allow for constant or substantially constant speed or operation of the engine core 218 while desirably adjusting magnitude and/or direction of thrust output.

As mentioned above, one or more of the plurality of plurality of fan guide vanes 262 is rotatable about a vane pitch axis (e.g., vane pitch vane pitch axis 264 in FIGS. 2, 35, 36). The vane actuation system 3548 may provide to one or more of the plurality of fan guide vanes 262 collective, independent, or ganged (i.e., a first set of vanes differently and/or independently operable from a second set of vanes, such as depicted and described herein) adjustment of the orientation or airfoil characteristics of the fan guide vanes 262 about the vane pitch axis of each respective fan guide vanes 262. Such independent or collective adjustment of pitch angle of the fan guide vanes 262 about the vane pitch axis may be utilized according to one or more methods further described herein, such as one or more methods for attenuating undesired acoustic noise, for producing a desired thrust vector, and/or for producing a desired thrust load.

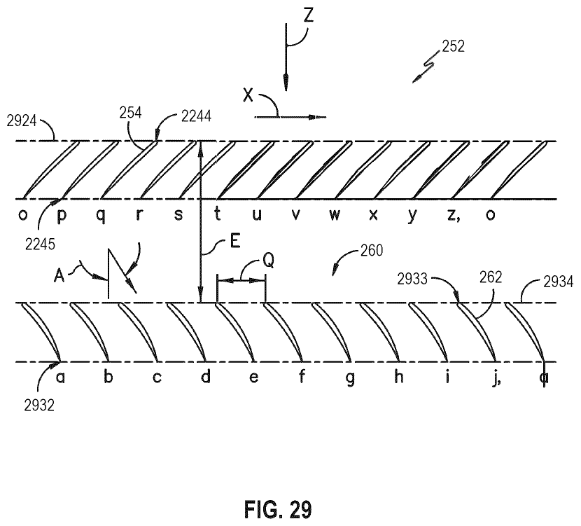

FIGS. 29-33 each include illustrations of radial sections of the turbofan engine 110 taken through stages of axial flow airfoils and nearby aircraft surfaces, and are typically referred to as “roll-out-views”, such as a projection of blades about circumference onto a plane. These views are generated by sectioning airfoil stages and aircraft surfaces at a fixed radial dimension measured radially from longitudinal axis 212 and reference dimension R in FIG. 2. When fan blades 245 and plurality of fan guide vanes 262 of respective fan 252 and fan guide vane array 260 are sectioned at reference dimension R, corresponding fan blade 254 and plurality of fan guide vanes 262 are generated. Then the fan blades 245 and plurality of fan guide vanes 262 are unrolled or ‘rolled-out’ to view the sections in two-dimensional space while maintaining the circumferential and axial relationships between the airfoil stages and any nearby aircraft surfaces. Reference dimension E for the axial spacing between fan blades 245 and plurality of fan guide vanes 262. This allows the fan 252 and the fan guide vane array 260 in FIGS. 29-33 to be described in two dimensions. An axial dimension, parallel to the longitudinal axis 212 and generally aligned with the direction Z of the moving working fluid shown in FIG. 2, and a ‘rolled-out’ or flattened circumferential dimension X, orthogonal to the axial dimension.

FIG. 29 illustrates a cross-sectional “roll-out view” of fan 252 which as depicted includes twelve fan blades 245. Each fan blade 254 is individually labeled with lower case letters o through z, with the fan blade 254 labeled o repeating at the end of the sequence to highlight the actual circumferential nature of fan 252. Each fan blade 254 has a blade leading edge 2244. A line positioned in the circumferential direction X through each blade leading edge 2244 defines a rotor plane 2924. Each fan blade 254 is spaced apart from one another and is located axially at a rotor plane 2924.

Similar to the fan 252, the fan guide vane array 260 depicted in FIG. 29 has ten plurality of fan guide vanes 262, individually labeled a through j, each with a vane leading edge 2933. A line positioned in the circumferential direction through each vane leading edge 2933 defines a stator plane 2934. In FIG. 29, each fan guide vanes 262 in the fan guide vane array 260 is identical in size, shape, and configuration, and is evenly spaced circumferentially from each other (i.e., along reference dimension P) and evenly spaced axially from the rotor plane 2924 (i.e., in regard to reference dimension E). A nominal, evenly distributed circumferential spacing Q, between plurality of fan guide vanes 262 can be defined by the following equation using the radial height of the reference dimension R, and the number of plurality of fan guide vanes 262, N, in fan guide vane array 260:

$$Q = R * 2 * π / N$$

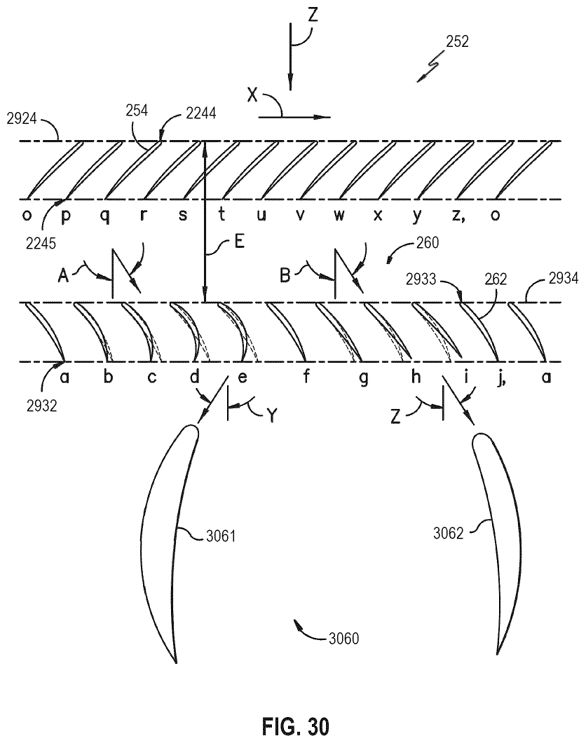

The turbofan engine 110 may include a controller configured to adjust the position of one or more plurality of fan guide vanes 262, the blade pitch angle of the plurality of fan blades 245 at the fan 252, and/or the rotor plane 2924 of the fan 252 relative to the plurality of fan blades 245 of the fan 252. In some example embodiments, the pitch angle at pitch axis (e.g., vane pitch vane pitch axis 264 in FIG. 1), the longitudinal or axial spacing of a respective vane leading edge 2933 to the rotor plane 2924, and/or the circumferential spacing of two or more plurality of fan guide vanes 262 along reference dimension Q is adjusted to improve the acoustic signature of the turbofan engine 110 relative to various operational conditions of the turbofan engine 110 and/or the aircraft (e.g., angle of attack). Exemplary embodiments of adjustments or positioning of the fan guide vane array 260 relative to the fan 252 are further provided in regard to FIGS. 30-32. In each of these figures, the fan 252 and fan guide vane array 260 are located axially forward of a wing of an aircraft. Additionally, at least one example embodiment of an aircraft surface 3060 is represented as two wing sections 3061, 3062. Note that two wing sections are present in each “roll-out view,” because the radial section that generates these installed views cuts through the wing of an aircraft in two circumferential locations. For the non-uniform plurality of fan guide vanes 262 in all of the Figures which follow, this dashed and solid line depiction method is used to refer to exemplary embodiments of nominal and non-nominal plurality of fan guide vanes 262 respectively.

To minimize the acoustic signature, it is desirable to have the aerodynamic loading of the vane leading edges 2933 to all be similar and be generally not highly loaded. To maximize the efficiency and minimize the acoustic signature of the fan 252, a desired goal would be to minimize the variation in static pressure circumferentially along the fan 252. To maximize the performance of the fan guide vane array 260, another goal would be to have neither the aerodynamic loadings of the vane leading edges 2933 nor the vane suction 35 and pressure surface 36 diffusion rates lead to separation of the flow.

To maximize the performance of the aircraft surface, depicted in these exemplary embodiments as a wing sections 3061 and 3062, one goal may be to keep the wing loading distribution as similar to the loading distribution the wing was designed for in isolation from the turbofan engine 110, thus maintaining its desired design characteristics. The goal of maintaining the aircraft surface 3060 performance as designed for in isolation from the turbofan engine 110 applies for aircraft surfaces that may be non-wing, including, for example, fuselages, pylons, and the like. Furthermore, to maximize the performance of the overall aircraft and turbofan engine 110, one of the goals would be to leave the lowest levels of resultant swirl in the downstream wake. As described herein, the non-uniform characteristics of the plurality of fan guide vanes 262 is adjusted based on one or more of these desired goals during operation of the turbofan engine 110 and aircraft.

This optimal performance can be accomplished in part by developing non-uniform vane exit flow angles, shown in FIG. 30 as angles Y and Z, to minimize interaction penalties of the engine installation and to reduce the acoustic signature. The first exemplary embodiment of this is shown in FIG. 30, where each pair of plurality of fan guide vanes 262 in the fan guide vane array 260 are evenly spaced circumferentially from one another and evenly spaced axially from the rotor plane 2924. However, the nominal (without pitch change) stagger angle and camber of the plurality of fan guide vanes 262 in FIG. 30 vary to provide optimal exit flow angles into the aircraft surface downstream of the fan guide vane array 260, such as depicted in regard to reference plurality of fan guide vanes 262 labeled b through e, and g through i.

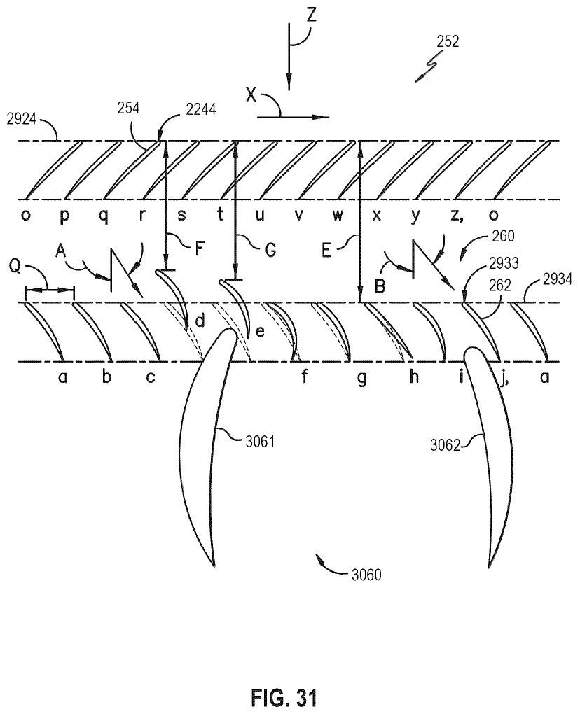

FIG. 31 shows another exemplary embodiment of fan guide vane array 260 providing flow complimentary to aircraft surface 3060. In FIG. 31, plurality of fan guide vanes 262 and related plurality of fan guide vanes 262 in fan guide vane array 260 are not evenly spaced circumferentially from each other, nor are they evenly spaced axially from the rotor plane 2924. The degree of non-uniformity may vary along the span of a vane. Two plurality of fan guide vanes 262 are spaced axially forward of the stator plane 2934, reference dimensions F and G, allowing the fan guide vane array 260 to merge axially with the aircraft surface 3060. For instance, the aircraft surface 3060 may at least partially include or define at least one of the plurality of fan guide vanes 262 of the fan guide vane array 260. The nominal (without pitch change) stagger angle and camber angle of the plurality of fan guide vanes 262 vary to provide optimal exit flow angles into the wing sections 3061 and 3062, as shown in plurality of fan guide vanes 262 labeled d through i.

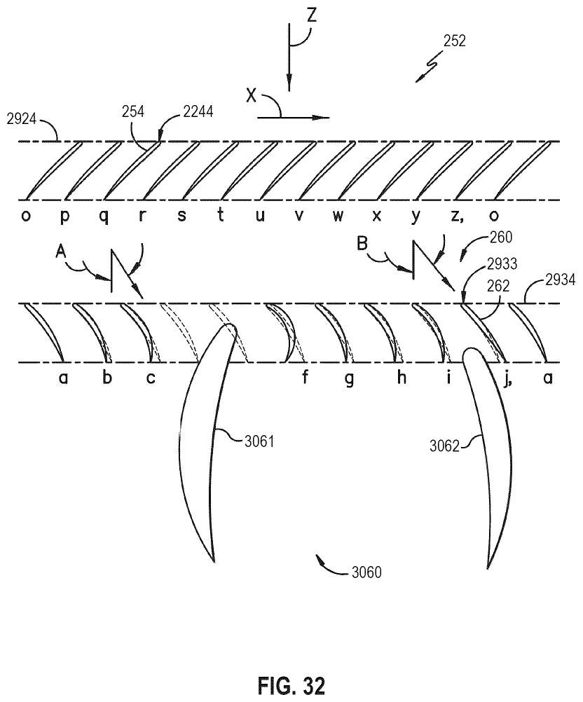

FIG. 32 is similar to FIG. 31, but depicts the removal of two plurality of fan guide vanes 262 adjacent to wing section 3061. This exemplary embodiment allows the plurality of fan guide vanes 262 to be evenly spaced axially from the rotor plane 2924 and allows the wing section to merge axially with the fan guide vane array 260.

Although the location of the fan 252 and fan guide vane array 260 in each of the foregoing exemplary embodiments was axially forward of the aircraft surface 3060, it is foreseen that a propulsion system could be located aft of the aircraft surface 3060. In these instances, the prior enumerated goals for optimal installed performance are unchanged. It is desirable that the propulsion system has suitable fan 252 circumferential pressure variations, vane leading edge 2933 aerodynamic loadings, and vane pressure surface and suction surface diffusion rates. This is accomplished in part by varying the size, shape, and configuration of each fan guide vanes 262 and related fan guide vanes 262 in the fan guide vane array 260 alone or in combination with changing the fan guide vanes 262 pitch angles. For these embodiments, additional emphasis may be placed on assuring the combined propulsion system and aircraft leave the lowest levels of resultant swirl in the downstream wake.

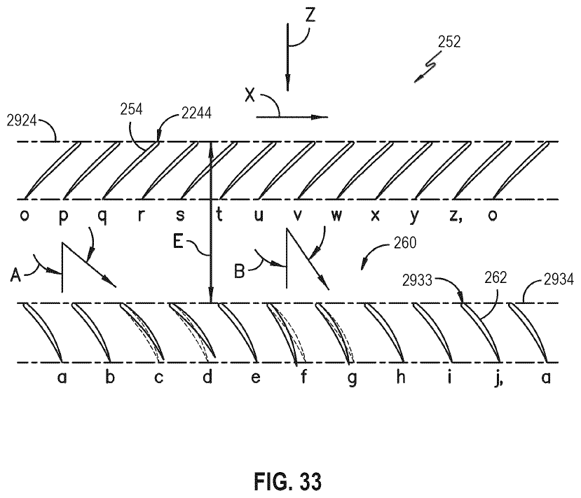

The exemplary embodiment of the fan 252 and fan guide vane array 260 in FIG. 29 is designed for a receiving a constant swirl angle, reference angle A, into plurality of fan guide vanes 262 along the stator plane 2934. However, as the aircraft angle of attack is varied the vanes move to off design conditions and the swirl angle into the fan guide vane array 260 will vary around the stator plane 2934. Therefore, to keep the aerodynamic loading on the vane leading edges 2933 roughly consistent along the stator plane 2934, a variable pitch system that would rotate either each fan guide vanes 262 or group of plurality of fan guide vanes 262 a different amount is desirable. Such a pitch change can be accomplished by rotating a fan guide vanes 262 in a solid body rotation along any axis, including, for example, the axis along the centroid of fan guide vanes 262 or an axis along the vane leading edge 2933. The desire for similar aerodynamic loading on the vane leading edges 2933 is in part driven by the desire to keep the acoustic signature of the turbofan engine 110 low. Plurality of fan guide vanes 262 with high leading edge loadings tend to be more effective acoustic radiators of the noise created from the gust of the upstream fan 252. The exemplary embodiment of the fan 252 and fan guide vane array 260 in FIG. 33 describes this desired variation in fan guide vanes 262 via changes in pitch angles of one or more plurality of fan guide vanes 262, such as via the vane actuation system 3548 further described herein. For ease of explanation, we define the chord line angle of vanes at the design point as stagger and hence variations between vanes at the design point as stagger variations. As the turbofan engine 110 moves to different operating conditions, or as the aircraft to which the engine is attached moves to different operating conditions (e.g., takeoff, climb, cruise, approach, landing, etc.), plurality of fan guide vanes 262 may rotate around the pitch vane pitch axis 264 referred to as pitch change (or changes in pitch angle) of the plurality of fan guide vanes 262. Variations in vane chord angles that result from these solid body rotations are referred to as pitch angle variations.

In FIG. 33, each fan guide vanes 262 in the fan guide vane array 260 is identical in size, shape, and configuration, and are evenly spaced circumferentially from each other and evenly spaced axially from the rotor plane 2924. However, the pitch angles of the plurality of fan guide vanes 262 in FIG. 33 vary as they represent a change in the fan guide vanes 262 pitch actuation to accommodate varying input swirl, reference different input swirl angles A and B, into stator plane 2934 caused in part by changes in aircraft angle of attack. As desired, this provides similar aerodynamic loading on the vane leading edges 2933 to keep the acoustic signature of the turbofan engine 110 low, such as within one or more ranges further described herein. This similar loading can be accomplished by independently changing pitch angle for individual plurality of fan guide vanes 262 via the vane actuation system 3548, or by changing pitch angles similarly for groups of plurality of fan guide vanes 262 suitable for ganging. The plurality of fan guide vanes 262 could rotate in pitch about any point in space, but it may be desirable to maintain the original vane leading edge 2933 circumferential spacing and rotate the plurality of fan guide vanes 262 around a point at or near their vane leading edge 2933. This is shown in FIG. 33 using plurality of fan guide vanes 262 labeled c, d, f, and g, where the nominal staggered plurality of fan guide vanes 262 are depicted in dashed lines and the rotated (or pitched) plurality of fan guide vanes 262 are depicted as solid lines.

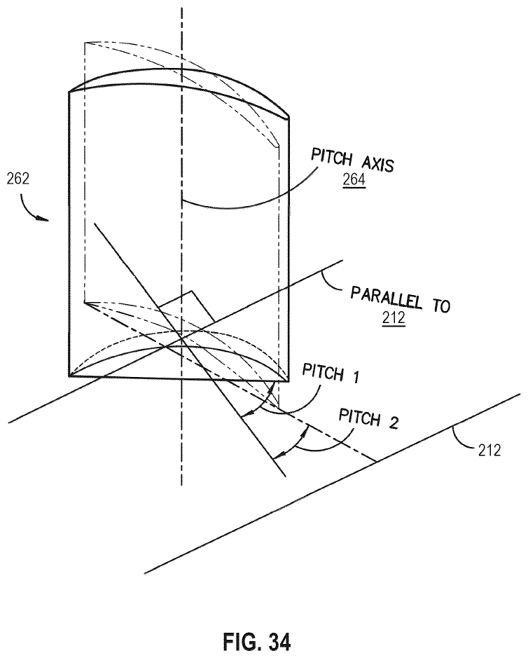

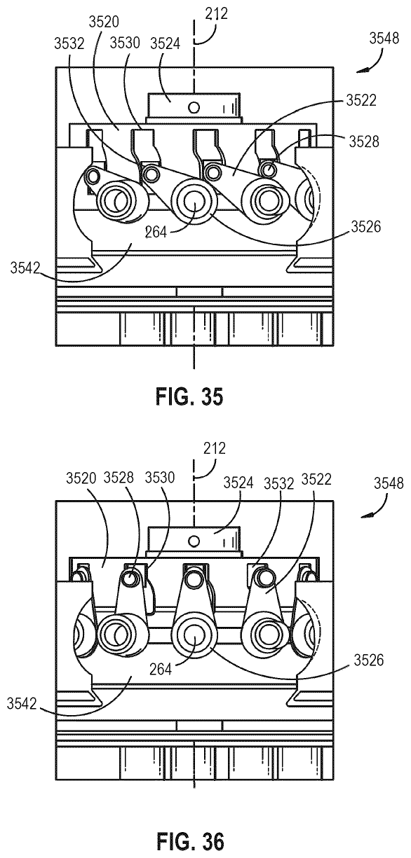

As shown by way of example in FIG. 34, it may be desirable that either or both of the sets of fan blades 245 and plurality of fan guide vanes 262 incorporate a pitch or airfoil characteristics change mechanism (e.g., blade pitch fan actuation system 2248 in FIGS. 22-27, vane actuation system 3548 in FIG. 35-36) such that the blades and vanes can be rotated with respect to an axis of pitch rotation either independently or in conjunction with one another. Such pitch change can be utilized to vary thrust and/or swirl effects under various operating conditions, including providing thrust reversing, acoustic noise attenuation, or desired thrust vector, which may be useful in certain operating conditions of the turbofan engine 110 and/or aircraft.

The fan guide vane array 260, as suitable for a given variation of input swirl and aircraft surface 3060 installation, has non-uniform characteristics or parameters of vanes with respect to one another selected either singly or in combination from those which follow. A delta in stagger angle between neighboring plurality of fan guide vanes 262 according to one embodiment of greater than or equal to about 2 degrees can be employed, and according to another embodiment between about 3 degrees and about 20 degrees. A delta in camber angle between neighboring plurality of fan guide vanes 262 and related plurality of fan guide vanes 262 according to one embodiment of greater than or equal to about 2 degrees can be employed, and according to another embodiment between about 3 degrees and about 15 degrees. A circumferential spacing Q at a given reference dimension R, between neighboring plurality of fan guide vanes 262 and related plurality of fan guide vanes 262, for fan guide vanes 262 counts N from about 5 to about 20, from about 10% to about 400% of the nominal, even circumferential spacing can be employed. An axial spacing from the rotor plane 2924 to plurality of fan guide vanes 262 and related plurality of fan guide vanes 262 up to about 400% of the radial height H, of the fan guide vanes 262 can also be employed.

The non-uniform characteristic may be attributed to a portion of the span of the vanes, or to substantially all of the span of the vanes. In some example embodiments, at least a portion, or all, of the plurality of plurality of fan guide vanes 262 of the fan guide vane array 260 may include the vane actuation system 3548, in which the vane characteristics actuation mechanism is configured to adjust at least a pitch axis and/or axial spacing such as described herein.

Still various embodiments of the fan guide vane array 260 provided herein may include at least one vane defining a pylon or aircraft surface (e.g., aircraft surface 3060). It should be appreciated that vane pitch angle changes may desirably alter thrust direction to or away from the pylon surface, such as described herein, to attenuate generation of undesired noise. In some example embodiments, one or more aircraft surfaces, such as the pylon, may include pitch change mechanisms, flaps, or actuators configured to perform substantially similarly as one or more vanes depicted and described herein.

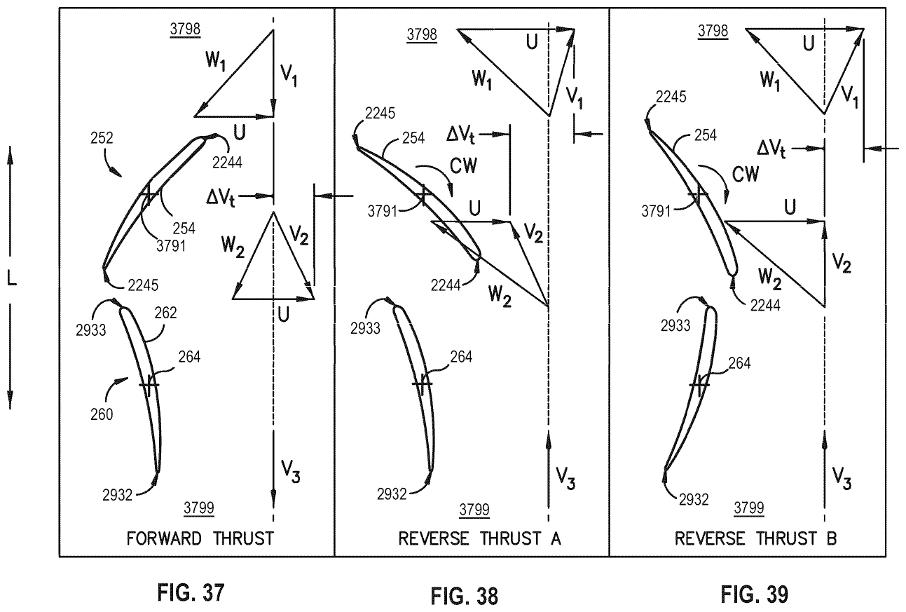

Referring now to FIGS. 37-41, exemplary depictions of adjustments, actuations, or other changes in pitch at the fan blades 245 and/or plurality of fan guide vanes 262 are provided. FIGS. 37-41 provide a radial view of an airfoil profile such as described in regard to FIGS. 2 and 22-36, corresponding to a radial location for which a contribution to reverse thrust is desired, such as the outer span of the fan blade 254. In regard to FIGS. 37-41, closing the fan blade 254, such as changing the pitch of the fan blade 254 toward a closed position, is represented by a clockwise rotation (e.g., depicted via arrows CW) of the airfoil about its respective pitch axis 3791. Closing the fan guide vanes 262, such as changing the pitch of the fan guide vanes 262 toward a closed position, is represented by a counter-clockwise rotation (e.g., opposite of arrows CW) of the airfoil about its respective vane pitch axis 264. In the vector diagrams depicted in FIGS. 37-41, subscript 1 (e.g., V₁, W₁) refers to an airflow condition at a first station forward of the fan 252 (e.g., proximate to forward end 3798). Subscript 2 (e.g., V₂, W₂) refers to an airflow condition at a second station between the fan 252 and the fan guide vane array 260. Subscript 3 (e.g., V₃, W₃) refers to an airflow condition at a third station aft of the fan guide vane array 260 (e.g., proximate to aft end 3799). V₁, V₂, V₃ each refer to absolute velocity at their respective airflow stations. W₁, W₂, W₃ each refer to velocity relative to a rotating frame of reference of the fan 252 at their respective airflow stations. U indicates magnitude and direction of the speed of the fan blade 254 corresponding to the rotational speed and radial location. Axial and tangential velocity components are indicated by the vertical and horizontal components, respectively, of the vectors. Positive tangential velocity components are in the direction of blade speed vector U. The change in tangential velocity that occurs as the flow travels through fan 252, indicated by ΔVₜ, indicates the level or magnitude of loading on the rotor.

It should be appreciated that as the fan 252 rotates about the longitudinal axis 212 of turbofan engine 110, it imparts tangential momentum, or swirl, to the flow, such that the flow exiting the rotor assembly has greater tangential velocity than the flow entering it. If flow enters the fan 252 with zero or substantially zero tangential velocity then the flow exits the rotor with a positive tangential velocity. The flow exiting the fan 252 may have a positive tangential velocity component, a zero or substantially zero tangential velocity component, or a negative tangential velocity component based on the flow entering the fan 252, the blade pitch angle about pitch axis 3791, or speed U of the fan blade 254, or combinations thereof. Residual swirl from forward thrust and reverse thrust operation (i.e., non-zero tangential velocity component in the flow exiting the propulsion system) does not contribute substantially to the thrust capability of the system.

FIG. 37 illustrates the turbofan engine 110 during forward thrust operation. In the embodiment depicted in FIG. 37, the fan 252 and the fan guide vane array 260 are each at or near their exemplary design point or forward thrust position (e.g., nominal position). As the air flows from the first station to the second station, the fan 252 imparts tangential momentum to the air such as to increase the tangential component of the absolute velocity (V) in the direction of rotation. From the second station to the third station, the fan guide vane array 260 removes a substantial portion, or all, of tangential momentum from the flow from the fan 252, resulting in an exit velocity from the fan guide vanes 262 at the third station that has less tangential velocity component. As such, the lower exit tangential velocity component may define, at least in part, a desirably efficient generation of thrust via reduced waste in kinetic energy. Stated differently, the desirably efficient generation of thrust directs kinetic energy generally along the axial or longitudinal direction rather than along a non-axial direction.

FIG. 38 illustrates the turbofan engine 110 during an exemplary thrust reverse operation mode. The fan guide vanes 262 is positioned substantially at or near its design point pitch angle, such as depicted in regard to FIG. 37. For reverse thrust operation, the fan blade 254 is closed, such as via rotation along blade pitch axis 3791 in the CW direction, so that the leading edge 2244 (i.e., the thick end relative to a thinner trailing edge 2245) is aft of the trailing edge 2245. As the fan 252 rotates about the longitudinal axis 212 of turbofan engine 110 with the fan blade 254 in closed position, the fan 252 induces flow from the second station to the first station. As a result, the fan guide vanes 262 imparts a tangential velocity component opposite to the direction of rotation of the fan 252 (i.e., counter-swirl) as the flow progresses from the third station to the second station. Absolute velocity V₂ has a negative tangential velocity component, and the effect of the fan 252 is to result in absolute velocity V₁ with reduced or eliminated negative tangential velocity component. This results in increased rotor loading and increased reverse thrust output relative to a system without a stationary vane row. With increased rotor loading, the change in angle of the relative velocity from W₂ to W₁ increases due to a higher negative tangential component of W₂. With the increase in loading on the rotor, the departing reverse thrust relative velocity W₁ may have a higher negative tangential component and less swirl component in the departing absolute velocity W₁ than a system without a stationary vane row.

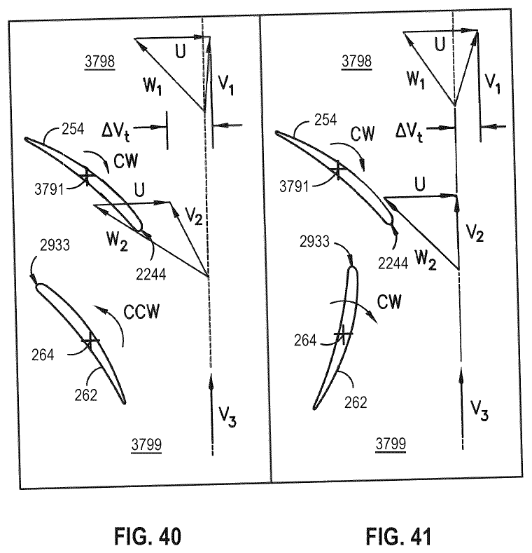

Referring now to FIG. 40, another thrust reverse operation mode is depicted. In FIG. 40, the fan guide vanes 262 is closed (i.e., rotated CCW along the vane pitch vane pitch axis 264) relative to its design point pitch angle (e.g., such as the vane depicted in FIG. 37). Relative to the example depicted in FIG. 38, closing the fan guide vanes 262 increases the counter-swirl entering the fan blade 254, such as to increase reverse thrust output via increased rotor loading at the fan blade 254. The increased rotor loading may increase the negative tangential component of the relative velocity W₁ departing the fan blade 254 and provide a reduced exit swirl. If the increased loading on the fan blade 254 produces excess reverse thrust or exit swirl, the fan blade 254 may be opened (i.e., rotated CCW along the blade pitch axis 3791) to enhance the desired effect.

FIG. 41 depicts the fan guide vanes 262 opened (i.e., rotated CW along the vane pitch vane pitch axis 264) relative to its design point pitch angle. In certain instances, methods or operations may desirably reduce or spoil thrust reverse such as depicted in FIG. 41, such as via opening the vane pitch angle to generate a resultant tangential velocity component at the first station. Desirably reducing or spoiling thrust reverse via altering the vane pitch angle allows for reducing thrust without changing rotor blade pitch 3791 angle or rotational speed at the fan 252. As such, reverse thrust output may be desirably altered without altering core engine speed or output, or while maintaining substantially constant core engine speed, such as described herein. It should be appreciated that spoiling reverse thrust such as described herein may mitigate risks or damage related to core engine or rotor assembly overspeed, changes in torque output at the core engine or rotor assembly, or other transient operations at the core engine or rotor assembly. However, it should further be appreciated that alteration or adjustment of vane angle for a desired thrust output may be performed with changes at the core engine and/or rotor assembly.

Referring now to FIG. 39, another thrust reverse operation mode is depicted. The fan guide vanes 262 is opened (i.e., the fan guide vanes 262 is rotated CW along the vane pitch vane pitch axis 264) relative to its design point, or nominal, pitch angle such as to reduce the negative tangential velocity component at the second station relative to the thrust reverse mode depicted in regard to FIG. 38. The reduced tangential velocity opposite of the rotation of the fan blades 245 (i.e., counter-swirl) tends to unload the fan 252. However, the pitch angle of the fan blade 254 is closed (i.e., rotated CW along the blade pitch axis 3791) an additional amount to at least partially recover the rotor loading and impart a change in absolute tangential velocity from the second station to the first station, such as described in regard to FIG. 38. Reverse thrust output may be reduced or spoiled by way of opening the plurality of fan guide vanes 262 while maintaining a substantially constant operation of the engine core 218 and/or without changing blade pitch angle or rotational speed.

In various example embodiments, the fan blade 254 is formed such that the stagger angle varies from hub to tip to accommodate the desired flow vectors and loading distribution along the blade span. The varied stagger angle may allow for forward thrust output from a lower span of the blade and reverse thrust output from an upper span of the blade. In one embodiment, the blade is configured to generate forward flow below 50% span. In still another embodiment, the blade is configured to generate reverse flow at or above 50% span. In still various example embodiments, the vane is configured to change angle up to 15 degrees open and up to 15 degrees closed from the design point to adjust reverse thrust such as described above. In another embodiment, the vane is configured to change up to 10 degrees open and up to 10 degrees closed from the design point to adjust reverse thrust such as described above. In yet another example embodiment, the vane is configured to change angle up to 5 degrees open and up to 5 degrees closed to adjust reverse thrust such as described above.

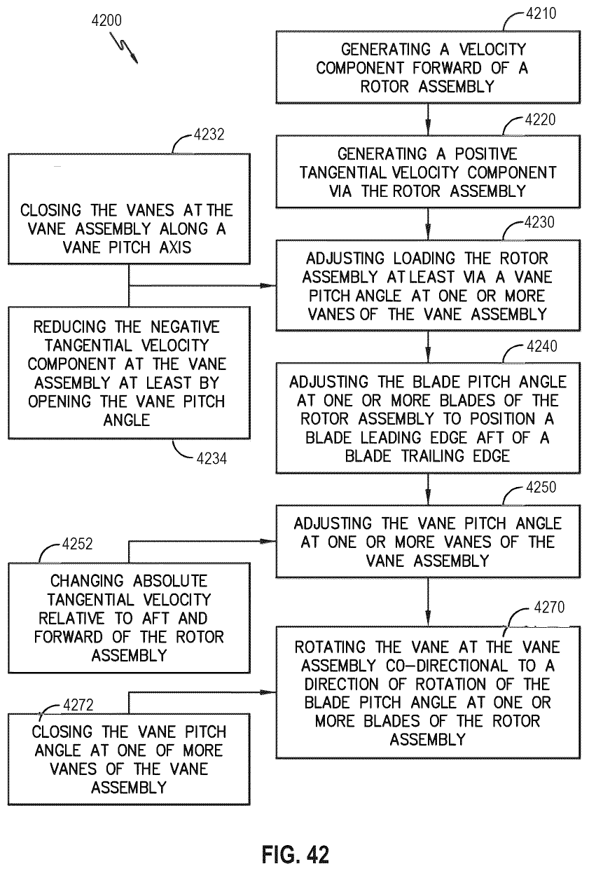

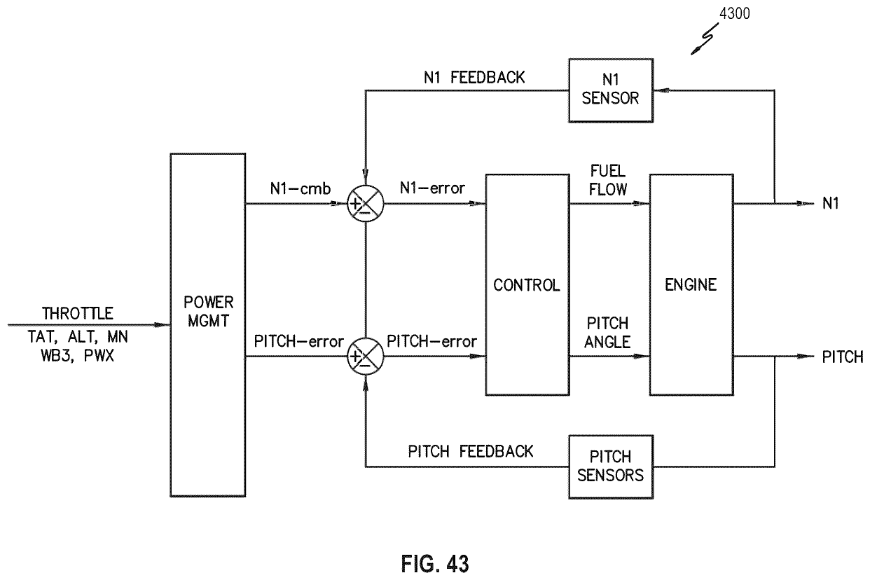

Referring now to FIG. 42, a method for adjusting thrust vector for an unducted rotor engine is provided, (hereinafter, “method 42000”). Embodiments of the method 42000 provided herein may particularly provide for altering or adjusting thrust direction and magnitude for an unducted rotor engine. Certain embodiments provide for control and generation of reverse thrust for an unducted rotor engine. Still certain embodiments provide for control and generation of thrust and desirably altering a tangential velocity component of the flow exiting the rotor assembly. Embodiments of the method 42000 may be applied with gas turbine engines with articulatable fan or propeller rotor pitch axis and vane assembly pitch axis, such as depicted in all or part of the embodiments of the turbofan engine 110 provided in regard to FIGS. 2 and 22-41. Steps of the method 42000 may be store and executed via a controller, such as one or more controllers depicted and described in FIGS. 43-49. However, it should be appreciated that the method 42000 may be executed with other configurations of unducted rotor engine.

The method 42000 includes at 4210 generating, via rotation of a rotor assembly, a flow of air from a first station forward of the rotor assembly to a second station aft of the rotor assembly. In a particular embodiment, the rotor assembly generates the flow of air from forward of the rotor assembly to aft of the vane assembly. In some example embodiments, the method 42000 further includes generating an aft axial velocity component of the flow of air from aft of the vane assembly to forward of the rotor assembly at least by closing a blade pitch angle at one or more blades at the rotor assembly. At 4220, the method 42000 includes generating a positive tangential velocity component of the flow of air via the rotor assembly. It should be appreciated that the positive tangential velocity component is along a first direction corresponding to the direction of rotation of the rotor assembly. A negative tangential velocity component is along a second direction opposite of the first direction.

In some example embodiments, the method 42000 includes at 4230 increasing loading at the blades of the rotor assembly. In one embodiment, increasing loading at the blades of the rotor assembly includes closing the blade pitch angle when generating reverse thrust via a flow of air from aft of the rotor assembly to forward of the rotor assembly, such as described in regard FIG. 38. In another embodiment, increasing loading at the blades of the rotor assembly includes closing a vane pitch angle at the vane assembly. In one embodiment, increasing loading at the rotor assembly includes at 4232 closing the pitch angle of the vane at the vane assembly and the blade at the rotor assembly. In some example embodiments, the method 42000 includes at 4234 reducing the negative tangential velocity component of the flow of air from the vane assembly at least by opening the vane pitch angle.

In additional example embodiments, the method 42000 includes at 4240 adjusting the blade pitch angle at one or more blades of the rotor assembly to position a blade leading edge aft of a blade trailing edge, such as depicted and described in regard to FIGS. 37-39. In particular embodiments, rotating the rotor assembly after adjusting the blade pitch angle generates the positive tangential velocity component of fluid from the rotor assembly.

In still various example embodiments, the method 42000 includes at 4250 adjusting the vane pitch angle at one or more vanes of the vane assembly. In one embodiment, adjusting the vane pitch angle includes reducing loading at the rotor assembly. In some example embodiments, the method 42000 includes at 4252 changing absolute tangential velocity relative to aft and forward of the rotor assembly. Changing absolute tangential velocity is based at least on adjusting blade pitch angle relative to vane pitch angle.

In some example embodiments, the method 42000 includes at 4270 rotating the vane at the vane assembly co-directional to a direction of rotation of the blade pitch angle at one or more blades of the rotor assembly. In one embodiment, the method 42000 includes at 4272 closing the vane pitch angle at one or more vanes of the vane assembly. In a particular embodiment, closing the vane pitch angle at one or more vanes of the vane assembly includes reducing a negative tangential velocity component at the vane assembly. In still another embodiment, closing the vane pitch angle at one or more vanes of the vane assembly includes increasing counter-swirl of the flow of air from the vane assembly, such as described and depicted in regard to FIGS. 40-41.

Referring now to FIGS. 43-49, diagrams outlining steps for operation of an unducted rotor engine are provided. The methods and diagrams provided herein may be utilized with various embodiments of a single unducted rotor engine, such as turbofan engine 110 depicted and described herein. However, it should be appreciated that the methods provided herein may be utilized to control engines generally including one or more of a rotor blade pitch change mechanism, a vane pitch change mechanism, a rotor angle of attack change mechanism, or combinations thereof.

Conventional turbofan engines generally control engine thrust by measuring corrected fan speed or overall engine pressure ratio and correlating one or both measurements to desired engine thrust based on an aircraft flight condition. However, methods for controlling and operating an unducted single rotor engine, such as depicted and described herein, include adjusting, to generate and adjust thrust output, a rotational speed (e.g., mechanical speed, corrected speed, etc.) of the rotor assembly (e.g., fan 252), a rotor blade pitch (e.g., at axis 3791) at the rotor assembly, a torque (e.g., torque on a fan or propeller shaft), engine pressure ratio (e.g., P56/P2), or core engine pressure ratio (e.g., P56/P25). The method includes generating or adjusting thrust output based at least on a performance map, curve, table, or other reference position or function of the rotor assembly as a function of rotor blade pitch (e.g., at axis 3791). In various example embodiments, the method further includes generating or adjusting thrust output based on rotational speed of the rotor assembly or a flight condition (e.g., takeoff, climb, cruise, approach, landing, etc., or one or more air conditions related thereto, including air speed, pressure, temperature, density, humidity, or other environmental condition).

In some example embodiments, the method includes determining or adjusting engine thrust output based at least on an engine cycle model, such as the power management and engine cycle model block (power management block) depicted in FIGS. 43-49. In one embodiment, a controller 4300 includes one or more, or multiple, single-input, single-output (SISO) loops or a combination of SISO and multi-input, multi-output (MIMO) loops to provide dynamic coordination or adjustment between blade pitch changes (e.g., blade pitch 3791 at one or more fan blades 245), vane pitch changes (e.g., vane pitch 264 at one or more plurality of fan guide vanes 262), rotor plane changes (e.g., rotor plane 2934), core engine speed changes (e.g., engine core 218), electric machine load changes, or combinations thereof.

Referring to FIG. 43, operations or method steps executed at the controller 4300 may include receiving or obtaining, at the power management block in the control logic, a throttle input. In various example embodiments, the schematic controller 4300 depicted in regard to FIG. 41 is a sensor-based controller that infers a desired thrust output based on a lookup table, chart, schedule, or other reference. The throttle input is mapped to one or more of a desired rotor speed, a desired torque, a desired thrust output, a desired pressure ratio across the engine and/or rotor assembly, while adjusting to or otherwise accounting for environmental conditions related to an aircraft state at the corresponding moment or period of time (e.g., air speed, pressure, temperature, density, humidity, altitude, etc.). In a first control loop, the engine cycle model or power management block outputs a signal indicative of a desired thrust output. In some example embodiments, the signal is a commanded rotor blade pitch angle and/or commanded vane pitch angle, such as described in regard to fan 252 and/or fan guide vane array 260 herein. A difference between a commanded pitch angle, measured pitch angle (i.e., pitch error), is received at a controller (e.g., Control) configured to control, adjust, or otherwise articulate the rotor blade pitch and/or vane pitch, such as via a respective rotor blade pitch change mechanism or vane pitch change mechanism. The turbofan engine 110 adjusts the rotor blade pitch angle 3791 based on the commanded adjustment. In various example embodiments, a pitch sensor obtains, receives, measures, or otherwise acquires an actual rotor blade pitch angle at one or more of the plurality of rotor blades (e.g., fan blade 254), at a synchronization ring (e.g., scheduling ring 2420), or at one or more slots (e.g., slot 2430) at the rotor blade pitch change mechanism (e.g., blade pitch change mechanism 48). The pitch sensor provides an output signal to a difference function, at which a difference or delta between the commanded rotor blade pitch angle from the engine cycle model is compared to the actual rotor blade pitch angle obtained from the pitch sensor.

In some example embodiments, the turbofan engine 110 adjusts the vane pitch angle 264264 based on the commanded adjustment. In various example embodiments, a pitch sensor obtains, receives, measures, or otherwise acquires an actual vane pitch angle at one or more of the plurality of vanes (e.g., fan guide vanes 262), at a synchronization ring, or at one or more slots at the vane pitch change mechanism (e.g., vane actuation system 3548). The pitch sensor provides an output signal to a difference function, at which a difference or delta between the commanded vane pitch angle from the engine cycle model is compared to the actual vane pitch angle obtained from the pitch sensor.

Referring still to FIG. 43, the controller 4300 includes a second control loop, at which the engine cycle model outputs a commanded low spool parameter (e.g., N₁-cmd, such as referring to a LP shaft 238 including the LP compressor 226 and the LP turbine 234 in FIG. 2). A difference (e.g., N₁ error), based at least on the commanded low spool parameter and adjusted based at least on an actual N₁ parameter obtained or measured from an N₁ sensor (e.g., N₁ feedback), is provided to the controller (e.g., Control). The controller outputs an engine control signal, including, but not limited to, a commanded fuel flow to the engine (e.g., combustion section 4048 in FIG. 1). The commanded fuel flow to the engine, such as the combustion section, includes or one or more of a fuel flow rate, pressure, temperature, or a valve, orifice, manifold, area, or volume adjustment corresponding to the commanded fuel flow, or other parameter that may affect an amount of fuel provided to the combustion chamber for generating combustion gases. The actual N₁ parameter corresponds to the commanded N₁ parameter and may include one or more of a low speed spool rotational speed (e.g., mechanical speed, corrected speed, etc.) torque (e.g., propeller shaft torque), or pressure ratio (e.g., pressure ratio across one or more compressors, or overall pressure ratio across the engine or core engine).

Although FIG. 43 depicts a first control loop and a second control loop controlling rotor blade pitch 3791 and rotational speed of the fan 252, it should be appreciated in other additional or alternative embodiments, control for rotational speed of the fan 252 may be replaced by, or augmented by, control of torque or engine pressure ratio (e.g., pressure measured, by a sensor, downstream of the turbine section, by a sensor, upstream of the compressor section over pressure measured, such as P56/P2) or core engine pressure ratio (e.g., pressure measured downstream of a turbine of the turbine section over pressure measured between a low pressure compressor and a high pressure compressor, such as P56/P25), or core engine rotational speed.

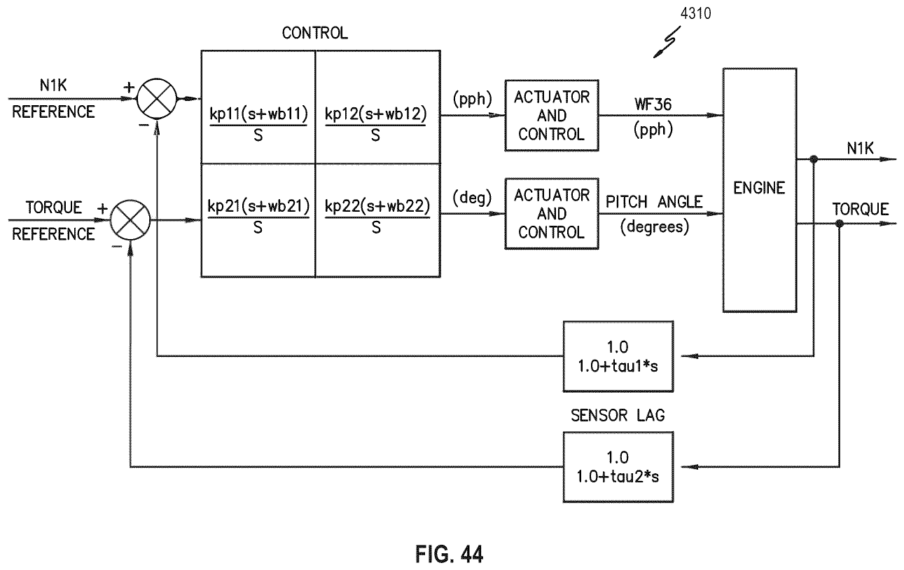

Referring now to FIG. 44, in yet other embodiments, steps of the for operating the engine may include providing a controller 4310 including two or more control loops. Various embodiments of the controller 4310 may be configured substantially similarly as depicted and described in regard to controller 4300 in regard to FIG. 43. In some example embodiments, the controller 4310 may include two or more control loops configured to control an engine using at least two parameters indicative of thrust. It should be appreciated that In some example embodiments, the two or more parameters indicative of thrust include a vane pitch angle 264 at a fan guide vane array 260 positioned in aerodynamic relationship with the rotor assembly (e.g., the fan guide vane array 260 with adjustable vane pitch angle 264 relative to the fan 252). In one embodiment, such as depicted in FIG. 44, the two or more closed control loops may include a combination of a fan or propeller speed and fan or propeller system torque, or a combination of fan or propeller speed and a pressure ratio such as described herein.

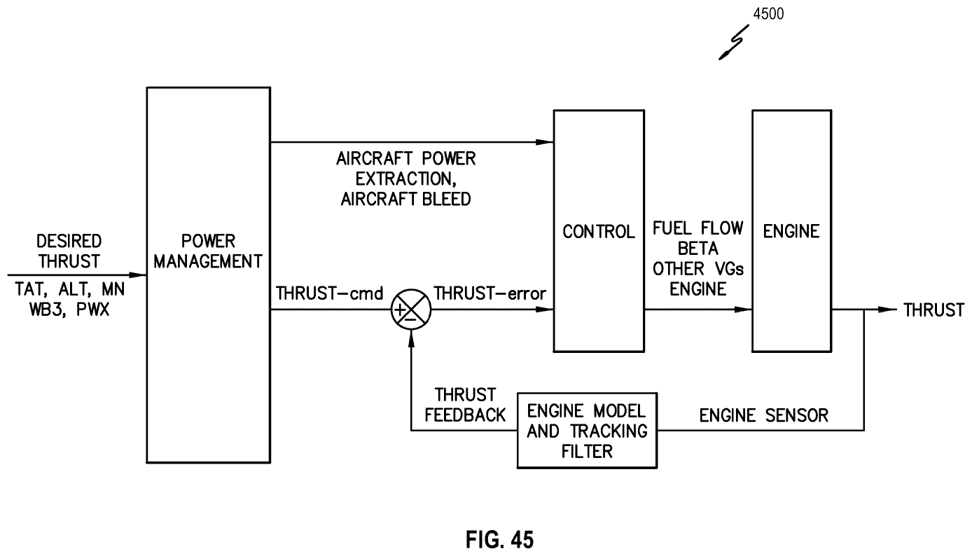

In still various example embodiments, the controller 4310 may include three or more control loops. For instance, a third loop may add another feedback parameter based on sensed or calculated variables to manipulate or modulate another effector such as other variable geometry (VG) (e.g., one or more stator vanes, an inlet guide vane, bleed valves, etc.) or other mechanism for modulating power or airflow. Control of two or more loops may be performed by a multi-input, multi-output (MIMO) controller, such as depicted in FIGS. 44-45. In still various example embodiments, control of two or more loops may be performed by several single-input, single-output (SISO) controllers, or combinations of MIMO and SISO controllers.

Referring now to FIGS. 45, another embodiment of a controller 4500 configured to execute steps of the method for operating a single unducted rotor engine is provided. The methods and diagrams provided herein may be utilized with various embodiments of a single unducted rotor engine such as depicted and described herein. However, it should be appreciated that the methods provided herein may be utilized to control engines generally including one or more of a rotor blade pitch change mechanism, a vane pitch change mechanism, a rotor angle of attack change mechanism, or combinations thereof. The power management block may further output an aircraft power extraction signal indicative of bleed air, electrical load, or other power extractions from one or more engines for aircraft systems (e.g., thermal management, environmental control system, electrical or electronic systems, etc.).

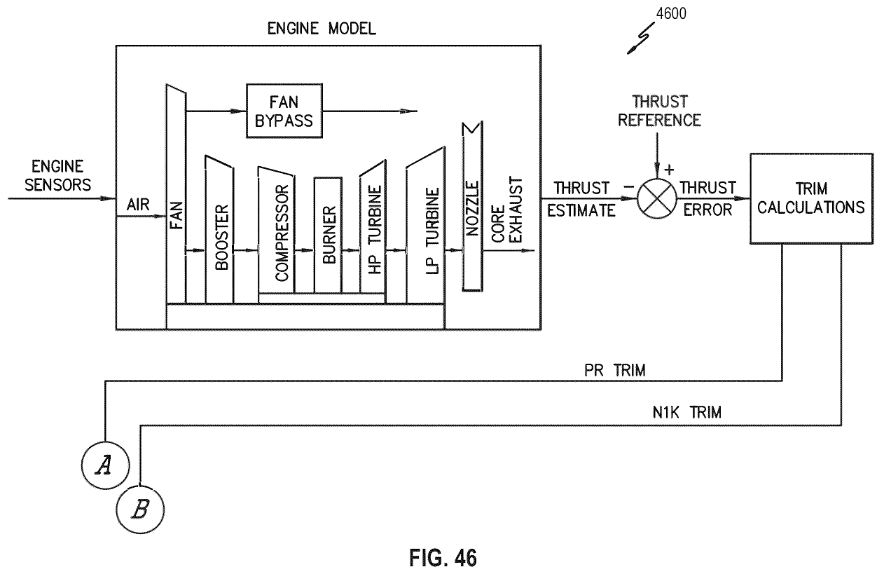

Referring to FIGS. 46-49, the schematic controller 4600 depicted is configured as a model-based controller, such as depicted at FIG. 46, configured to calculate a desired output thrust based at least on an engine operating parameter including fuel flow, variable geometry (e.g., vane pitch angle, blade pitch angle, compressor vane or bleed opening/closing, fuel flow controls, etc.), and flight condition (altitude, Mach number, ambient air temperature and/or pressure, one or more aircraft loads, such as, but not limited to, aircraft electrical loads, thermal or environmental control system bleeds, or other aircraft bleeds and power extractions). Steps of the method for operation may include receiving or obtaining at the controller 4600, or particularly at the power management block of the control logic, a desired thrust output, such as from a throttle input. The power management block determines or otherwise calculates commanded positions for variable geometries (VGs) (e.g., variable vane angles, actuator positions, bleed valve open/close positions, or other variable geometries) as well as the commanded fan speed or corrected fan speed. The controller (e.g., Control) receives the difference between the commanded thrust output signal and an actual or estimated thrust output signal from an engine model and tracking filter. The controller provides to the engine an output signal corresponding to one or more of a commanded fuel flow (e.g., flow rate, pressure, temperature, etc.), a rotor blade pitch angle, a vane pitch angle, a rotor plane angle at the rotor assembly, or one or more other variable geometries (e.g., Other VGs), such as, but not limited to, a variable vane or bleed valve at a compressor section, a bypass valve or flow, a turbine nozzle area, an inlet guide vane of a compression stage feeding a third-stream flowpath, booster or low pressure compressor variable stator vanes, or third-stream variable nozzle, or one or more actuator positions corresponding thereto. The engine receives the output signal from the controller and generates an actual thrust output based on the output signal from the controller. One or more engine signals corresponding to one or more engine sensors, such as a torque sensor, low spool speed measurement (e.g., N₁ speed), high spool speed measurement (e.g., N₂ speed), other spool speed measurements (e.g., intermediate spools for 3-shaft engines, fan shaft speeds for geared engine arrangements, etc.), a rotor blade pitch angle measurement, a vane pitch angle measurement, a rotor plane position measurement, or one or more actuator positions corresponding to the variable geometries articulated by the output signal, or an acoustic sensor (e.g., microphone, vibration sensor, accelerometer, etc.) is provided from the engine and obtained by the engine model and tracking filter. A thrust feedback signal is generated from the engine model and tracking filter based on one or more engine signals corresponding to one or more engine sensors.

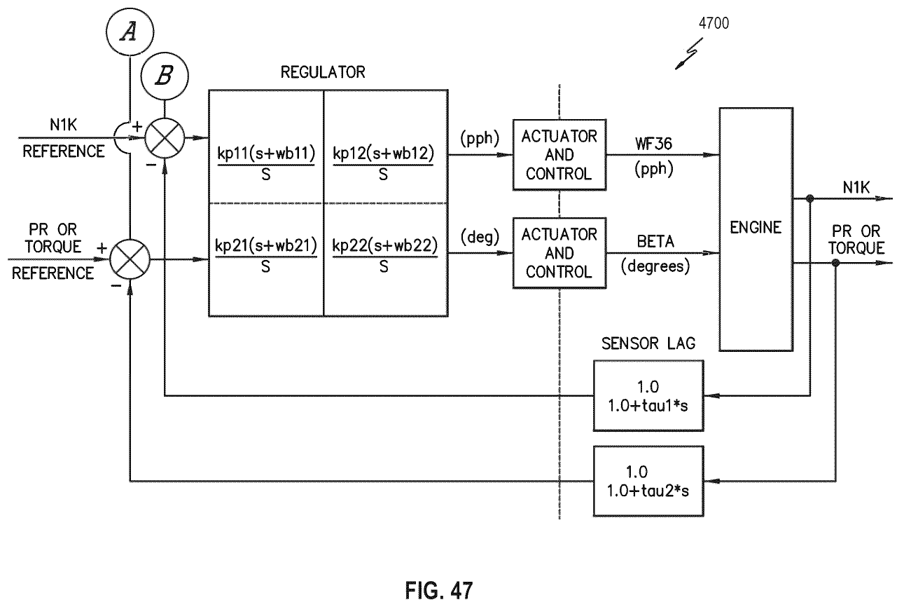

Referring to FIGS. 46-49, In some example embodiments, the engine, aircraft, system, or method may include a computing system 4700 including a sensor-based controller (also referred to as a first controller), such as depicted in FIGS. 47-49, and a model-based controller (also referred to as a second controller), such as depicted in FIG. 46. The computing system 4700 may be configured substantially similarly such as depicted and described in regard to a plurality of control devices such as depicted and described in regard to FIGS. 43-45 (e.g., controller 4300, 4310, 4500). In one embodiment, a model-based controller, such as depicted in FIG. 46 or configured such as controller 4500 depicted in regard to FIG. 43, is utilized as a supervisory controller to provide a trim or adjustment to engine operation and performance, such as described herein. In one instance, the model-based controller may alter or vary engine output thrust within a 7% margin (e.g., +/−3.5%) of a set condition. In another instance, the model-based controller may alter or vary engine thrust output within a 5% margin (e.g., +/−2.5%) of a set condition. In yet another instance, the model-based controller may alter or vary engine thrust output within a 2% margin (e.g., +/−1%) of a set condition.

In various example embodiments, such as at least one example embodiment depicted in FIG. 46, the computing system 4700 includes a model-based trim function providing one or more trims or adjustments to controller commands to improve engine performance or operability based on a current operating state of the engine, aircraft, and environmental parameter. In various example embodiments, the model-based or state-aware scheme includes a parameter estimation algorithm, also known as a tracking filter, to update the model to match actual engine characteristics or engine health, such as engine deterioration.

The sensor-based controller, such as depicted in FIGS. 47-49 or configured such as controller 4300, 4310 depicted and described in regard to FIGS. 43-44, may provide control and adjustment for changes in thrust output greater than the trim or adjustment levels of the model-based controller. In various instances, the sensor-based controller may provide for transient changes in engine operating condition, such as to and between two or more of ignition, idle, takeoff, climb, cruise, descent, approach, or thrust reverse. In other instances, the model-based controller may provide for adjustments during substantially steady state engine operating condition.

Referring to FIGS. 43-49, embodiments of methods for operation of an unducted rotor engine may adjust, change, articulate, or actuate one or more of a rotor blade pitch, a vane pitch, a rotor plane (e.g., via an Angle of Attack change mechanism), low spool speed, high spool speed, or combinations thereof, such as via one or more controllers 4300, 4310, 4500, 4600, or combinations thereof.

As such, a computing system for an unducted rotor engine is provided in which the computing system includes one or the other, or both, of a sensor-based controller or a model-based controller such as described herein. The sensor-based controller is configured to execute a first set of operations, such as those described herein, including obtaining a first signal corresponding to a commanded low spool speed. obtaining a second signal indicative of a pitch angle corresponding to thrust output from the unducted rotor assembly and variable pitch vane assembly, and generating a pitch feedback signal corresponding to a commanded adjustment to the pitch angle based at least on one or both of a variable blade pitch angle or a variable vane pitch angle.

In various example embodiments, the first set of operations executed by the sensor-based controller include obtaining a throttle input corresponding to one or more of a desired air speed of an aircraft, a desired thrust output, or a desired pressure ratio, generating the first signal corresponding to the commanded low spool speed, and generating the second signal indicative of the pitch angle corresponding to thrust output at the rotor assembly. In a particular embodiment, the first set of operations further includes generating a low spool speed feedback signal corresponding to the commanded fuel flow.

In certain embodiments of the computing system including the model-based controller and the sensor-based controller, the sensor-based controller is configured to generate the pitch feedback signal during transient changes in engine operating condition. Such as described herein, transient changes in engine operating condition may include conditions to and between two or more of ignition, idle, takeoff, climb, cruise, descent, approach, or thrust reverse.

Additionally, or alternatively, the computing system includes the model-based controlled configured to execute a second set of operations such as described herein, including obtaining a desired thrust output via a throttle input, determining, at least via a power management block, a commanded thrust output signal, receiving the commanded thrust output signal, and generating an output signal corresponding to one or more of a commanded fuel flow to a combustion section, a variable blade pitch angle, a variable vane pitch angle, or a rotor plane angle. In some example embodiments, the model-based controller, when included in the computing system with the sensor-based controller, is configured to generate the output signal during substantially steady state engine operating condition.

In additional example embodiments, the second set of operations executed by the model-based controller includes receiving, via a sensor at the engine, an engine signal corresponding to one or more of a torque, a low spool speed, a high spool speed, a rotor blade pitch angle, a vane pitch angle, a rotor plane position, or one or more actuator positions corresponding to a variable geometry, or an acoustic sensor, and generating a thrust feedback signal based at least on the engine signal.

In some example embodiments, desired thrust and/or desired acoustic noise level is generated at least by adjusting the rotor blade pitch via a rotor blade pitch change mechanism as a function of one or more of rotor assembly speed (e.g., N₁ speed), core engine speed (e.g., N₂ speed), and environmental conditions of the incoming air (including angle of attack, speed, temperature, pressure, humidity, etc.). In some example embodiments, desired thrust and/or acoustic noise level is generated at least by adjusting two or more parameter indicative of thrust output. In particular embodiments, the two or more parameters indicative of thrust output includes the rotor blade pitch at the rotor assembly and/or vane pitch angle at the vane assembly in aerodynamic relationship with the rotor assembly, such as described herein. As such, thrust output may be altered or generated by articulation of the vane assembly such as described herein. Furthermore, operation of the engine may use fuel flow to the core engine and rotor blade pitch and/or vane pitch changes to control rotor assembly (e.g., fan or propeller speed) in addition to engine pressure ratio, core speed, or rotor assembly torque. In some example embodiments, methods for operating the engine include operating the core engine at a substantially constant speed during one or more of ground operation (e.g., ground idle, taxi, etc.), takeoff, climb, cruise, approach, landing, or thrust reverse. Operating the core engine at a substantially constant speed may improve engine efficiency and performance by allowing the core engine to operate substantially at or within an operating band (e.g., within 5%) of an aero design point (e.g., a design point for maximum performance in contrast to other operating conditions or speeds) for the core engine. Furthermore, operating the core engine at a substantially constant speed may contrast with control systems or methods generally directed to operating an engine at a substantially constant fan or propeller speed while adjusting gas generator or core speed.

In contrast to gas turbine engine configurations such as turbofans, embodiments of the engine provided herein allow for thrust control based substantially on rotor blade pitch adjustment (e.g., via fan actuation system 2248), vane pitch adjustment (e.g., via vane actuation system 3548), or both. In some example embodiments, the engine core 218 may operate at a substantially constant speed, such as to provide electricity, air, or other services to an aircraft, such as for an environmental control system, a thermal management system, or powering avionics or the aircraft generally. Operating the core engine (e.g., engine core 218) at a substantially constant speed may allow embodiments of the engine provided herein, as a propulsion system, to obviate a separate auxiliary power unit (APU) for an aircraft. As such, aircraft weight and complexity may be reduced by allowing the propulsion unit to provide power and services during ground operation that may conventionally be provided by an APU.

In additional example embodiments, such as in regard to turbofan engine 110, substantially constant speed operation of the LP shaft 238 and/or the HP shaft 236 may be allowed by rotating the rotor blade pitch 3791 to reduce or increase thrust, including producing little or no thrust from the rotor assembly when desired (e.g., ground operations), substantially independent of speed of the engine core 218 during operation of the turbofan engine 110. For example, the fan 252 may reduce or spoil thrust output from the rotor assembly such as described in regard to FIGS. 40-41. Furthermore, or alternatively, thrust output may be adjusted by rotating about the vane pitch axis 264 to reduce or increase thrust output, or to change thrust vector (e.g., reverse thrust, or provide substantially axial thrust to correct for angle of attack). As such, In some example embodiments, methods and controllers provided herein allow for thrust control via modulating or adjusting blade pitch angle and vane pitch angle while maintaining substantially constant speed or torque of the core engine.

Embodiments of methods for control provided herein as may be stored or executed by one or more controllers 4300, 4310, 4500, 4600 may be utilized to desirably control rotor dynamics, such as vibrations, beat frequencies, acoustics, etc. via trim controls or adjustments to blade pitch angle, vane pitch angle (e.g., altering loading at one or more of the rotor assembly and/or the vane assembly), or rotor plane angle. In still various example embodiments, methods and systems for control depicted and described herein may include a supervisory controller configured as a model-based controller. The supervisory controller may include an online optimization program to improve fuel burn, perceived or measured noise levels, combustor tones or dynamics, emissions output, or other control or performance parameters, while maintaining desired thrust output within operability limits.

Additionally, or alternatively, methods provided herein as may be stored or executed by one or more controllers 4300, 4310, 4500, 4600 may be utilized to desirably adjust or articulate blade pitch angle and/or vane pitch angle over a desired quantity of iterations, such as to determine a desired thrust output versus core engine speed, to remove or mitigate icing build up at a transient aircraft operating condition (e.g., during takeoff through icing conditions). In one embodiment, the controller receives an input signal indicative of an environmental parameter at which icing conditions may be present. The controller may generate an output signal corresponding to relatively rapid movements or changes in one or both of blade pitch angle or vane pitch angle to mitigate formation or build-up of ice at the rotor assembly or the vane assembly. The generated output signal may further be based at least on a torsional mode shape of the fan blade 254 or the fan guide vanes 262, such that the output signal corresponds to a desired frequency (e.g., a resonance frequency). The method may include intermittent changes in pitch such as to remove icing build-up or mitigate ice build-up.

In addition to, or alternative to, steps of a method for operating an unducted rotor engine provided above, embodiments of the method or operations provided herein may particularly provide for altering or adjusting thrust direction and magnitude, mitigating, or eliminating beat frequency, reducing undesired acoustics, reducing or removing ice or debris build-up on a rotor assembly, and/or improve thrust match for an unducted rotor engine.

Although embodiments of the method or operations may be applied with all or part of the embodiments of the turbofan engine 110 provided herein, certain embodiments of the turbofan engine 110 may include a computing system configured to execute one or more steps of the method provided herein. However, it should be appreciated that the embodiments of the method, or portions thereof, may be executed with other configurations of unducted rotor engine, gas turbine engine, or turbomachine.

In various example embodiments, the method or operations includes operating a core engine and a rotor assembly to generate thrust output. In some example embodiments, such as the engine or portions thereof described herein, the core engine speed and the rotor assembly speed may be operated substantially separately or at least partially independently of one another. For instance, blade pitch angles at one or more blades of the rotor assembly may be altered to reduce or eliminate rotation of the rotor assembly while the core engine is operating. As such, In some example embodiments, the method or operations includes determining a desired thrust output versus speed of the core engine.

In still various example embodiments, the method includes determining a desired first blade pitch at the first blade of the rotor assembly and determining a desired second blade pitch at the second blade of the rotor assembly. The method may include generating an output signal based at least on the determined desired thrust output versus speed of the core engine. In some example embodiments, such as described herein, thrust vector generated from the rotor assembly may be altered based at least on operating the low speed spool (e.g., including the rotor assembly) at a substantially constant speed based at least on articulating one or both of a first blade or a second blade of the variable pitch rotor assembly relative to a vane pitch angle of a vane assembly aft of the rotor assembly.

The method includes adjusting or altering one or both of a first blade pitch at a first blade of the rotor assembly or a second blade pitch at a second blade of the rotor assembly based on a determined desired thrust output versus speed of the core engine. In some example embodiments, the method includes articulating a first blade of a rotor assembly, such depicted and described herein, such as alter the first blade pitch when articulating the first blade. The method may further include articulating a second blade of the rotor assembly different from the first blade. Articulating the second blade alters the second blade pitch of the second blade differently from the first blade pitch at the first blade, such as depicted and described herein.

In various example embodiments, the method includes receiving an input signal indicative of an environmental parameter within or surrounding the propulsion system. The method or operations includes generating an output signal based on the environmental parameter. The output signal corresponds to adjusting or articulating one or more of the first blade or the second blade of the rotor assembly. In some example embodiments, the environmental parameter corresponds to one or more of a temperature, pressure, flow rate, density, or physical property of fluid entering the engine. In additional example embodiments, the environmental parameter corresponds to a perceived noise, ambient air temperature, ambient air pressure, or icing condition. The environmental parameter may particularly correspond to an operating altitude or attitude of an aircraft to which the engine is attached.

In additional example embodiments, generating the output signal corresponds to a desired frequency of articulation of one or more of the first blade or the second blade of the rotor assembly. In one embodiment, the desired frequency of articulation corresponds to a resonance frequency of one or more of the first blade or the second blade of the rotor assembly. In another embodiment, the desired frequency of articulation is based at least on a torsional mode shape of the first blade or the second blade of the rotor assembly, as described herein.

In yet another example embodiment, articulating the first blade and the second blade of the rotor assembly includes intermittently changing the first blade pitch and the second blade pitch. For example, intermittent changing of the blade pitch may include actuating the first blade pitch and/or the second blade pitch each between a first angle (e.g., theta_{1 first blade pitch}, theta_{1 second blade pitch}, etc.) and a second angle (e.g., theta_{2 first blade pitch}, theta_{2 second blade pitch}).

In various example embodiments, the method includes altering thrust vector based at least on operating the core engine at a substantially constant speed and articulating one or both of the first blade or the second blade of the variable pitch rotor assembly. In one embodiment, the method includes altering thrust vector based at least on operating the low speed spool at a substantially constant speed based at least on articulating one or both of the first blade or the second blade of the variable pitch rotor assembly relative to a vane pitch angle of the vane assembly aft of the rotor assembly. In another example embodiment, the method includes altering thrust vector based at least on operating the high speed spool at a substantially constant speed based at least on articulating one or both of the first blade or the second blade of the variable pitch rotor assembly relative to a vane pitch angle of the vane assembly.

Various example embodiments of the method may be executed with a controller in which all or part of the method is stored as instructions and/or executed as operations at one or more embodiments of an engine, such as the turbofan engine 110 depicted and described herein. In some example embodiments, the method is performed at an engine including a single unducted rotor assembly positioned forward of a vane assembly. In additional example embodiments, the method is executed at an engine including an unducted rotor assembly positioned in aerodynamic relationship with a variable pitch vane assembly.

Still various exemplary embodiments of the method may be executed with an engine including a variable pitch rotor assembly including a single stage of a plurality of blades coupled to a disk in which the plurality of blades includes a first blade configured to articulate a first blade pitch separately from a second blade configured to articulate a second blade pitch. A fixed-pitch or variable-pitch vane assembly may be positioned forward or aft of the variable pitch rotor assembly. The engine includes a core engine including a high speed spool and a low speed spool is operably coupled to the rotor assembly.

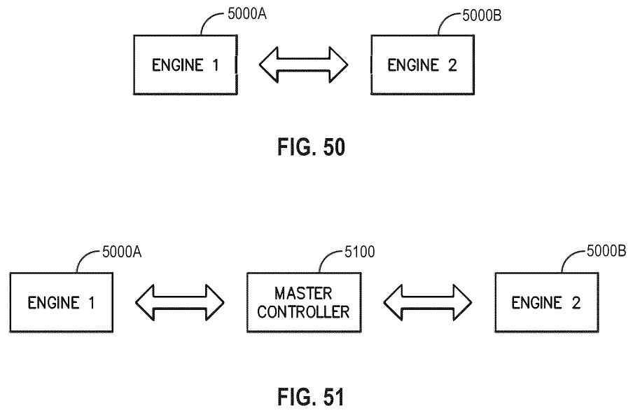

Referring now to FIGS. 50-51, an aircraft with symmetric open rotor engine configurations (e.g., left wing engines 5000B and right wing engines 5000A, or left-side fuselage engines 5000B and right-side fuselage engines 5000A, etc.) may be susceptible to undesired acoustic noise based on acoustic beat interferences due to differences in rotor assembly frequencies between the plurality of engines. It should be appreciated that beat interference or beat frequency is an interference pattern from two or more engines operating at different frequencies, perceived as a periodic variation in volume whose rate is the difference between the two or more frequencies from the respective engines.

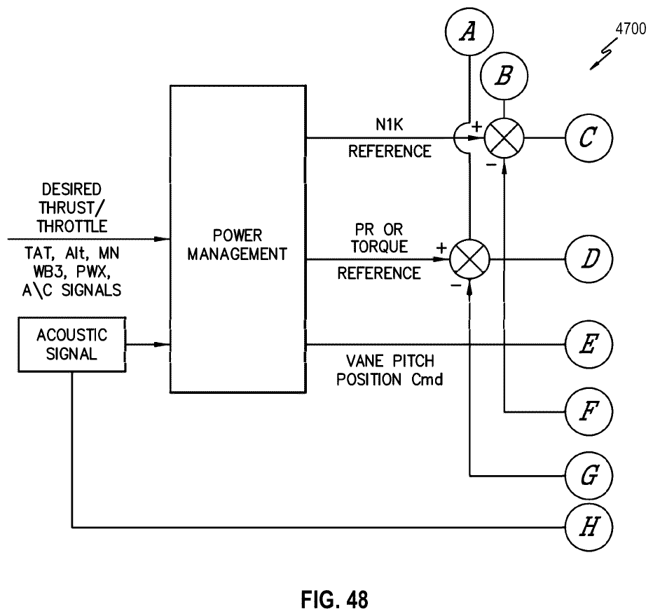

The controllers shown and described in regard to FIGS. 43-49 may be configured substantially similarly as shown and described in regard to FIGS. 50-51. In the embodiment depicted in FIG. 48, a first engine depicted as Engine 1 or turbofan engine 15000A represents one or more right-wing or right-side fuselage engines, and a second engine depicted as Engine 2 or turbofan engine 15000B represents one or more left-wing or left-side fuselage engines. The engine controllers from Engine 1 and Engine 2 are coupled together in analog or digital communication. Cross coupling of the two or more engine controllers allows for communication between the respective engine controllers of an engine operating parameter, such as one or more of the rotor assembly rotational speed, rotor blade pitch angle, vane pitch angle, or rotor plane (e.g., via an Angle of Attack control mechanism). In alternate embodiments, this cross-coupling or communication between engines may be via the aircraft flight control and communication bus.

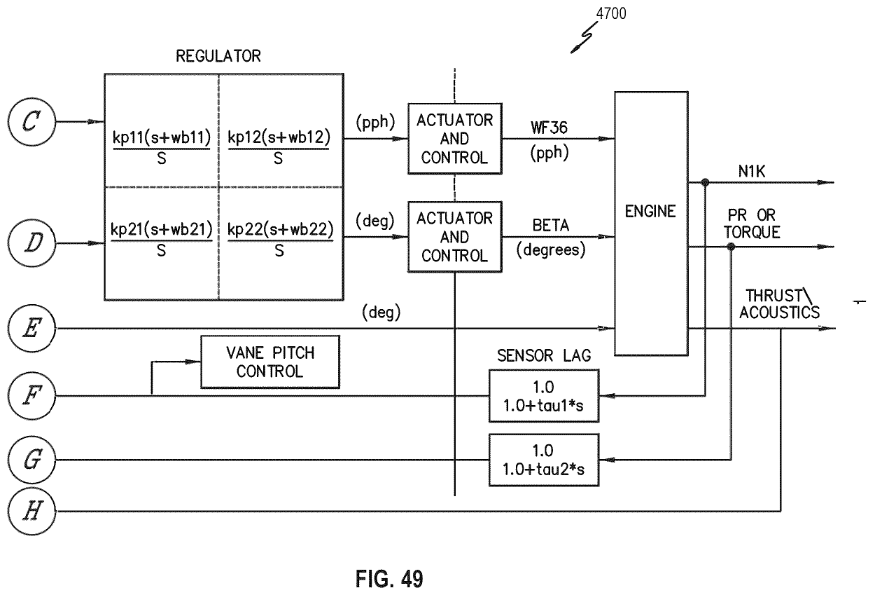

As shown in in FIG. 49, two or more of the engine controls from Engine 1 and Engine 2 are coupled together in analog or digital communication via a master controller 5100. The master controller 5100 is configured to receive inputs from Engine 1 and Engine 2 and determine whether to adjust an engine operating parameter at Engine 1, at Engine 2, or both, to synchrophase the plurality of engines. In some example embodiments, the master controller 5100 is a designated engine controller from either engine 1 or engine 2 (e.g., an engine controller, such as a Full Authority Digital Engine Controller, or FADEC). In other example embodiments, the master controller is an aircraft controller, such as via aircraft avionics. In yet another example embodiment, the master controller is, or is a portion of, a distributed network configured to receive and transmit signals from and to the two or more engines.

In various example embodiments, the designated engine controller is altered or varying between Engine 1 and Engine 2. In such an embodiment, the designated engine controller (e.g., the master controller 5100) may be varied based on a relative engine performance of Engine 1 and Engine 2. In one embodiment, the designated engine controller is based at least on a better-performing engine, in which the better-performing engine is based on one or more of a health parameter, an engine operating parameter, an engine cycle count, an exhaust gas temperature, specific fuel consumption, time-on-wing, or other desired parameter establishing one engine as determinative of an engine operating condition to which another engine will be adjusted to.

In another embodiment, the designated engine controller is based at least on a least-performing engine, such as to define a lowest common denominator of engine performance between Engine 1 and Engine 2. In such an embodiment, the better-performing engine (i.e., not the least performing engine) may be de-tuned, de-rated, or otherwise adjusted to substantially match the engine operating condition of the least-performing engine.

Referring back to FIGS. 50-51, the controller and method determines differences in the engine operating parameter. In some example embodiments, the controller and method further compare the differences in engine operating parameter to one or more of a desired acoustic noise level, a desired thrust output, a health parameter, or a performance parameter (e.g., specific fuel consumption). The controller and method determine one or more adjustments, trims, or other changes to the engine operating parameter based at least on changing rotor assembly (e.g., fan 252) at one or more engines to match the plurality of engines at the aircraft to mitigate undesired noise. The controller and method may further determine one or more adjustments to the engine operating parameter to mitigate or eliminate undesired noise while avoiding asymmetric thrust or power conditions.

The controller and method further adjust the engine operating parameter based on the determined adjustment. In some example embodiments, the method includes decreasing the performance parameter at a first engine to substantially match the performance parameter at a second engine and further synchrophase rotor speeds and outputs to reduce or eliminate beat interferences. In another embodiment, a first engine including a better health parameter may be de-tuned to match a second engine including a relatively worse health parameter to reduce or eliminate beat interferences. In still another embodiment, a first engine including certain desired levels of health parameter or performance parameter may increase or decrease rotor assembly speed, pitch angle, etc. to mitigate or attenuate beat interferences while reducing the health parameter or performance parameter (e.g., reducing within still acceptable or desired limits).

It should be appreciated that embodiments of the method, controller, engine, or aircraft provided herein may include cross coupling two or more engines to improve overall aircraft and system performance and mitigate or eliminate undesired noise, such as beat frequency, while preserving desired thrust output. As such, although certain embodiments may include de-rating or de-tuning an engine to match another engine, it should be appreciated that the two or more engines may define substantially similar performance characteristics.

Embodiments of the method and system provided herein may receive engine parameters from the respective engines and adjust one or more of the core speed (e.g., fuel flow, engine loading via an electric machine or variable vanes, valves, orifices, etc., high spool speed, etc.) or rotor blade pitch angle. The system may additionally adjust vane pitch angle and/or rotor plane angle to improve acoustic noise levels based on other noise sources (e.g., those not based on beat frequency), or to control thrust output level, or to control thrust output vector (e.g., providing a more axial thrust, such as to allow for lower core engine speeds and fuel consumption while maintaining or increasing thrust output at the rotor assembly and vane assembly).

Various embodiments of the turbofan engine 110 depicted and described herein provide novel improvements over known propulsion systems. Embodiments of the turbofan engine 110 include, but are not limited to, one or more ranges of ratios of blades to vanes, length to maximum diameter, vane spacing or orientation (i.e., vane pitch angle) relative to one or more blades or blade pitch angle, or combinations thereof. It should be appreciated that, to the extent one or more structures or ranges may overlap one or more of those known in the art, certain structures with certain turbo machine arrangements may be generally undesired to combine with other structures of other turbo machine arrangements. For instance, turbofan configurations generally include certain quantities of vanes to provide structural support for a casing surrounding a rotor assembly, without providing any teaching or motivation in regard to thrust output and noise abatement particular to open rotor engines.

In still another instance, certain ranges of blades to vanes described herein provide unexpected benefits not previously known in the art, or furthermore, not previously known in the art for single stage unducted rotor assemblies. In still yet another instance, certain ranges of blades to vanes with certain ranges of length to maximum diameter of the engine provide unexpected benefits not previously known in the art, or furthermore, not previously known in the art for single stage unducted rotor assemblies. In still particular embodiments, certain ranges, differences, or sums of blades and vanes provided herein provide unexpected benefits not previously known in the art, such as reduced interaction noise between the fan 252 and the fan guide vane array 260.

Still further, certain embodiments of the turbofan engine 110 provided herein may allow for normal subsonic aircraft cruise altitude operation at or above Mach 0.5, or above Mach 0.75, based at least on ranges or quantities of blades to vanes and/or ranges of blades to vanes and length to maximum diameter, and/or in combination with other structures provided herein. In some example embodiments, the turbofan engine 110 allows for normal aircraft operation between Mach 0.55 and Mach 0.85, or between Mach 0.75 to Mach 0.85 at cruise altitude. In some example embodiments, the turbofan engine 110 allows for rotor blade tip speeds at or less than 750 feet per second (fps). In additional example embodiments, the engine core 218 and fan 252 are together configured to produce a threshold power loading is 25 horsepower per ft² or greater at cruise altitude. In particular embodiments of the turbofan engine 110, structures and ranges provided herein generate power loading between 25 horsepower/ft² and 100 horsepower/ft² at cruise altitude. Still particular embodiments may provide such benefits with reduced interaction noise between the fan 252 and the fan guide vane array 260 and/or decreased overall noise generated by the fan 252 and the fan guide vane array 260. Additionally, it should be appreciated that ranges of power loading and/or rotor blade tip speed may correspond to certain structures, core sizes, thrust outputs, etc., or other structures at the engine core 218 and the fan 252. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art.

It should furthermore be appreciated that certain unexpected benefits of various embodiments of the turbofan engine 110 provided herein may provide particular improvements to propulsion systems in regard to thrust output and acoustic levels. For instance, quantities of blades greater than those of one or more ranges provided herein may produce noise levels that may disable use of an open rotor engine in certain applications (e.g., commercial aircraft, regulated noise environments, etc.). In another instance, quantities of blades less than those ranges provided herein may produce insufficient thrust output, such as to render an open rotor engine non-operable in certain aircraft applications. In yet another instance, quantities of vanes less than those of one or more ranges provided herein may fail to sufficiently produce thrust and abate noise, such as to disable use of an open rotor engine in certain applications. In still another instance, quantities of vanes greater than those of ranges provided herein may result in increased weight that adversely affects thrust output and noise abatement.

It should be appreciated that embodiments of the turbofan engine 110 including one or more ranges of ratios, differences, sums, or discrete quantities of fan blades 245 to plurality of fan guide vanes 262 depicted and described herein may provide advantageous improvements for turbofan engine configurations. In one instance, embodiments of the turbofan engine 110 provided herein allow for thrust ranges similar to or greater than turbofan engines with larger quantities of blades or vanes, while further obviating structures such as fan cases or nacelles. In still another instance, embodiments of the turbofan engine 110 provided herein allow for thrust ranges and attenuated acoustic levels such as provided herein while reducing weight, complexity, or issues associated with fan cases, nacelles, variable nozzles, or thrust-reverser assemblies at a turbofan nacelle.

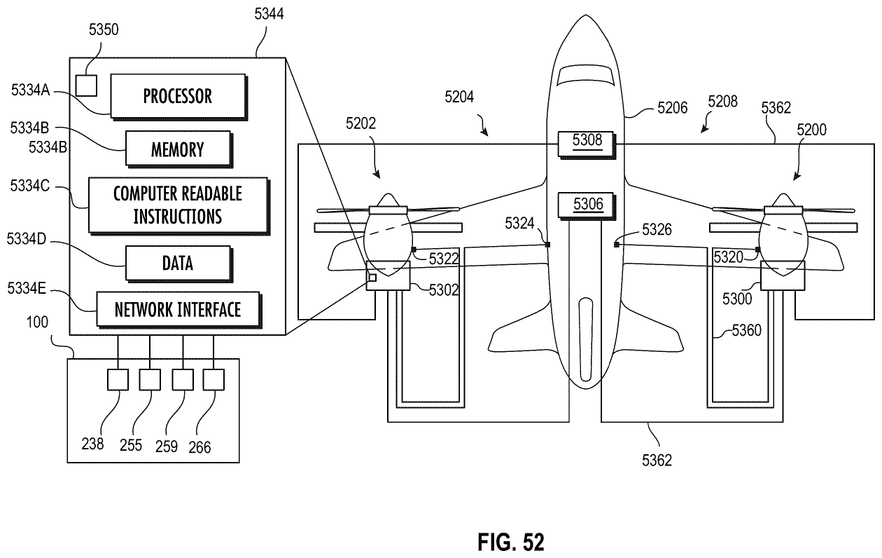

Referring to FIG. 52, an aircraft 5204 has two engines 5200, 5202. For clarity only engine 5200 is described in detail and the description of engine 5200 is applicable to engine 5202. The engines 5200, 5202 may be similar or analogous to the turbofan engine 110 described herein above.

The aircraft 5204 includes a control system 5208. The control system 5208 is configured to limit noise generated by one or more of the engines 5200, 5202. For example, engine geometries and operational conditions are controlled to (a) limit community noise during takeoff, and landing operations and (b) limit cabin noise during climb and cruise. The control system 5208 may include controllers 5300, 5302, a flight management system 5306, manual aircraft controls 5308 (e.g., including a selectable quiet mode), and sensors 5320, 5322.

In one or more exemplary embodiments, the controllers 5300, 5302 depicted in FIG. 52 may be stand-alone controllers such as a Full Authority Digital Engine Control (FADEC) for providing full digital control of the engine 5200. In some alternative embodiments, the engine 5200 can include more than one controller for controlling the engine 5200, and controllers may be connected with or integrated into one or more of a controller for the engine 5200, a controller for the aircraft 5204, the control system 5208, etc. For example, the controllers 5300, 5302 may be integrated into or connected to a global supervisory control, as described in further detail below.

The controllers 5300, 5302 can control various aspects of the engines 5200, 5202 and may include system-specific or function-specific controls. For example, the controllers 5300, 5302 may include a noise reduction control, a base power management schedule or control (which may, e.g., dictate engine geometries and conditions based on a desired power or thrust output for the engine 5200, including a speed of the fan 252, a pitch angle of the fan blades 254, a pitch angle of the fan guide vanes 262, a speed of the mid-fan 286, an area of the fan exhaust nozzle 278, a guide vane schedule (which may, e.g., dictate a pitch angle for the fan guide vanes 262 based on one or more of an engine operating condition, such as takeoff, climb, cruise, descent, etc.; a fan speed schedule or control; an engine or fan thrust output; or the like), a guide vane control, and a thrust control.

The controller 5300 is configured to control geometries of the engine 5200, control operating conditions, or otherwise make control decisions based on a noise sensitive condition 5350. In particular, the controller 5300 may control geometries or operating conditions of unducted features of the engine including a pitch angle of fan blades 254 around their respective pitch axis P, a speed of the fan 252, and a pitch angle of the fan guide vanes 262 around their respective vane pitch axis 264. The controller 5300 may also control geometries or operating conditions of ducted features including a speed of the mid-fan 286, and an area of the fan exhaust nozzle 278.

As shown in FIG. 52, the controller 5300 may be configured to indirectly or directly control the speed of the LP shaft 238 (e.g., via gearbox 255) and the actuators 259, 266.

Each engine 5200, 5202 has a respective controller 5300, 5302. For clarity, only controller 5302 is now described in greater detail and the description of controller 5302 is applicable to controller 5300. Referring particularly to the operation of the controller 5302, in at least certain embodiments, the controller 5302 can include one or more computing device(s) 5344. The computing device(s) 5344 can include one or more processor(s) 5344A and one or more memory device(s) 5344B. The one or more processor(s) 5344A can include any suitable processing device, such as a microprocessor, microcontroller, integrated circuit, logic device, and/or other suitable processing device. The one or more memory device(s) 5344B can include one or more computer-readable media, including, but not limited to, non-transitory computer-readable media, RAM, ROM, hard drives, flash drives, and/or other memory devices.

The one or more memory device(s) 5344B can store information accessible by the one or more processor(s) 5344A, including computer-readable instructions 5344C that can be executed by the one or more processor(s) 5344A. The instructions 5344C can be any set of instructions that when executed by the one or more processor(s) 5344A, cause the one or more processor(s) 5344A to perform operations.

In some example embodiments, the instructions 5344C can be executed by the one or more processor(s) 5344A to cause the one or more processor(s) 5344A to perform operations, such as any of the operations and functions for which the controller 5300 and/or the computing device(s) 5344 are configured, the operations for operating an engine 5200 according to a noise sensitivity condition (e.g., methods described below), as described herein, and/or any other operations or functions of the one or more computing device(s) 5344. The instructions 5344C can be software written in any suitable programming language or can be implemented in hardware. Additionally, and/or alternatively, the instructions 5344C can be executed in logically and/or virtually separate threads on processor(s) 5344A.

For example, a noise reduction control, a base power management control, a guide vane control, a fan speed control, a variable nozzle area control, and a thrust control may be implemented as control modules including instructions 5344C that are executed to provide the control functionality.

The memory device(s) 5344B can further store data 5344D that can be accessed by the processor(s) 5344A. For example, the data 5344D can include data indicative of evaluations of noise values or levels based on sensor measurements, data from a flight management system, data indicative of engine/aircraft operating conditions, and/or any other data and/or information described herein.

The computing device(s) 5344 can also include a network interface 5344E used to communicate, for example, with the other components (e.g., other of the engine 5200, the aircraft 5204, the control system 5208, etc.) For example, in the embodiment depicted, as noted above, the engine 5200 includes one or more sensors for sensing data indicative of one or more parameters of the engine 5200, the aircraft 5204, or both.

The controller 5302 is operably coupled to the one or more sensors 5322 (sensors 5320 for the controller 5300) through, e.g., the network interface, such that the controller 5302 may receive data indicative of various operating parameters sensed by the one or more sensors during operation.

The network interface 5344E can include any suitable components for interfacing with one or more network(s), including for example, transmitters, receivers, ports, controllers, antennas, and/or other suitable components.

The technology discussed herein refers to computer-based systems, and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The flight management system 5306 may include a navigational database and may use data from sensors 5320, 5322 such as a global positioning system (GPS), distance measuring equipment (DME), VHF omnidirectional range (VOR), non-directional beacons (NDBs), and the like to navigate a flight plan. The navigational database may include noise thresholds or noise limits for waypoints of the flight plan.

The manual aircraft controls 5308 may include manual controls that are able to set a threshold or select a mode such as quiet mode (e.g., having a predetermined lower noise threshold). For example, the manual aircraft control 5308 may be used to lower the noise of the cabin and provide a more comfortable flight.

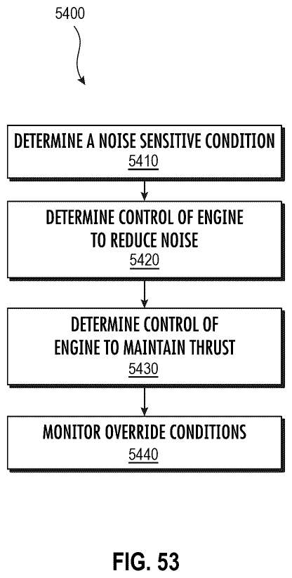

Referring now to FIGS. 52 and 53, the controllers 5300, 5302 and/or the control system 5208 are configured to implement an exemplary method 5400. For purposes of teaching, the method 5400 is described with respect to the controller 5300 although the steps may be alternatively implemented by the controller 5302 or the control system 5208.

According to a first step 5410, the controller 5300 determines a noise sensitive condition 5350. According to a second step 5420, the controller 5300 determines a control scheme to reduce noise based on the noise sensitive condition. According to a third step 5430, the controller 5300 determines a control scheme to maintain a nominal thrust based on the control scheme to limit noise. According to a fourth step 5440, the controller 5300 monitors the engine 5200 for override conditions. The method 5400 is now described in further detail.

The controller 5300 may receive and/or evaluate data to determine the noise sensitive condition 5350. For example, the noise sensitive condition 5350 may include noise thresholds 5362, limits, or target amounts of noise reduction (e.g., amount of noise reduction to achieve a target noise level), an amount of departure from an average or acceptable level of noise, and the like. The noise sensitive condition 5350 may be determined or based on other conditions being met, by manual selection or initiation of a mode, combinations thereof, and the like.

The noise thresholds 5362, limits, and the like may be looked up in a table of threshold noise levels based other factors or conditions related to the noise sensitive condition such as location, time of day, altitude, etc. For example, the noise sensitive condition 5350 may be a function of a location along a flight path, a time of day, an altitude, or a combination thereof. The noise sensitive condition 5350 may be specific to noise measurement points encountered during operations including approach, sideline, and cutback.

Here, the noise sensitive condition 5350 may be a scheduled or pre-determined noise threshold 5362 that is triggered or determined based on one or more conditions such as location, time of day, altitude, and the like. Such conditions may be detected by a sensor, a flight management system, and the like as described in further detail below. The noise threshold 5362 may be implemented for a limited time during which the under-lying conditions hold.

The noise sensitive condition 5350 may also be determined or implemented based on a selection of a mode or manual setting. In such cases, a noise threshold 5362 may be manually selected or may be automatically determined by analyzing noise values 360 measured over time. For example, engines on opposite sides of an aircraft may operate in a way that creates higher than normal noise levels in the cabin. Here, a noise value 5360 may be continuously measured and analyzed, and a feedback control implemented to keep the noise level at (or withing a certain range of) an average or acceptable noise level (which may depend on various conditions). Here, a noise sensitive condition 5350 may be implemented in a non-scheduled manner include using control functions to maintain a noise level.

A noise value 5360 or noise level may be determined based on one or more measurements or data from sensors 5320, 5322, 5324, 5326 associated with the engine 5200 or aircraft 5204. Sensors may be located on or in the aircraft fuselage (e.g., sensor 3524), in the cabin (e.g., sensor 5326), may be part of (on or in) the engines 5200, 5202 (e.g., sensors 5320, 5322), or at other locations on the aircraft 5204.

Exemplary sensors include acoustic sensors, accelerometers or vibration sensors, pressure sensors, temperature sensors (e.g., exhaust gas temperature (EGT) sensors), and the like. Exemplary sensors may also include an altitude sensor, a global positioning system (GPS), a distance sensor, a timer, other sensors discussed below with respect the flight management system 5306, and the like.

According to a second step 5420 of method 5400, the control system 5208 determines control of one or more geometries or operating conditions of the engine 5200 to reduce noise.

A noise sensitive condition 5350 may also include a noise value 5360 approaching or exceeding a noise threshold 5362 (e.g., a noise threshold set as part of a silent mode). Noise threshold 5362 may be set or selected via the manual aircraft control 5308 and/or determined from the flight management system 5306.

A noise sensitive condition 5350 may be determined by the flight management system 5306. The noise sensitive condition 5350 may be noise thresholds, limits, or target amounts of noise reduction at waypoints along a flight path. The flight management system 5306 may provide signals or data indicative of the noise sensitive conditions 5350 such that the controllers 5300, 5302 can implement control schemes for noise reduction at scheduled (or non-scheduled) waypoints along the flight path.

The controller 5300 may control the pitch angle of the fan guide vanes 262 to reduce community noise during takeoff and landing operations. Noise may be measured by ground level sensors at noise measurement points (e.g., acoustic certification points) including at sideline, cutback, and approach. Sideline may be a lateral full-power noise measurement point during takeoff where the noise level is maximum and 1,476 feet to the side of the runway; cutback may be a flyover noise measurement point at a distance of 21,325 feet from a start of roll on the runway; and approach may be a noise measurement point 6,562 feet from the threshold of a runway.

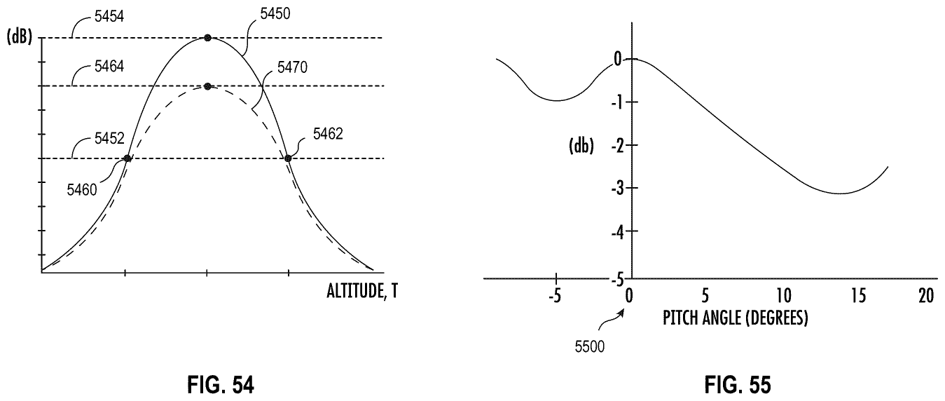

Referring to FIG. 54, an exemplary noise profile 5450 (e.g., a Perceived Noise Level with Tone Correction (PNLT) curve) for an aircraft at a sideline noise measurement point is illustrated. Here, the noise profile 5450 hits a measurement level 5452 (here, −10 dB from a nominal peak level 454) on the advancing side at 400 feet of altitude; hits the nominal peak level 454 at approximately 1000 feet of altitude; and hits the measurement level 5452 on the retreating side at 1400 feet of altitude for the sideline certification condition. The noise profile 5450 may hit the measurement level 5452 on the retreating side as high as, for example, 4000 feet at a cutback operating condition. It will be appreciated that the altitudes associated with the noise profile of FIG. 54 are by way of example only.

The noise profile 5450 may be measured by a ground level sensor at a noise measurement point beginning at the time (e.g., point 5460) when the noise rises above the measurement level 5452 on the advancing side and ending at the time (e.g., point 5462) when then noise drops below the measurement level 5452 on the retreating side. A noise rating may be based on the area between the noise profile 5450 and the measurement level 5452 between points 5460, 5462. Other measurement levels 5452, 5454 may be used and may vary based on regulations at different locations, times of day, combinations thereof, and the like.

To achieve a reduced noise profile 5470 for a reduced peak level 5464 (e.g., reduced with respect to the nominal noise profile 5450 that may be used for measurement levels 5452, 5454), the controller 5300 may determine a noise control scheme described in further detail below including closing the pitch angle of the fan guide vanes 262 (e.g., with respect to a nominal pitch angle).

The controller 5300 may control the pitch angle of the fan guide vanes 262 to achieve maximum engine efficiency at runway takeoff (e.g., 0 to 400 feet altitude) and then to achieve minimum noise for lateral and flyover acoustic measurement points (e.g., when the aircraft is at 400 feet altitude to 4000 feet altitude Above Ground Level). Accordingly, the closure of the fan guide vanes 262 may begin at the time, location, and/or altitude when the noise rises above a level −10 dB from the reduced peak level 5464.

As the location or time along a flight path when the noise rises above a level −10 dB from the reduced peak level 5464 is associated with an altitude, location, distance, or time (e.g., based on a typical noise profile), control of the pitch angle of the fan guide vanes 262 by the controller 5300 may be based on a command or indication from the flight management system 5306 of a noise sensitive condition 5350. Additionally or alternatively, a determination may be made from a measurement from the sensor 5320, 5322 including an above ground altitude sensor (e.g., altitude measured from, e.g., a takeoff point or brake release), a measurement of location (e.g., from a global positioning system (GPS)), a measurement from a distance sensor, a measurement from a timer (e.g., a time after wheels up), combinations thereof, and the like.

Based on the noise sensitive condition 5350, the controller 5300 may determine a maximum extent to which the pitch angle of the fan guide vanes 262 may be closed while still maintaining a minimum efficiency for the fan 252, a minimum thrust requirement for the fan 252, or both. For example, input from other sensors 5320, 5322 (e.g., an exhaust gas temperature (EGT) sensor) may be used to determine the maximum extent to which the fan guide vanes 262 may be closed from an overall engine performance or turbine lifting standpoint. An EGT sensor may be used to limit the change or closure of fan guide vanes 262 as turbine life will be affected if the exhaust gas temperature is high.

To maintain overall engine thrust, the speed of the fan 252 may be increased or the pitch of the fan blades 254 may be changed. Since the noise of the engine is heavily influenced by the primary stream, this results in a lower noise operation at the same thrust.

The controller 5300 may alternatively or additionally close the fan guide vanes 262 to an extent that is determined to achieve a noise profile based on a peak noise level. For example, a fan guide vane 262 closure schedule may be predetermined based on a peak noise level and a measurement from a sensor.

In some cases, the controller 5300 may change the pitch angle of the fan guide vanes 262 to hold a noise level at a level below a peak noise level (e.g., at a level that is-5 dB from the nominal peak level 5454). In some cases, the controller 5300 may continuously or frequently change the pitch angle of the fan guide vanes 262 to achieve an average noise level below a peak noise level.

According to one aspect of the second step 5420 of the method 5400, controller 5300 changes the pitch angle of the fan guide vanes 262 around their respective vane pitch axis 264. Referring to FIG. 55, providing exemplary noise from an unducted (e.g., fan 252 or propellor) component in accordance with one or more aspects of the present disclosure, noise reduction can be achieved by opening or closing the pitch angle of the fan guide vanes 262 relative to a design point 5500. The amount of noise reduction may vary depending on the fan tip speed and design. For example, the method 5400 may at step 5420 change the pitch angle of the fan guide vanes 262 relative to the guide vane schedule for the fan guide vanes 262.

In FIG. 55, negative-value pitch angles correspond to opening the pitch angle of the fan guide vanes 262 relative to the design point 5500 and positive-value pitch angles refer to closing the pitch angle of the outlet guide vanes relative to the design point 5500. The pitch angle of the fan guide vanes 262 is closed to reduce noise under some conditions, for example, such as sideline and cutback. The pitch angle of the fan guide vanes 262 may be opened to reduce noise under some conditions, for example, such as approach.

The design point 5500 may refer to an orientation (including pitch angle) for the component to achieve maximum efficiency from a fuel burn standpoint for a given aircraft mission. The design point 5500 may be referred to as an aero design point (ADP).

For example, opening the pitch angle of the fan guide vanes 262 (e.g., on approach) by about 5 degrees (i.e., −5 degrees on the x-axis) may reduce noise by approximately 1-2 decibels (dB).

Greater noise reduction may be achieved by closing the pitch angle of the fan guide vanes 262 (e.g., at sideline). For example, closing the pitch angle of the fan guide vanes 262 by about 5 degrees may reduce noise by approximately 1-2 decibels (dB), closing the pitch angle of the fan guide vanes 262 by about 10 degrees may reduce noise by approximately 2-4 dB, closing the pitch angle of the fan guide vanes 262 by about 15 degrees may reduce noise by approximately 3-5 dB.

The noise value may be measured according to various methods including measuring the noise at the blade passing frequency for the fan or the noise at the dominant frequency or the Effective Perceived Noise of the fan system.

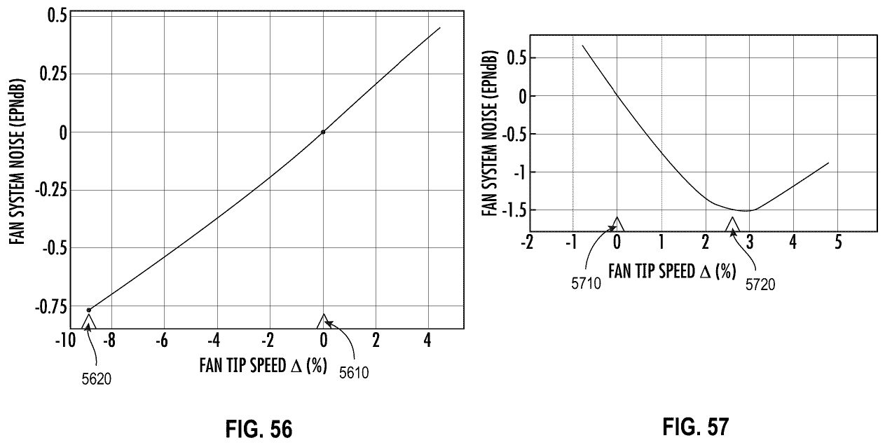

According to another aspect of step 5420, referring to FIGS. 56 and 57 providing illustrations of fan system noise vs. fan tip speed at approach and sideline, the controller 5300 may additionally or alternatively control the speed of the fan 252 (e.g., fan tip speed) with respect to a nominal speed to reduce noise, for example, at one or more of sideline, cutback, and approach. The nominal speed may be one that is optimized for fuel efficiency (e.g., a lowest fuel burn) and/or turbine life considerations. A speed that is alternatively or additionally optimized or selected within an acceptable range of fan tip speeds to reduce noise may be referred to as a noise reduction speed. The total engine thrust may be maintained during operation at a noise reduction speed.

Referring to FIG. 56, on approach and with respect to an approach noise measurement point, the speed of the fan 252 may be reduced with respect to a nominal speed 5610 to reduce noise emitted from the fan system. For example, the speed of the fan 252 may be reduced to a noise reduction speed 5620 (e.g., a speed that is 8% to 10% below the nominal speed 5610) and thereby reduce the fan system noise by 0.6 dB to 0.85 dB. Here, the mid-fan thrust contribution may be as low as possible.

Referring to FIG. 57, increasing the speed of the fan 252 with respect to a nominal speed 5710 (e.g., over speeding) reduces the noise of the fan system at a sideline noise measurement point. Increasing the fan tip speed can in some cases reduce the noise of the fan system as increasing the fan tip speed increases fan efficiency. This in turn reduces the fan wake strength resulting in reduced interaction noise from the fan guide vanes 262. For example, the speed of the fan 252 may be increased to a noise reduction speed 5720 (e.g., a speed that is 2% to 3% above the nominal speed 5710) where the fan system noise is at its lowest point on the curve. Here, operating at the noise reduction speed 5720 may reduce the noise of the fan system by 1.3 dB to 1.5 dB relative to operating at the nominal speed 5710.

The increased speed may at least partially compensate for a decrease in thrust from closing the pitch angle of the fan guide vanes 262 and/or the pitch angle of the fan blades 254. Accordingly, together, these measures may cooperate to reduce noise while limiting loss of thrust at sideline (e.g., maintaining an overall thrust for the engine substantially constant).

At cutback and with respect to a cutback measurement point, reducing the fan tip speed with respect to a nominal measurement point, to a certain extent, reduces the fan system noise.

According to another aspect of step 5420, the fan blade pitch angle may be changed to increase the thrust produced by the fan 252 to offset any decrease in thrust from closing the pitch angle of the fan guide vanes 262. While this increases the strength of the wakes shed from fan 252 and therefore increases the interaction noise of these wakes impinging on the fan guide vanes 262, this change in wake strength is small and the noise of the system with closed pitch angle of the fan guide vanes 262 is still lower than a nominal setting.

According to a third step 5430 of method 5400, the controller 5300 is configured to control geometries or operating conditions of the engine 5200 to maintain the thrust (e.g., a nominal thrust) of the engine based on the geometries and operating conditions determined at the second step 5420. The thrust split may be between an unducted stream (e.g., first stream) and ducted streams (e.g., second and third streams). In certain exemplary aspects, the method 5400 may at step 5430 modify geometries and operating conditions of the engine relative to the base power management schedule in response to steps 5410, 5420, or both.

The controller 5300 may control geometries or operating conditions of ducted features including a speed of the mid-fan 286. The controller 5300 may control geometries or operating conditions of unducted features of the engine 5200 including a pitch angle of fan blades 254 around their respective pitch axis P, a speed of the fan 252, and a pitch angle of the fan guide vanes 262 around their respective vane pitch axis 264. For example, the controller 5300 may control unducted features that are not controlled according to the geometries and operating conditions determined at the second step 5420.

The amount of thrust needed varies at different altitudes and operations (e.g., departure and landing operations). As one example for the engine configuration of FIG. 2, the contribution to the overall thrust of the engine 5200 may be distributed between the fan 252 (and bypass passage) and the fan duct 272.

The geometry or operating condition of one or more of the fan 252, the fan guide vanes 262, and the mid-fan 286 may be controlled to maintain a nominal thrust based on a geometry or operating condition of one or more of the fan 252 and the fan guide vanes 262.

For example, as described above with respect to the second step 5420, to reduce noise, the thrust generated by the fan 252 or engine 5200 may be reduced as the pitch angle of the fan guide vanes 262 is closed, the pitch of the fan blade 254 is closed, the speed of the fan 252 is reduced, or a combination thereof.

In some cases, the drop in thrust may be compensated by an increase in the speed of the fan 252 (and the mid-fan 286). Here, additional thrust is provided by the airflow through the fan duct 272 (generated at least in part by the mid-fan 286) such that a lower fraction of the thrust is required by the fan 252 and fan guide vanes 262. The fractional contribution of unducted components or streams and ducted components or streams may be referred to as the thrust split.

Similarly, the thrust generated by the airflow through the fan duct 272 may be reduced as the pitch of the mid-fan blades 182 is closed (not shown), the speed of the mid-fan 286 is reduced, or a combination thereof. In some cases, the drop in thrust may be compensated by an increase in the speed of the mid-fan 286.

Additionally, or alternatively, the controller 5300 may adjust the thrust split or otherwise add to the thrust of the engine 5200 to compensate for the drop in thrust generated by the airflow through the fan duct 272 by increasing the speed of the fan 252, changing the pitch of the fan blades 254, and/or (opening) the pitch angle of the fan guide vanes 262. Here, additional thrust is provided by the fan 252, such that a lower fraction of the thrust is required by the airflow through the fan duct 272.

According to the fourth step of the method 5400, the controller 5300 may monitor for conditions where the method 5400 should be discontinued or overridden. Such conditions include instances where performance and/or health of the engine is reduced. For example, the controller may monitor engine gas temperature measurements from a sensor 5320 of the engine 5200 and end the noise reduction method 5400 if the temperature reaches a limit.

The noise reduction method 5400 may otherwise be overridden by other situations such as if one of the engines is inoperative and the full thrust performance of the functioning engine is needed.

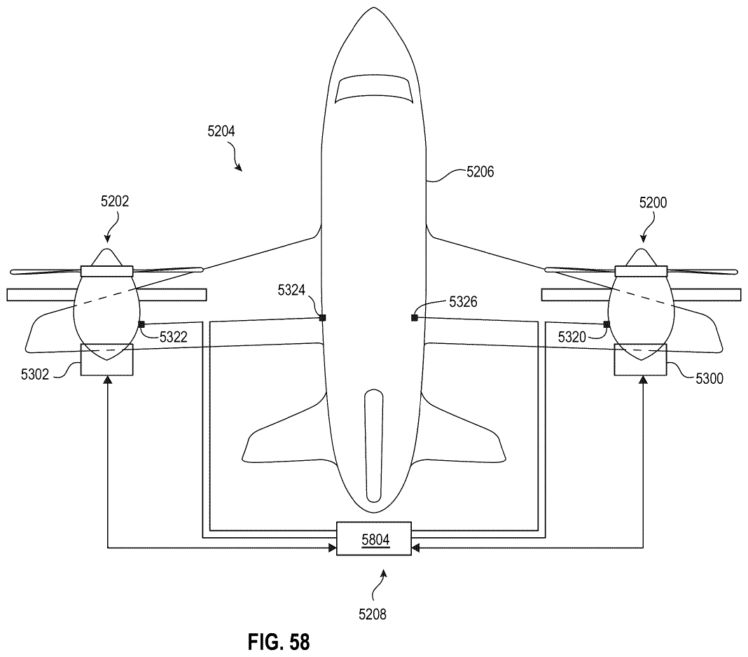

Referring to FIG. 58, providing an alternative embodiment of the control system 5208 that may control one or more engines 5200, 5202 based on a multi-engine noise control method 5800. For example, one or more engines may be controlled to limit cabin noise and/or community noise based on noise sensors on or in the aircraft 5204. As described above, a noise sensor may include an accelerometer, a temperature sensor, or an acoustic sensor on the interior of the fuselage 5206 or cabin (e.g., sensor 5326).

In the embodiment of FIG. 58, the control system 5208 includes a supervisory controller 5804. The supervisory controller 5804 is configured to receive sensor measurements from the cabin sensor 5326 as well as engine sensors 5320, 5322 and to coordinate control of the engines 5200, 5202 via the controllers 5300, 5302 to reduce the overall noise. Alternatively, or additionally, the controllers 5300, 5302 may directly communicate with one another to share data (e.g., sensor data, geometry, speed, etc.) and coordinate control of the engines 5200, 5202 to reduce overall noise.

A starboard acoustic noise sensor 5320 may be positioned proximate a starboard-side engine 5200 (e.g., as described with respect to engine 5200) and a port-side acoustic noise sensor 5322 may be positioned proximate a port-side engine 5202 (e.g., as described with respect to engine 5200).

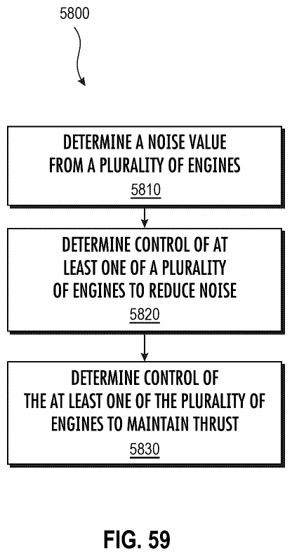

Referring to FIG. 59, according to a first step 5810, the supervisory controller 5804 determines a noise sensitive condition 5350 (e.g., a noise value 5360 from engine sensors 5320, 5322) associated with each of engines 5200, 5202 (e.g., port-side and starboard). Alternatively, or additionally, the supervisory controller 5804 may also determine a noise value 5360 of the cabin from the cabin sensor 5326 that is approaching or exceeding a noise threshold.

The starboard-side engine 5200 may have a different noise level (e.g., based on the direction of rotation of the fan 252 or other factors) than the port-side engine 5202. Accordingly, the associated acoustic noise sensors 5320, 5322 may measure different noise levels.

According to a second step 5820, the supervisory controller 5804 determines control of at least one of the engines 5200, 5202 to reduce noise. The supervisory controller 5804 may determine a contribution (e.g., to a cabin noise value 5360 from cabin sensor 5326) and control the engine geometries or operational conditions of one engine 5200 differently than the engine geometries or operational conditions of the other engine 5202 (e.g., according to different contributions) to reduce the overall cabin noise.

For example, the supervisory controller 5804 may independently adjust the engine geometries or speeds of the port and/or starboard engines 5200, 5202 to reduce a noise level of an engine 5200, 5202 associated with a higher noise. Alternatively, or additionally, the supervisory controller 5804 may independently adjust the engine geometries or speeds of the port and/or starboard engines 5200, 5202 to enable better noise cancellation within the cabin or fuselage 5206.

According to a third step 5830, the supervisory controller 5804 determines control of the engines 5200, 5202 to maintain a nominal thrust for each based on the geometries and/or speeds determined from second step 5820. The supervisory controller 5804 may independently adjust the thrust splits of the engines 5200, 5202 while maintaining the same overall thrust of the engines 5200, 5202. The thrust adjustments may be a function of an aircraft operating condition (e.g., cruise, climb etc.).

Further aspects are provided by the subject matter of the following clauses.

A turbofan engine for an aircraft, the turbofan engine comprising a fan having a plurality of fan blades, each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 300 to 1860, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more radial thrust bearings.

A turbofan engine for an aircraft, the turbofan engine comprising a fan having a plurality of fan blades, each of the plurality of fan blades being rotatable about a pitch axis, a nacelle that circumferentially surrounds the fan, and a fan actuation system including one or more actuators for rotating the plurality of fan blades about the pitch axis and one or more radial thrust bearings, wherein the fan actuation system is characterized by a fan actuation system envelope in a range from 300 to 660, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more thrust bearings.

A turbofan engine for an aircraft, the turbofan engine comprising a fan having a plurality of fan blades, the fan being an open fan, and each of the plurality of fan blades being rotatable about a pitch axis, and a fan actuation system including one or more actuators for rotating the plurality of fan blades about the pitch axis and one or more radial thrust bearings, wherein the fan actuation system is characterized by a fan actuation system envelope in a range from 660 to 1860, the fan actuation system envelope being given by:

$$\frac{{N}_{FB} \times {D}_{FT} \times {M}_{cruise}}{( \frac{{R}_{TB}}{{N}_{FB}} )}$$

wherein N_{FB} is a number of the plurality of fan blades, D_{FT} is a fan tip diameter of the plurality of fan blades, M_{cruise} is a Mach number of the aircraft at cruise operating conditions, and R_{TB} is a thrust bearing radius of the one or more radial thrust bearings.

The turbofan engine of any preceding clause, wherein the fan actuation system includes a hydraulic system that supplies hydraulic fluid for rotating the plurality of fan blades about the pitch axis.

The turbofan engine of any preceding clause, wherein the cruise operating conditions occur at a mid-level power range of the turbofan engine.

The turbofan engine of the preceding clause, wherein the mid-level power range is 30% to 85% of a sea level static maximum engine rated thrust for the turbofan engine.

The turbofan engine of any preceding clause, wherein the turbofan engine is rated for use on a regional aircraft having a maximum takeoff thrust of 10,000 lbf to 20,000 lbf.

The turbofan engine of any preceding clause, wherein the turbofan engine is rated for use on a narrow body aircraft having a maximum takeoff thrust of 15,000 lbf to 30,000 lbf.

The turbofan engine of any preceding clause, wherein the turbofan engine is rated for use on a wide body aircraft having a maximum takeoff thrust of 40,000 lbf to 110,000 lbf.

The turbofan engine of any preceding clause, wherein N_{FB} is in a range from ten to eighteen.

The turbofan engine of any preceding clause, wherein N_{FB} is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 168.0 inches.

The turbofan engine of any preceding clause, wherein R_{TB} is in a range from 14 inches to 27 inches.

The turbofan engine of any preceding clause, wherein R_{TB} is in a range from 14 inches to 19 inches.

The turbofan engine of any preceding clause, wherein R_{TB} is in a range from 19 inches to 27 inches.

The turbofan engine of any preceding clause, wherein M_{cruise} is in a range from 0.7 to 0.92.

The turbofan engine of any preceding clause, wherein M_{cruise} is in a range from 0.75 to 0.9.

The turbofan engine of any preceding clause, wherein M_{cruise} is in a range from 0.8 to 0.88.

The turbofan engine of any preceding clause, wherein the fan actuation system includes a pressurized pneumatic chamber that is filled with a pressurized gas that biases the plurality of fan blades to a feather position.

The turbofan engine of any preceding clause, wherein the fan actuation system is devoid of counterweights for reducing inertial loading associated with rotation of fan blades.

The turbofan engine of any preceding clause, further comprising core cowl, wherein the turbofan engine has a longitudinal centerline axis, and the core cowl is annular about the longitudinal centerline axis.

The turbofan engine of the preceding clause, further comprising a core inlet that is annular about the longitudinal centerline axis.

The turbofan engine of any preceding clause, further comprising a gearbox assembly, wherein the turbine section includes a low-pressure shaft, and the fan has a fan shaft that is coupled to the low-pressure shaft through the gearbox assembly.

The turbofan engine of the preceding clause, wherein the gearbox assembly has a gear ratio in a range 3.5:1 to 5:1 for a ducted engine.

The turbofan engine of any preceding clause, wherein the gearbox assembly has a gear ratio in a range from 4:1 and 10:1 for an unducted fan engine.

The turbofan engine of any preceding clause, wherein the low-pressure shaft, the gearbox assembly, and the fan shaft are coaxial along the longitudinal centerline axis.

The turbofan engine of any preceding clause, wherein the fan actuation system envelope is in a range from 660 to 1020.

The turbofan engine of any preceding clause, the fan actuation system envelope being in a range from 300 to 660.

The turbofan engine of any preceding clause, the fan actuation system envelope being in a range from 660 to 1860.

The turbofan engine of any preceding clause, the fan actuation system envelope being in a range from 660 to 1020.

The turbofan engine of any preceding clause, further comprising a nacelle that circumferentially surrounds the fan.

The turbofan engine of any preceding clause, wherein the turbofan engine is an open fan engine.

The turbofan engine of any preceding clause, further comprising a fan hub, the plurality of fan blades extending radially from the fan hub.

The turbofan engine of any preceding clause, the fan actuation system being disposed within the fan hub.

The turbofan engine of any preceding clause, further comprising a compressor section, a combustor, and a turbine section.

The turbofan engine of any preceding clause, the compressor section including a low-pressure compressor and a high-pressure compressor, and the turbine section including a high-pressure turbine and a low-pressure turbine.

The turbofan engine of any preceding clause, further comprising a high-pressure shaft that couples the high-pressure compressor and the high-pressure turbine.

The turbofan engine of any preceding clause, further comprising a low-pressure shaft that couples the low-pressure compressor and the low-pressure turbine.

The turbofan engine of any preceding clause, the low-pressure shaft being disposed through the high-pressure shaft.

The turbofan engine of any preceding clause, the gearbox assembly comprising a gear assembly comprising a plurality of gears.

The turbofan engine of any preceding clause, the gearbox assembly including one or more gear bearings.

The turbofan engine of any preceding clause, each of the plurality of fan blades extending from a fan root to a fan tip.

The turbofan engine of any preceding clause, the fan tip diameter DFT being defined from the longitudinal centerline axis to the fan tip of each of the plurality of fan blades.

The turbofan engine of any preceding clause, the fan actuation system including a trunnion mechanism that includes a plurality of trunnions, each fan blade being disposed in a respective trunnion.

The turbofan engine of any preceding clause, the fan blades extending from a disk.

The turbofan engine of any preceding clause, the disk including a plurality of disk segments.

The turbofan engine of any preceding clause, each fan blade being coupled to a respective disk segment at the trunnion mechanism.

The turbofan engine of any preceding clause, the plurality of trunnions being rotatable to rotate the plurality of fan blades about the pitch axis.

The turbofan engine of any preceding clause, the fan actuation system including one or more actuators coupled to the plurality of trunnions.

The turbofan engine of any preceding clause, the fan actuation system including a plurality of trunnion links and a unison ring, the plurality of trunnion links being coupled to the plurality of trunnions and to the unison ring.

The turbofan engine of any preceding clause, the plurality of trunnion links including a plurality of forward trunnion links and a plurality of aft trunnion links.

The turbofan engine of any preceding clause, the unison ring including a plurality of unison rings including a forward unison ring that is positioned forward of the plurality of trunnions and an aft unison ring that is disposed aft of the plurality of trunnions.

The turbofan engine of any preceding clause, the plurality of forward trunnion links being coupled to the forward unison ring.

The turbofan engine of any preceding clause, the plurality of aft trunnion links being coupled to the aft unison ring.

The turbofan engine of any preceding clause, further comprising a plurality of pins that couple the plurality of trunnion links to the unison ring.

The turbofan engine of any preceding clause, the plurality of forward trunnion links being coupled to the forward unison ring by a plurality of forward pins.

The turbofan engine of any preceding clause, the plurality of aft trunnion links being coupled to the aft unison ring by a plurality of aft pins.

The turbofan engine of any preceding clause, the one or more actuators including a hydraulic cylinder and a piston disposed within the hydraulic cylinder.

The turbofan engine of the preceding clause, the hydraulic cylinder and the piston being movable along an axial direction.

The turbofan engine of any preceding clause, the forward unison ring being coupled to the hydraulic cylinder such that the forward unison ring moves when the hydraulic cylinder moves.

The turbofan engine of any preceding clause, the aft unison ring being coupled to the piston such that the aft unison ring moves as the piston moves.

The turbofan engine of any preceding clause, the fan actuation system rotating the plurality of fan blades between a first end position and a second end position.

The turbofan engine of any preceding clause, the first end position being a feather position in which the plurality of fan blades is substantially aligned with a flow of a volume of air across the plurality of fan blades.

The turbofan engine of the preceding clause, the fan actuation system rotating the plurality of fan blades to any position between the first end position and the second end position.

The turbofan engine of any preceding clause, the second end positioned being a reverse position in which the plurality of fan blades exceeds a plane that is transverse to the longitudinal centerline axis by at least 30° to assist with braking the aircraft.

The turbofan engine of any preceding clause, the fan actuation system moving the hydraulic cylinder in a first direction and moving the piston in a second direction.

The turbofan engine of any preceding clause, movement of the hydraulic cylinder and the piston causing the plurality of fan blades to rotate about the pitch axis.

The turbofan engine of any preceding clause, the one or more actuators including a piston retainer.

The turbofan engine of the preceding clause, the piston retainer being coupled to the fan shaft such that the piston retainer rotates with the fan shaft.

The turbofan engine of any preceding clause, the piston being coupled to the piston retainer such that the piston rotates with the piston retainer.

The turbofan engine of any preceding clause, the hydraulic cylinder being axially slidable with respect to the piston and the piston retainer.

The turbofan engine of any preceding clause, the piston retainer comprising a first portion, a second portion that extends radially outward from the first portion, and a third portion that extends axially from the second portion.

The turbofan engine of any preceding clause, the third portion of the piston retainer being coupled to the fan shaft.

The turbofan engine of any preceding clause, the piston being coupled to, and extending forward from, the first portion of the piston retainer.

The turbofan engine of any preceding clause, the hydraulic cylinder being disposed radially outward of the piston retainer and the piston.

The turbofan engine of any preceding clause, the hydraulic cylinder being coupled to the unison ring at a joint such that movement of the hydraulic cylinder in the axial direction causes the plurality of fan blades to pitch about the pitch axis.

The turbofan engine of any preceding clause, the hydraulic cylinder having a first portion, a second portion, a third portion, and a fourth portion.

The turbofan engine of the preceding clause, the first portion of the hydraulic cylinder extending generally in the axial direction and being coupled to the unison ring at the joint.

The turbofan engine of any preceding clause, the second portion of the hydraulic cylinder being disposed radially inward of the first portion and being coupled to the first portion and to the unison ring at the joint.

The turbofan engine of any preceding clause, the third portion of the hydraulic cylinder extending forward from the joint.

The turbofan engine of any preceding clause, the fourth portion of the hydraulic cylinder being coupled to, and extending axially within, the third portion of the hydraulic cylinder.

The turbofan engine of any preceding clause, the first portion of the hydraulic cylinder being sealingly engaged with the third portion of the piston retainer.

The turbofan engine of any preceding clause, the second portion of the piston retainer being sealingly engaged with the first portion of the hydraulic cylinder.

The turbofan engine of any preceding clause, the piston being sealingly engaged with the second portion and the fourth portion of the hydraulic cylinder.

The turbofan engine of any preceding clause, the fan actuation system including one or more hydraulic chambers defined between the hydraulic cylinder, the piston, and the piston retainer.

The turbofan engine of the preceding clause, the one or more hydraulic chambers including a first hydraulic chamber, a second hydraulic chamber, and a third hydraulic chamber.

The turbofan engine of any preceding clause, the first hydraulic chamber being defined between first portion of the hydraulic cylinder, the second portion of the piston retainer, and the third portion of the piston retainer.

The turbofan engine of any preceding clause, the second hydraulic chamber being defined between the first portion of the hydraulic cylinder, the second portion of the hydraulic cylinder, the first portion of the piston retainer, and the second portion of the piston retainer.

The turbofan engine of any preceding clause, the third hydraulic chamber being defined between the second portion of the hydraulic cylinder, an aft end of the piston, and the first portion of the piston retainer,

The turbofan engine of any preceding clause, the first hydraulic chamber and the third hydraulic chamber being supplied with a hydraulic fluid at a first pressure, and the second hydraulic chamber being supplied with the hydraulic fluid at a second pressure.

The turbofan engine of any preceding clause, the first pressure and the second pressure being increased or decreased to cause the hydraulic cylinder to move axially forward or axially rearward to rotate the plurality of fan blades about the pitch axis.

The turbofan engine of any preceding clause, the fan actuation system comprising a hydraulic system that supplies the hydraulic fluid to the one or more hydraulic chambers.

The turbofan engine of any preceding clause, the hydraulic system including a pump to supply the hydraulic fluid to the one or more hydraulic chambers.

The turbofan engine of the preceding clause, the hydraulic system comprising an oil transfer bearing including a fixed portion with a plurality of fluid lines coupled to the pump.

The turbofan engine of the preceding clause, the oil transfer bearing including a sleeve that is rotatable about the fixed portion.

The turbofan engine of any preceding clause, the plurality of fluid lines including a first fluid line in fluid communication with the first hydraulic chamber, a second fluid line in fluid communication with the second hydraulic chamber, and a third fluid line in fluid communication the third hydraulic chamber.

The turbofan engine of any preceding clause, the plurality of fluid lines being coupled to the sleeve.

The turbofan engine of any preceding clause, the first hydraulic chamber and the third hydraulic chamber being provided with the hydraulic fluid at the same first pressure.

The turbofan engine of any preceding clause, the pump supplying the hydraulic fluid to the first hydraulic chamber and the third hydraulic chamber to increase the first pressure P1 and supplying the hydraulic fluid to the second hydraulic chamber to decrease the second pressure P2, to move the hydraulic cylinder in the rearward direction to rotate the plurality of fan blades towards the reverse position.

The turbofan engine of any preceding clause, the pump supplying the hydraulic fluid to the second hydraulic chamber to increase the second pressure P2 and supplying the hydraulic fluid to the first hydraulic chamber and the third hydraulic chamber to decrease the first pressure P1, to move the hydraulic cylinder in the forward direction to rotate the plurality of fan blades towards the feather position.

The turbofan engine of any preceding clause, the one or more actuators further comprising a pressurized pneumatic chamber filled with a pressurized gas to bias the hydraulic cylinder to move the plurality of fan blades to the feather position.

The turbofan engine of any preceding clause, a pressure of the pressurized gas in the pressurized pneumatic chamber being in a range from 720 psi to 920 psi.

The turbofan engine of any preceding clause, the pressurized gas in the pressurized pneumatic chamber causing the hydraulic cylinder to move rearward when the hydraulic system or the turbofan engine fails or is shut down.

The turbofan engine of any preceding clause, the fan actuation system not including a pitch lock device.

The turbofan engine of any preceding clause, the one or more radial thrust bearings being disposed between the plurality of trunnions and the disk such that the plurality of trunnions rotates with respect to the disk to rotate the plurality of fan blades about the pitch axis.

The turbofan engine of any preceding clause, the one or more radial thrust bearings transmitting a load from the plurality of fan blades to a static structure of the turbofan engine.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the fan actuation system includes a pressurized pneumatic chamber that is filled with a pressurized gas that biases the plurality of fan blades to a feather position.

The turbofan engine of any preceding clause, wherein the fan actuation system includes one or more counterweights for reducing inertial loading associated with rotation of the plurality of fan blades.

The turbofan engine of any preceding clause, further comprising a core cowl, wherein the turbofan engine has a longitudinal centerline axis, and the core cowl is annular about the longitudinal centerline axis wherein the core cowl includes a core inlet that is annular about the longitudinal centerline axis.

The turbofan engine of any preceding clause, wherein the fan actuation system includes a hydraulic system that supplies hydraulic fluid for rotating the plurality of fan blades about the pitch axis.

The turbofan engine of any preceding clause, wherein N_{FB} is in a range from ten to eighteen.

The turbofan engine of any preceding clause, wherein N_{FB} is in a range from ten to fourteen.

The turbofan engine of any preceding clause, wherein D_{FT} is in a range from 84.0 inches to 180.0 inches.

The turbofan engine of any preceding clause, wherein D_{FT} is in a range from 84.0 inches to 120.0 inches.

The turbofan engine of any preceding clause, wherein D_{FT} is in a range from 120.0 inches to 180.0 inches.

The turbofan engine of any preceding clause, wherein R_{TB} is in a range from 12 inches to 27 inches.

The turbofan engine of any preceding clause, wherein R_{TB} is in a range from 12 inches to 19 inches.

The turbofan engine of any preceding clause, wherein R_{TB} is in a range from 19 inches to 27 inches.

The turbofan engine of any preceding clause, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings.

The turbofan engine of any preceding clause, wherein A_{FH} is in a range from 25 inches to 75 inches.

The turbofan engine of any preceding clause, wherein A_{FB} is in a range from 16 inches to 23 inches.

The turbofan engine of any preceding clause, wherein the fan actuation system has a fan actuation system axial length (A_{FAS}) defined from an axially forward-most surface of the fan actuation system to the pitch axis of the plurality of fan blades, A_{FAS} being a maximum of 80% A_{FH}.

A turbofan engine for an aircraft, the turbofan engine including a fan having a plurality of fan blades coupled to a fan shaft having one or more fan bearings, each of the plurality of fan blades being rotatable about a pitch axis and extending from a fan hub, a nacelle that circumferentially surrounds the fan, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 13, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range from 25 inches to 40 inches, and A_{FB} is in a range from 17 inches to 20 inches.

A turbofan engine for an aircraft, the turbofan engine including a fan having a plurality of fan blades coupled to a fan shaft having one or more fan bearings, the fan being an open fan, and each of the plurality of fan blades being rotatable about a pitch axis and extending from a fan hub, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range from 25 inches to 75 inches, and A_{FB} is in a range from 16 inches to 23 inches, and D_{FT} is in a range from 120.0 inches to 180.0 inches.

The turbofan engine of the preceding clause, wherein R_{TB} is in a range from 12 inches to 27 inches.

A turbofan engine for an aircraft, the turbofan engine including a fan having a plurality of fan blades coupled to a fan disk that is drivingly coupled to a fan shaft, the fan disk defining a disk bore, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range from 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further comprising a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

A turbofan engine for an aircraft, the turbofan engine including a fan having a plurality of fan blades coupled to a fan disk that is drivingly coupled to a fan shaft, the fan disk defining a disk bore, and the fan being an open fan, a fan hub that directs an airflow through the plurality of fan blades, each of the plurality of fan blades being rotatable about a pitch axis and extending from the fan hub, one or more fan bearings that support rotation of the fan shaft, the one or more fan bearings being positioned radially outward of the disk bore, wherein a fan bearing radius ratio is in a range from 1.0 to 2.75, and a fan actuation system disposed within the fan hub and including one or more actuators for rotating the plurality of fan blades about the pitch axis and one or more radial thrust bearings, wherein the fan actuation system is characterized by a fan actuation system length envelope in a range of 8.5 to 24, the fan actuation system length envelope being given by

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 85 inches, and A_{FB} is in a range of 10 inches to 23 inches, and D_{FT} is in a range of 120.0 inches to 192.0 inches.

The turbofan engine of the preceding clause, wherein the turbofan engine has a fan hub radius ratio in a range from 0.1 to 0.4.

The turbofan engine of any preceding clause, wherein the one or more radial thrust bearings are tapered roller bearings.

The turbofan engine of any preceding clause, wherein the one or more fan bearings are positioned axially aft of the fan disk.

The turbofan engine of any preceding clause, wherein the fan disk extends between an inner surface and an outer surface, the one or more fan bearings being positioned radially outward of the outer surface.

The turbofan engine of any preceding clause, wherein the one or more fan bearings include at least one of roller bearings or ball bearings.

The turbofan engine of any preceding clause, wherein the ball bearings include four-point contact ball bearings.

The turbofan engine of any preceding clause, further comprising a compressor section, a combustion section, and a turbine section downstream of the fan, the turbine section having an input shaft that couples the compressor section to the turbine section, and a gearbox assembly, the fan shaft being drivingly coupled to the input shaft through the gearbox assembly.

The turbofan engine of any preceding clause, wherein the one or more fan bearings are positioned axially between the fan disk and the gearbox assembly.

The turbofan engine of any preceding clause, wherein the one or more fan bearings are positioned radially outward of the gearbox assembly.

A propulsion system defining an engine centerline, the propulsion system comprising a rotor assembly comprising a plurality of blades extended radially relative to the engine centerline axis; and a vane assembly positioned in aerodynamic relationship with the rotor assembly, wherein the vane assembly comprises a plurality of vanes extended radially relative to the engine centerline axis, and wherein the propulsion system comprises a ratio of a quantity of blades to a quantity of vanes between 2:5 and 2:1.

The propulsion system of any preceding clause, wherein the quantity of blades is 20 or fewer.

The propulsion system of any preceding clause, wherein the quantity of blades is between 16 and 11.

The propulsion system of any preceding clause, wherein a difference between the quantity of vanes and the quantity of blades is between 2 and −2.

The propulsion system of any preceding clause, wherein a difference between the quantity of vanes and the quantity of blades is between 2 and −2, and wherein the quantity of blades is between 16 and 11.

The propulsion system of any preceding clause, wherein the ratio of the quantity of blades to the quantity of vanes between 0.5 and 1.5.

The propulsion system of any preceding clause, wherein a sum of blades and vanes is 30 or fewer, and wherein the sum of blades and vanes is 20 or greater.

The propulsion system of any preceding clause, wherein the rotor assembly is unducted.

The propulsion system of any preceding clause, wherein the vane assembly is positioned aft of the rotor assembly.

The propulsion system of any preceding clause, wherein the vane assembly is unducted.

The propulsion system of any preceding clause, the propulsion system comprising a core engine encased in a nacelle, wherein the nacelle defines a maximum diameter, and wherein the vane assembly is extended from the nacelle.

The propulsion system of any preceding clause, wherein the rotor assembly comprises a hub from which the plurality of blades is extended, and wherein the propulsion system comprises a length extended from a forward end of the hub to an aft end of the nacelle, and wherein a ratio of length to maximum diameter is at least 2.

The propulsion system of any preceding clause, wherein the ratio of length to maximum diameter is at least 2.5.

The propulsion system of any preceding clause, wherein the core engine and the rotor assembly are together configured to generate a power loading of 25 horsepower per square foot or greater at cruise altitude.

The propulsion system of any preceding clause, wherein the rotor assembly is configured to rotate at a blade tip speed of up to 750 feet per second.

A propulsion system defining an engine centerline axis, the propulsion system comprising an unducted single rotor assembly comprising a plurality of blades extended radially relative to the engine centerline axis; and a vane assembly positioned aft of the unducted rotor assembly, wherein the vane assembly comprises a plurality of vanes extended radially relative to the engine centerline axis, and wherein the propulsion system comprises a difference between a quantity of vanes and a quantity of blades is between 2 and −2.

The propulsion system of any preceding clause, wherein the rotor assembly comprises a blade pitch change mechanism configured to control blade pitch at one or more of the plurality of blades relative to vane pitch at one or more of the plurality of vanes.

The propulsion system of any preceding clause, wherein the vane assembly comprises a vane pitch change mechanism configured to control vane pitch at one or more of the plurality of vanes relative to blade pitch at one or more of the plurality of blades.

The propulsion system of any preceding clause, the propulsion system comprising a core engine encased in a nacelle, wherein the nacelle defines a maximum diameter, and wherein the vane assembly is extended from the nacelle; and wherein the rotor assembly comprises a hub from which the plurality of blades is extended, and wherein the propulsion system comprises a length extended from a forward end of the hub to an aft end of the nacelle, and wherein a ratio of length to maximum diameter is at least 2.

The propulsion system of any preceding clause, wherein a sum of blades and vanes is 30 or fewer, and wherein the sum of blades and vanes is 20 or greater.

The propulsion system of any preceding clause, wherein the propulsion system generates a power loading at the rotor assembly of 50 horsepower per ft² or less at cruise altitude.

A propulsion system, the propulsion system comprising a core engine encased in a nacelle, wherein the nacelle defines a diameter, a rotor assembly comprising a plurality of blades and a hub, a vane assembly extended from the nacelle of the core engine, the vane assembly positioned aft of the rotor assembly, the propulsion system defines a length extended from the hub of the rotor assembly to an aft end of the nacelle, and wherein a ratio of length to diameter is at least 2, or at least 2.5

The propulsion system of any preceding clause, wherein the core engine comprises an axisymmetric inlet.

The propulsion system of any preceding clause comprising the system for reducing noise generation for a single unducted rotor engine of any preceding clause.

A propulsion system, the propulsion system comprising a variable pitch rotor assembly comprising a plurality of blades coupled to a disk, wherein the plurality of blades extends radially from the disk, and wherein the plurality of blades is positioned along a rotor plane, the rotor plane extended orthogonal to a longitudinal centerline axis of the rotor assembly; and a scheduling ring rotatable relative to the disk and having a plurality of slots, and a plurality of linkage arms, each linkage arm operatively coupled to one of the plurality of fan blades and to one of the plurality of slots, wherein each of the plurality of fan blades rotates according to a blade pitch schedule defined by the slot to which it is operatively coupled, and wherein at least two of the plurality of slots define different blade pitch schedules.

The propulsion system of any preceding clause, wherein at least two of the plurality of slots define different blade pitch schedules.

The propulsion system of any preceding clause, wherein each of the plurality of linkage arms has a first end fixedly connected to one of the plurality of blades and a second end slidably connected to one of the plurality of slots.

The propulsion system of any preceding clause, wherein the plurality of blades comprises a first set of blades and a second set of blades, and wherein the first set of blades is operably coupled to a first scheduling slot defining a first blade schedule, and wherein the second set of blades is operably coupled to a second scheduling slot defining a second blade schedule different from the first blade schedule.

The propulsion system of any preceding clause, wherein the first scheduling slot and the second scheduling slot are in adjacent alternating arrangement.

The propulsion system of any preceding clause, wherein the rotor assembly is a single unducted rotor assembly configured to provide substantially axial thrust.

The propulsion system of any preceding clause, wherein the rotor assembly comprises between eight and twenty blades rotatably coupled to the disk.

The propulsion system of any preceding clause, wherein the rotor assembly comprises twelve blades.

The propulsion system of any preceding clause, comprising a core engine configured to produce combustion gases for driving a turbine section, wherein the variable pitch rotor assembly is configured to provide changes in thrust vector without changes in speed at the core engine.

The propulsion system of any preceding clause comprising the system for reducing noise generation for a single unducted rotor engine of any preceding clause.

A method for thrust reverse for a single unducted rotor engine, the method comprising generating a forward velocity component forward of a rotor assembly at least by closing a blade pitch angle at a blade at the rotor assembly, and generating a positive tangential velocity component at the rotor assembly, wherein the positive tangential velocity component is opposite of a negative tangential velocity component from a vane assembly aft of the rotor assembly.

The method of any preceding clause, comprising loading the rotor assembly at least by closing a vane pitch angle at a vane at the vane assembly.

The method of any preceding clause, wherein loading the rotor assembly comprises rotating the vane at the vane assembly co-directional to a direction of rotation of the blade at the blade assembly.

The method of any preceding clause, wherein loading the rotor assembly comprises reducing the negative tangential velocity component at the vane assembly at least by closing the vane pitch angle.

A method for adjusting thrust vector for a single unducted rotor engine, the method comprising one or more steps of any preceding clause.

A computer-implemented method for operating a single unducted rotor engine, the computer-implemented method comprising the method of any preceding clause.

A computing system comprising one or more processors and one or more memory devices, wherein the one or more memory devices is configured to store instructions that, when executed by the one or more processors, performs operations, the operations comprising any of the steps of the method of any preceding clause.

A propulsion system of any preceding clause, the propulsion system comprising the computing system of any preceding clause.

A propulsion system of any preceding clause, the propulsion system configured to execute the steps of the method of any preceding clause.

A computing system comprising one or more processors and one or more memory devices, wherein the one or more memory devices is configured to store instructions that, when executed by the one or more processors, performs operations, the operations comprising obtaining a throttle input corresponding to one or more of a desired air speed of an aircraft, thrust output, or pressure ratio; generating, via an engine cycle model, a commanded rotor blade pitch angle; obtaining, via a sensor, a measured rotor blade pitch; and generating, via a controller, a rotor blade pitch signal corresponding to a commanded adjustment to the commanded rotor blade pitch angle based at least on the measured rotor blade pitch.

The computing system of any preceding clause, comprising generating a corrected low spool parameter signal based at least on a commanded low spool parameter and a measured low spool parameter; and generating an engine control signal corresponding to a fuel flow at a combustion section.

The computing system of any preceding clause, wherein generating the rotor blade pitch signal is a first control loop and generating the engine control signal is a second control loop.

The computing system of any preceding clause, wherein generating the rotor blade pitch signal is independent of generating the engine control signal when the combustion section is at a substantially steady state aircraft operating condition.

A computing system comprising one or more processors and one or more memory devices, wherein the one or more memory devices is configured to store instructions that, when executed by the one or more processors, performs operations, the operations comprising management logic block, a commanded thrust output signal; receiving, at a controller, the commanded thrust output signal; and generating, via the controller, an output signal corresponding to one or more of a commanded fuel flow, a rotor blade pitch angle, a vane pitch angle, or a rotor plane angle.

The computing system of any preceding clause, comprising generating, via the engine, an actual thrust output estimate based at least on the output signal.

The computing system of any preceding clause, comprising receiving, via a sensor at the engine, an engine signal corresponding to one or more of a torque measurement, a low spool speed measurement, a high spool speed measurement, a rotor blade pitch angle measurement, a vane pitch angle measurement, a rotor plane position measurement, or one or more actuator positions corresponding to a variable geometry, or an acoustic sensor.

The computing system of any preceding clause, comprising generating a thrust feedback signal based at least on the engine signal.

The computing system of any preceding clause, wherein the thrust curve defines engine output characteristics as a function of one or more environmental conditions or control devices at the engine.

A computing system comprising one or more processors and one or more memory devices, wherein the one or more memory devices is configured to store instructions that, when executed by the one or more processors, performs operations, the sensor-based controller configured to execute instructions that perform operations comprising obtaining a throttle input corresponding to one or more of a desired air speed of an aircraft, thrust output, or pressure ratio; generating, via an engine cycle model, a commanded rotor blade pitch angle; obtaining, via a sensor, a measured rotor blade pitch; and generating, via a controller, a rotor blade pitch signal corresponding to a commanded adjustment to the commanded rotor blade pitch angle based at least on the measured rotor blade pitch, and wherein the computing system comprises a model-based controller configured to execute operations comprising obtaining a desired thrust output via a throttle input; determining, at least via an engine cycle model comprising a thrust curve, a commanded thrust output signal; receiving, at a controller, the commanded thrust output signal; and generating, via the controller, an output signal corresponding to one or more of a commanded fuel flow, a rotor blade pitch angle, a vane pitch angle, or a rotor plane angle.

The computing system of any preceding clause, wherein the model-based controller is configured to adjust engine output thrust within a 7% margin.

The computing system of any preceding clause, wherein the model-based controller is configured to adjust engine output thrust within a 5% margin.

The computing system of any preceding clause, wherein the sensor-based controller is configured to generate the rotor pitch signal during transient changes in engine operating condition.

The computing system of any preceding clause, wherein transient changes in engine operating condition comprises conditions to and between two or more of ignition, idle, takeoff, climb, cruise, descent, approach, or thrust reverse.

The computing system of any preceding clause, wherein the model based controller is configured to generate the output signal during substantially steady state engine operating condition.

The computing system of any preceding clause, the computing system configured to execute operations, the operations comprising generating a control signal corresponding to a commanded engine pressure ratio, a commanded core engine pressure ratio, a commanded rotor blade pitch angle, a commanded fuel flow, a commanded rotor plane angle, a commanded vane pitch angle, or combinations thereof.

The computing system of any preceding clause, the computing system comprising a first engine controller corresponding to a first single unducted rotor engine, the first engine controller comprising the sensor-based controller and the model-based controller; a second engine controller corresponding to a second single unducted rotor engine, the second engine controller comprising the sensor-based controller and the model-based controller, wherein the first engine controller and the second engine controller are in cross coupled communication to one another, and wherein the operations comprise determining a master controller of the first engine controller and the second engine controller, and determining whether to adjust an engine operating parameter at one or more of the first single unducted rotor engine or the second single unducted rotor engine, wherein determining whether to adjust the engine operating parameter corresponds to a sensed beat frequency between the first and second single unducted rotor engines.

The computing system of any preceding clause, the operations comprising adjusting one or more of an engine operating parameter comprising rotor blade pitch angle, a vane pitch angle, or a rotor plane angle at one or more of the first single unducted rotor engine or the second single unducted rotor engine.

The computing system of any preceding clause, wherein adjusting one or more of the engine operating parameter comprises maintaining a substantially constant speed of a core engine at the single unducted rotor engines.

The computing system of any preceding clause, wherein determining the master controller comprises determining a better-performing engine based on one or more of a health parameter, an engine operating parameter, an engine cycle count, an exhaust gas temperature, specific fuel consumption, or time-on-wing.

The computing system of any preceding clause, the operations comprising de-tuning the better-performing single unducted rotor engine based on the other engine operating condition.

The computing system of any preceding clause, the operations comprising generating, via the sensor-based controller at the first engine controller or the second engine controller, a corrected low spool parameter signal based at least on a commanded low spool parameter and a measured low spool parameter; generating, via the sensor-based controller at the first engine controller or the second engine controller, an engine control signal corresponding to a fuel flow at a combustion section; generating, via the engine, an actual thrust output based at least on the output signal; and receiving, via a sensor at the engine, an engine signal corresponding to one or more of a torque measurement, a low spool speed measurement, a high spool speed measurement, a rotor blade pitch angle measurement, a vane pitch angle measurement, a rotor plane position measurement, or one or more actuator positions corresponding to a variable geometry, or an acoustic sensor.

An aircraft comprising a computing system of any preceding clause.

An aircraft comprising a propulsion system of any preceding clause.

An aircraft configured to execute the steps of a method of any preceding clause.

A propulsion system, the propulsion system comprising a variable pitch rotor assembly comprising a plurality of blades coupled to a disk, wherein the plurality of blades comprises a first blade configured to articulate a first blade pitch separately from a second blade configured to articulate a second blade pitch; a vane assembly positioned in aerodynamic relationship with the variable pitch rotor assembly; a core engine comprising a high speed spool and a low speed spool, wherein the low speed spool is operably coupled to the rotor assembly; and one or more controllers configured to execute operations, the operations comprising articulating the first blade of the rotor assembly, wherein articulating the first blade alters the first blade pitch; and articulating the second blade of the rotor assembly, wherein articulating the second blade alters the second blade pitch.

The propulsion system of any preceding clause, the operations comprising receiving an input signal indicative of an environmental parameter within or surrounding the propulsion system; and generating an output signal based on the environmental parameter, wherein the output signal corresponds to articulation of one or more of the first blade or the second blade of the rotor assembly.

The propulsion system of any preceding clause, wherein generating the output signal corresponds to a desired frequency of articulation of one or more of the first blade or the second blade of the rotor assembly.

The propulsion system of any preceding clause, wherein the desired frequency of articulation corresponds to a resonance frequency of one or more of the first blade or the second blade of the rotor assembly.

The propulsion system of any preceding clause, wherein the desired frequency of articulation is based at least on a torsional mode shape of the first blade or the second blade of the rotor assembly.

The propulsion system of any preceding clause, wherein articulating the first blade and the second blade of the rotor assembly comprises intermittently changing the first blade pitch and the second blade pitch.

The propulsion system of any preceding clause, the operations comprising altering thrust vector based at least on operating the core engine at a substantially constant speed and articulating one or both of the first blade or the second blade of the variable pitch rotor assembly.

The propulsion system of any preceding clause, the operations comprising altering thrust vector based at least on operating the low speed spool at a substantially constant speed based at least on articulating one or both of the first blade or the second blade of the variable pitch rotor assembly relative to a vane pitch angle of the vane assembly aft of the rotor assembly.

The propulsion system of any preceding clause, wherein the variable pitch rotor assembly is a single unducted rotor assembly positioned forward of the vane assembly.

The propulsion system of any preceding clause, the operations comprising operating the core engine and the rotor assembly to generate thrust output; determining a desired thrust output versus speed of the core engine; and generating an output signal based at least on the determined desired thrust output versus speed of the core engine.

The propulsion system of any preceding clause, the operations comprising altering thrust vector based at least on operating the low speed spool at a substantially constant speed based at least on articulating one or both of the first blade or the second blade of the variable pitch rotor assembly relative to a vane pitch angle of the vane assembly aft of the rotor assembly.

A propulsion system comprising a variable pitch rotor assembly comprising a single stage of a plurality of blades coupled to a disk, wherein the plurality of blades comprises a first blade configured to articulate a first blade pitch separately from a second blade configured to articulate a second blade pitch; a vane assembly positioned aft of the variable pitch rotor assembly; a core engine comprising a high speed spool and a low speed spool, wherein the low speed spool is operably coupled to the rotor assembly; and a controller configured to execute operations, the operations comprising determining a desired thrust output versus speed of the core engine; determining a desired first blade pitch at the first blade; determining a desired second blade pitch at the second blade; and adjusting one or both of the first blade pitch or the second blade pitch based on the determined desired thrust output versus speed of the core engine.

The propulsion system of any preceding clause, the operations comprising receiving an input signal indicative of an environmental parameter; and generating an output signal based on the environmental parameter, wherein the output signal corresponds to adjusting of one or more of the first blade pitch or the second blade pitch.

The propulsion system of any preceding clause, wherein the environmental parameter comprises one or more of a perceived noise, ambient air temperature, ambient air pressure, or icing condition.

The propulsion system of any preceding clause, wherein generating the output signal corresponds to a desired frequency of adjusting of one or more of the first blade pitch or the second blade pitch.

The propulsion system of any preceding clause, wherein the desired frequency of adjusting corresponds to a resonance frequency of one or more of the first blade or the second blade of the rotor assembly.

The propulsion system of any preceding clause, wherein the desired frequency of adjusting is based at least on a torsional mode shape of the first blade or the second blade of the rotor assembly.

The propulsion system of any preceding clause, wherein adjusting one or both of the first blade pitch or the second blade pitch comprises intermittently adjusting the first blade pitch and the second blade pitch between a respective first angle and second angle.

The propulsion system of any preceding clause, the operations comprising altering thrust vector based at least on adjusting the first blade to the desired first blade pitch at the first blade or adjusting the second blade to the desired second blade pitch different from the desired first blade pitch.

The propulsion system of any preceding clause, the operations comprising operating the core engine at a substantially constant speed when altering thrust vector.

A propulsion system defining an engine centerline, the propulsion system comprising a rotor assembly configured to rotate relative to the engine centerline axis, the rotor assembly comprising a plurality of blades, each blade of the plurality of blades configured to rotate along a respective blade pitch angle axis; and a vane assembly positioned in aerodynamic relationship with the rotor assembly, the vane assembly comprising a plurality of vanes, each vane of the plurality of vanes configured to rotate along a respective vane pitch angle axis a controller configured to execute operations, the operations comprising moving each blade of the plurality of blades to a reverse thrust position about its respective blade pitch axis, wherein a leading edge of each blade is located aft of a trailing edge of the respective blade at a radial span location when in the reverse thrust position; and adjusting each vane of the plurality of vanes about its respective vane pitch axis when the plurality of blades is in the reverse thrust position to modify an amount of reverse thrust generated by the propulsion system.

The propulsion system of any preceding clause, wherein the rotor assembly is unducted.

The propulsion system of any preceding clause, wherein the one or more blades is configured to generate forward flow over a first portion of a blade span, and wherein the one or more blades is configured to generate reverse flow over a second portion of the blade span.

The propulsion system of any preceding clause, wherein the one or more blades is configured to generate forward flow below 50% of a blade span, and wherein the one or more blades is configured to generate reverse flow at or above 50% of the blade span.

The propulsion system of any preceding clause, wherein adjusting each vane of the plurality of vanes about its respective vane pitch axis when the plurality of blades are in the reverse thrust position comprises rotating one or more vanes along the vane pitch axis up to 15 degrees open or up to 15 degrees closed from a design point.

The propulsion system of any preceding clause, wherein adjusting each vane of the plurality of vanes about its respective vane pitch axis when the plurality of blades are in the reverse thrust position comprises rotating one or more vanes along the vane pitch axis up to 10 degrees open or up to 10 degrees closed from a design point.

The propulsion system of any preceding clause, wherein adjusting each vane of the plurality of vanes about its respective vane pitch axis when the plurality of blades are in the reverse thrust position comprises rotating one or more vanes along the vane pitch axis up to 5 degrees open or up to 5 degrees closed from a design point.

The propulsion system of any preceding clause, wherein adjusting each vane of the plurality of vanes about its respective vane pitch axis when the plurality of blades is in the reverse thrust position comprises closing the vanes to increase the amount of reverse thrust generated by the propulsion system.

The propulsion system of any preceding clause, wherein adjusting each vane of the plurality of vanes about its respective vane pitch axis when the plurality of blades is in the reverse thrust position comprises opening the vanes to decrease the amount of reverse thrust generated by the propulsion system.

The propulsion system of any preceding clause, wherein the rotor assembly is ducted.

The propulsion system of any preceding clause, wherein the vane assembly is positioned aft of the rotor assembly when the blade pitch angle at one or more blades of the rotor assembly is closed.

A method for generating reverse thrust for a single stage unducted rotor engine with a vane assembly positioned in aerodynamic relationship, the method comprising adjusting a blade pitch angle at one or more blades of the rotor assembly to position a blade leading edge aft of a blade trailing edge at a radial span location; and adjusting loading at the rotor assembly based on changing a vane pitch angle of one or more vanes of the vane assembly.

The method of any preceding clause, wherein adjusting loading at the rotor assembly based on changing the vane pitch angle of one or more vanes of the vane assembly comprises closing the vanes to increase the amount of reverse thrust generated by the engine.

The method of any preceding clause, wherein adjusting loading at the rotor assembly based on changing the vane pitch angle of one or more vanes of the vane assembly comprises opening the vanes to decrease the amount of reverse thrust generated by the propulsion system.

The method of any preceding clause, wherein adjusting loading at the rotor assembly based on changing the vane pitch angle of one or more vanes of the vane assembly comprises rotating one or more vanes along the vane pitch axis up to 15 degrees open or up to 15 degrees closed from a design point.

The method of any preceding clause, wherein adjusting loading at the rotor assembly based on changing the vane pitch angle of one or more vanes of the vane assembly comprises rotating one or more vanes along the vane pitch axis up to 10 degrees open or up to 10 degrees closed from a design point.

The method of any preceding clause, wherein adjusting loading at the rotor assembly based on changing the vane pitch angle of one or more vanes of the vane assembly comprises rotating one or more vanes along the vane pitch axis up to 5 degrees open or up to 5 degrees closed from a design point.

The method of any preceding clause, wherein adjusting the blade pitch angle at one or more blades of the rotor assembly to position the blade leading edge aft of the blade trailing edge at the radial span location comprises generating forward flow below 50% of a blade span; and generating reverse flow at or above 50% of the blade span.

A computing system, the computing system configured to store instructions that, when executed by the one or more processors, performs operations, the operations comprising commanding an adjustment of a blade pitch angle at one or more blades of a rotor assembly of an aeronautical engine to position a blade leading edge aft of a blade trailing edge at a radial span location; and commanding an adjustment of a loading at the rotor assembly based on changing a vane pitch angle of one or more vanes of a vane assembly of the aeronautical engine.

The computing system of any preceding clause, wherein commanding the adjustment of the loading at the rotor assembly based on changing the vane pitch angle of one or more vanes of the vane assembly comprises commanding a closing of the vanes to increase an amount of reverse thrust generated by the aeronautical engine.

The computing system of any preceding clause, wherein commanding the adjustment of the loading at the rotor assembly based on changing the vane pitch angle of one or more vanes of the vane assembly comprises commanding an opening of the vanes to decrease an amount of reverse thrust generated by the aeronautical engine.

A system for reducing noise generation for a single unducted rotor engine, the system comprising the propulsion system of any preceding clause.

A propulsion system defining an engine centerline, the propulsion system comprising an unducted rotor assembly comprising a plurality of blades extended radially relative to the engine centerline axis, the rotor assembly configured to generate thrust substantially co-directional to the engine centerline axis, and a vane assembly positioned aft of the rotor assembly, the vane assembly comprising a plurality of vanes extended radially relative to the engine centerline axis, wherein the propulsion system generates a power loading at the rotor assembly of at least 25 horsepower per ft² at cruise altitude.

The propulsion system of any preceding clause, wherein the propulsion system generates a power loading at the rotor assembly of 100 horsepower per ft² or less at cruise altitude.

The propulsion system of any preceding clause, wherein cruise altitude comprises an ambient air condition between 4.85 psia and 2.14 psia.

A propulsion system of any preceding clause configured to execute the method of any preceding clause.

An engine comprising an unducted fan drivingly coupled with a low-pressure turbine, the unducted fan comprising a plurality of fan blades, wherein a pitch angle of the fan blades is variable; a plurality of unducted outlet guide vanes, wherein a pitch angle of the unducted outlet guide vanes is variable; and a controller configured to change, based on a noise sensitive condition, at least one of: the pitch angle of the unducted outlet guide vanes; a speed of the unducted fan; and the pitch angle of the fan blades.

The engine of any preceding clause, wherein changing the pitch angle of the unducted outlet guide vanes based on the noise sensitive condition comprises closing the unducted outlet guide vanes by 3 to 20 degrees relative to a design point.

The engine of any preceding clause, wherein changing the pitch angle of the unducted outlet guide vanes based on the noise sensitive condition comprises opening the unducted outlet guide vanes by 1 to 5 degrees relative to a design point.

The engine of any preceding clause, wherein the speed of the unducted fan is increased.

The engine of any preceding clause, wherein the speed of the unducted fan is decreased.

The engine of any preceding clause, wherein the controller is configured to change: a pitch of the unducted outlet guide vanes relative to a nominal pitch; a pitch of the fan blades relative to a nominal pitch; and a speed of the unducted fan relative to a nominal speed.

The engine of any preceding clause, wherein the noise sensitive condition is based on at least one of a location, an altitude, and a time of day.

The engine of any preceding clause, wherein the noise sensitive condition is based on a noise measurement point of at least one of approach, cutback, and sideline.

The engine of any preceding clause, wherein the noise sensitive condition is based on a selected noise threshold.

The engine of any preceding clause, wherein the noise sensitive condition is based on maintaining noise value at a noise level.

The engine of any preceding clause, wherein the controller is further configured to adjust a thrust split between an unducted airflow stream and a ducted airflow stream.

The engine of any preceding clause, wherein adjusting the thrust split between the unducted airflow stream and the ducted airflow stream includes maintaining a nominal thrust of the engine.

The engine of any preceding clause, comprising a ducted fan and inlet guide vanes forward of the ducted fan, wherein a pitch angle of the inlet guide vanes is variable.

The engine of any preceding clause, wherein the controller is configured to control the pitch angle of the inlet guide vanes to adjust a thrust split between an unducted airflow stream and a ducted airflow stream based on the noise sensitive condition.

The engine of any preceding clause, further comprising a variable area fan duct nozzle.

The engine of any preceding clause, wherein the controller is configured to control the area of the variable area fan duct nozzle to adjust a thrust split between an unducted airflow stream and a ducted airflow stream based on the noise sensitive condition.

An aircraft, comprising: a first engine comprising a first unducted fan, a first ducted fan, and first outlet guide vanes; a second engine comprising a second unducted fan, a second ducted fan, and second outlet guide vanes; and a controller configured to independently adjust, based on a first noise value associated with the first engine and a second noise value associated with the second engine, at least one of: a first thrust split between the first unducted fan and at least one of the first ducted fan and the first outlet guide vanes; and a second thrust split between the second unducted fan and at least one of the second ducted fan and the second outlet guide vanes.

The aircraft of any preceding clause, wherein the first noise value is based on a measurement from a first sensor associated with the first engine, and the second noise value is based on a measurement from a second sensor associated with the second engine.

The aircraft of any preceding clause, wherein the first sensor is on one of the first engine and a fuselage of the aircraft; and the second sensor is on one of the second engine and the fuselage of the aircraft.

A method of operating a gas turbine engine, the gas turbine engine comprising a low-pressure turbine, an unducted fan drivingly coupled with the low-pressure turbine, and a plurality of outlet guide vanes, the method comprising: receiving data indicative of a noise sensitive condition with a controller of the gas turbine engine; and changing, in response to the received data indicative of the noise sensitive condition, at least one of: a pitch angle of the outlet guide vanes; a speed of the unducted fan; and a pitch angle of fan blades of the unducted fan.

A turbofan engine for an aircraft, the turbofan engine comprising: a fan having a plurality of fan blades coupled to a fan shaft having one or more fan bearings, each of the plurality of fan blades being rotatable about a pitch axis and extending from a fan hub; a fan guide vane array downstream of the fan and comprising a plurality of fan guide vanes, each of the plurality of fan guide vanes being rotatable about a vane pitch axis; a fan actuation system disposed within the fan hub and including one or more actuators for rotating the plurality of fan blades about the pitch axis and one or more radial thrust bearings; and a sensor-based controller configured to execute a first set of operations, the first set of operations comprising: obtaining a first signal corresponding to a commanded low spool speed; obtaining a second signal indicative of a pitch angle corresponding to thrust output from the fan and the fan guide vane array; generating a pitch feedback signal corresponding to a commanded adjustment to the pitch angle based at least on one or both of a variable blade pitch angle or a variable vane pitch angle; a model-based controller configured to execute a second set of operations, the second set of operations comprising: obtaining a desired thrust output via a throttle input; determining, at least via a power management block, a commanded thrust output signal; receiving the commanded thrust output signal; and generating an output signal corresponding to one or more of a commanded fuel flow to a combustion section, a variable blade pitch angle, a variable vane pitch angle, or a rotor plane angle; wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )} ,$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of any preceding clause, wherein the model-based controller is configured to adjust engine thrust output via the output signal within a 7% margin relative to the sensor-based controller.

The turbofan engine of any preceding clause, wherein the sensor-based controller is configured to generate the pitch feedback signal during transient changes in engine operating condition.

The turbofan engine of any preceding clause, wherein transient changes in engine operating condition comprises conditions to and between two or more of ignition, idle, takeoff, climb, cruise, descent, approach, or thrust reverse.

The turbofan engine of any preceding clause, wherein the model-based controller is configured to generate the output signal during substantially steady state engine operating condition.

The turbofan engine of any preceding clause, the first set of operations comprising: obtaining a throttle input corresponding to one or more of a desired air speed of an aircraft, a desired thrust output, or a desired pressure ratio; generating the first signal corresponding to the commanded low spool speed; and generating the second signal indicative of the pitch angle corresponding to thrust output at the fan.

The turbofan engine of any preceding clause, the first set of operations comprising: generating a low spool speed feedback signal corresponding to the commanded fuel flow.

The turbofan engine of any preceding clause, wherein generating the low spool speed feedback signal corresponding to the commanded adjustment to the fuel flow maintains a substantially constant core engine speed.

The turbofan engine of any preceding clause, wherein generating the low spool speed feedback signal corresponding to the commanded adjustment to the fuel flow provides a variable fan speed.

The turbofan engine of any preceding clause, wherein generating the pitch feedback signal is independent of generating the low spool speed feedback signal when the combustion section is at a substantially steady state aircraft operating condition.

The turbofan engine of any preceding clause, the second set of operations comprising: receiving, via a sensor at the turbofan engine, an engine signal corresponding to one or more of a torque, a low spool speed, a high spool speed, a rotor blade pitch angle, a vane pitch angle, a rotor plane position, one or more actuator positions corresponding to a variable geometry, or an acoustic sensor; and generating a thrust feedback signal based at least on the engine signal.

A turbofan engine for an aircraft, the turbofan engine comprising: a fan having a plurality of fan blades coupled to a fan shaft having one or more fan bearings, each of the plurality of fan blades being rotatable about a pitch axis and extending from a fan hub; a nacelle that circumferentially surrounds the fan; a fan actuation system disposed within the fan hub and including one or more actuators for rotating the plurality of fan blades about the pitch axis and one or more radial thrust bearings; and a computing system comprising one or more processors and one or more memory devices, wherein the one or more memory devices is configured to store instructions that, when executed by the one or more processors, performs operations, the operations comprising: obtaining a first signal corresponding to a commanded low spool speed, obtaining a second signal indicative of a pitch angle corresponding to thrust output at the fan, and generating a pitch feedback signal corresponding to a commanded adjustment to the pitch angle based at least on one or both of a variable blade pitch angle or a variable vane pitch angle; wherein the fan actuation system is characterized by a fan actuation system length envelope in a range of 8.5 to 13, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches.

The computing system of any preceding clause, the operations comprising: obtaining a throttle input corresponding to one or more of a desired air speed of an aircraft, a desired thrust output, or a desired pressure ratio; generating the first signal corresponding to the commanded low spool speed; and generating the second signal indicative of the pitch angle corresponding to thrust output at the fan.

The computing system of any preceding clause, wherein the first signal is indicative of a fuel flow to a combustion section.

The computing system of any preceding clause, the operations comprising: generating a low spool speed feedback signal corresponding to a commanded adjustment to the fuel flow.

The computing system of any preceding clause, wherein generating the pitch feedback signal is a first closed control loop, and wherein generating the low spool speed feedback is a second closed control loop.

The computing system of any preceding clause, wherein generating the low spool speed feedback signal corresponding to the commanded adjustment to the fuel flow maintains a substantially constant core engine speed.

The computing system of any preceding clause, wherein generating the low spool speed feedback signal corresponding to the commanded adjustment to the fuel flow provides a variable fan speed.

The computing system of any preceding clause, wherein generating the pitch feedback signal is independent of generating the low spool speed feedback when a combustion section is of the turbofan engine at a substantially steady state aircraft operating condition.

A turbofan engine for an aircraft, the turbofan engine comprising: a fan having a plurality of fan blades coupled to a fan shaft having one or more fan bearings, the fan being an open fan, and each of the plurality of fan blades being rotatable about a pitch axis and extending from a fan hub; a fan actuation system disposed within the fan hub and including one or more actuators for rotating the plurality of fan blades about the pitch axis and one or more radial thrust bearings; and a computing system comprising one or more processors and one or more memory devices, wherein the one or more memory devices is configured to store instructions that, when executed by the one or more processors, performs operations, the operations comprising: management block, a commanded thrust output signal; receiving, at a controller, the commanded thrust output signal; and generating, via the controller, an output signal corresponding to one or more of a commanded fuel flow, a blade pitch angle, a vane pitch angle, or a rotor plane angle; wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches.

A turbofan engine for an aircraft, the turbofan engine comprising: a fan having a plurality of fan blades coupled to a fan shaft having one or more fan bearings, each of the plurality of fan blades being rotatable about a pitch axis and extending from a fan hub; a vane assembly positioned in aerodynamic relationship with the fan, the vane assembly comprising a plurality of vanes, each vane of the plurality of vanes configured to rotate along a respective vane pitch axis; a fan actuation system disposed within the fan hub and including one or more actuators for rotating the plurality of fan blades about the pitch axis and one or more radial thrust bearings; and a controller configured to execute operations, the operations comprising; moving each blade of the plurality of fan blades to a reverse thrust position about its respective pitch axis, wherein a leading edge of each fan blade is located aft of a trailing edge of the respective fan blade at a radial span location when in the reverse thrust position, and adjusting each vane of the plurality of vanes about its respective vane pitch axis when the plurality of fan blades is in the reverse thrust position to modify an amount of reverse thrust generated by the turbofan engine; wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of any preceding clause, wherein the fan is unducted.

The turbofan engine of any preceding clause, wherein the one or more blades is configured to generate forward flow over a first portion of a blade span, and wherein the one or more blades is configured to generate reverse flow over a second portion of the blade span.

The turbofan engine of any preceding clause, wherein the one or more blades is configured to generate forward flow below 50% of a blade span, and wherein the one or more blades is configured to generate reverse flow at or above 50% of the blade span.

The turbofan engine of any preceding clause, wherein adjusting each vane of the plurality of vanes about its respective vane pitch axis when the plurality of fan blades are in the reverse thrust position comprises rotating one or more vanes along the vane pitch axis up to 15 degrees open or up to 15 degrees closed from a design point.

The turbofan engine of any preceding clause, wherein adjusting each vane of the plurality of vanes about its respective vane pitch axis when the plurality of fan blades are in the reverse thrust position comprises rotating one or more vanes along the vane pitch axis up to 10 degrees open or up to 10 degrees closed from a design point.

The turbofan engine of any preceding clause, wherein adjusting each vane of the plurality of vanes about its respective vane pitch axis when the plurality of fan blades are in the reverse thrust position comprises rotating one or more vanes along the vane pitch axis up to 5 degrees open or up to 5 degrees closed from a design point.

The turbofan engine of any preceding clause, wherein adjusting each vane of the plurality of vanes about its respective vane pitch axis when the plurality of fan blades is in the reverse thrust position comprises closing the plurality of vanes to increase the amount of reverse thrust generated by the turbofan engine.

The turbofan engine of any preceding clause, wherein adjusting each vane of the plurality of vanes about its respective vane pitch axis when the plurality of fan blades is in the reverse thrust position comprises opening the plurality of vanes to decrease the amount of reverse thrust generated by the turbofan engine.

The turbofan engine of any preceding clause, wherein the fan is ducted.

A turbofan engine for an aircraft, the turbofan engine comprising: a fan having a plurality of fan blades coupled to a fan shaft having one or more fan bearings, each of the plurality of fan blades being rotatable about a pitch axis and extending from a fan hub; a nacelle that circumferentially surrounds the fan; a vane assembly positioned in aerodynamic relationship with the fan, the vane assembly comprising a plurality of vanes, each vane of the plurality of vanes configured to rotate along a respective vane pitch axis; a fan actuation system disposed within the fan hub and including one or more actuators for rotating the plurality of fan blades about the pitch axis and one or more radial thrust bearings; and a controller configured to execute operations, the operations comprising: adjusting a blade pitch angle at one or more of the plurality of fan blades of the fan to position a blade leading edge aft of a blade trailing edge at a radial span location, and adjusting loading at the fan based on changing a vane pitch angle of one or more of the plurality of vanes of the vane assembly; wherein the fan actuation system is characterized by a fan actuation system length envelope in a range of 8.5 to 13, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches.

The turbofan engine of any preceding clause, wherein adjusting loading at the fan based on changing the vane pitch angle of one or more vanes of the vane assembly comprises closing the vanes to increase an amount of reverse thrust generated by the engine.

The turbofan engine of any preceding clause, wherein adjusting loading at the fan based on changing the vane pitch angle of one or more vanes of the vane assembly comprises opening the vanes to decrease an amount of reverse thrust generated by the turbofan engine.

The turbofan engine of any preceding clause, wherein adjusting loading at the fan based on changing the vane pitch angle of one or more vanes of the vane assembly comprises rotating one or more vanes along the vane pitch axis up to 15 degrees open or up to 15 degrees closed from a design point.

The turbofan engine of any preceding clause, wherein adjusting loading at the fan based on changing the vane pitch angle of one or more vanes of the vane assembly comprises rotating one or more vanes along the vane pitch axis up to 10 degrees open or up to 10 degrees closed from a design point.

The turbofan engine of any preceding clause, wherein adjusting loading at the fan based on changing the vane pitch angle of one or more vanes of the vane assembly comprises rotating one or more vanes along the vane pitch axis up to 5 degrees open or up to 5 degrees closed from a design point.

The turbofan engine of any preceding clause, wherein adjusting the blade pitch angle at one or more of the plurality of fan blades of the fan to position the blade leading edge aft of the blade trailing edge at the radial span location comprises: generating forward flow below 50% of a blade span; and generating reverse flow at or above 50% of the blade span.

A turbofan engine for an aircraft, the turbofan engine comprising: a fan having a plurality of fan blades coupled to a fan shaft having one or more fan bearings, the fan being an open fan, and each of the plurality of fan blades being rotatable about a pitch axis and extending from a fan hub; a vane assembly positioned in aerodynamic relationship with the fan, the vane assembly comprising a plurality of vanes, each vane of the plurality of vanes configured to rotate along a respective vane pitch axis; a fan actuation system disposed within the fan hub and including one or more actuators for rotating the plurality of fan blades about the pitch axis and one or more radial thrust bearings; and a computing system configured to store instructions that, when executed by one or more processors, performs operations, the operations comprising: commanding an adjustment of a blade pitch angle at one or more of the plurality of fan blades of the fan to position a blade leading edge aft of a blade trailing edge at a radial span location, and commanding an adjustment of a loading at the fan based on changing a vane pitch angle of one or more of the plurality of vanes of the vane assembly; wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of system length envelope being given by: fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches.

The turbofan engine of any preceding clause, wherein commanding the adjustment of the loading at the fan based on changing the vane pitch angle of one or more vanes of the vane assembly comprises commanding a closing of the vanes to increase an amount of reverse thrust generated by the turbofan engine.

The turbofan engine of any preceding clause, wherein commanding the adjustment of the loading at the rotor assembly based on changing the vane pitch angle of one or more vanes of the vane assembly comprises commanding an opening of the vanes to decrease an amount of reverse thrust generated by the turbofan engine.

A turbofan engine for an aircraft, the turbofan engine comprising: a fan having a plurality of fan blades coupled to a fan shaft having one or more fan bearings, each of the plurality of fan blades being rotatable about a pitch axis and extending from a fan hub; a plurality of unducted outlet guide vanes, wherein a pitch angle of the plurality of unducted outlet guide vanes is variable; a fan actuation system disposed within the fan hub and including one or more actuators for rotating the plurality of fan blades about the pitch axis and one or more radial thrust bearings; and a controller configured to change, based on a noise sensitive condition, at least one of: the pitch angle of the plurality of unducted outlet guide vanes, a speed of the fan, and a pitch angle of the plurality of fan blades; wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

The turbofan engine of any preceding clause, wherein changing the pitch angle of the unducted outlet guide vanes based on the noise sensitive condition comprises closing the unducted outlet guide vanes by 3 to 20 degrees relative to a design point.

The turbofan engine of any preceding clause, wherein changing the pitch angle of the unducted outlet guide vanes based on the noise sensitive condition comprises opening the unducted outlet guide vanes by 1 to 5 degrees relative to a design point.

The turbofan engine of any preceding clause, wherein the speed of the fan is increased.

The turbofan engine of any preceding clause, wherein the speed of the fan is decreased.

The turbofan engine of any preceding clause, wherein the controller is configured to change: a pitch of the unducted outlet guide vanes relative to a nominal pitch; a pitch of the fan blades relative to a nominal pitch; and a speed of the fan relative to a nominal speed.

The turbofan engine of any preceding clause, wherein the noise sensitive condition is based on at least one of a location, an altitude, and a time of day.

The turbofan engine of any preceding clause, wherein the noise sensitive condition is based on a noise measurement point of at least one of approach, cutback, and sideline.

The turbofan engine of any preceding clause, wherein the noise sensitive condition is based on a selected noise threshold.

The turbofan engine of any preceding clause, wherein the noise sensitive condition is based on maintaining noise value at a noise level.

The turbofan engine of any preceding clause, wherein the controller is further configured to adjust a thrust split between an unducted airflow stream and a ducted airflow stream.

The turbofan engine of any preceding clause, wherein adjusting the thrust split between the unducted airflow stream and the ducted airflow stream includes maintaining a nominal thrust of the turbofan engine.

The turbofan engine of any preceding clause, comprising a ducted fan and inlet guide vanes forward of the ducted fan, wherein a pitch angle of the inlet guide vanes is variable.

The engine of any preceding clause, wherein the controller is configured to control the pitch angle of the inlet guide vanes to adjust a thrust split between an unducted airflow stream and a ducted airflow stream based on the noise sensitive condition.

The turbofan engine of any preceding clause, further comprising a variable area fan duct nozzle.

The turbofan engine of any preceding clause, wherein the controller is configured to control the area of the variable area fan duct nozzle to adjust a thrust split between an unducted airflow stream and a ducted airflow stream based on the noise sensitive condition.

An aircraft, comprising: a first turbofan engine comprising a first unducted fan having a first plurality of fan blades coupled to a first fan shaft having one or more fan bearings, a first ducted fan, and first outlet guide vanes; a second turbofan engine comprising a second unducted fan having a second plurality of fan blades coupled to a second fan shaft having one or more fan bearings, a second ducted fan, and second outlet guide vanes; a fan actuation system disposed within the first turbofan engine and the second turbofan engine, the fan actuation system including one or more actuators for rotating the plurality of fan blades of the first unducted fan and the second plurality of fan blades of the second unducted fan about a pitch axis and one or more radial thrust bearings; and a controller configured to independently adjust, based on a first noise value associated with the first turbofan engine and a second noise value associated with the second turbofan engine, at least one of: a first thrust split between the first unducted fan and at least one of the first ducted fan and the first outlet guide vanes, and a second thrust split between the second unducted fan and at least one of the second ducted fan and the second outlet guide vanes; wherein the fan actuation system is characterized by a fan actuation system length envelope in a range of 8.5 to 13, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches.

The aircraft of any preceding clause, wherein the first noise value is based on a measurement from a first sensor associated with the first turbofan engine, and the second noise value is based on a measurement from a second sensor associated with the second turbofan engine.

The aircraft of any preceding clause, wherein the first sensor is on one of the first turbofan engine and a fuselage of the aircraft; and the second sensor is on one of the second turbofan engine and the fuselage of the aircraft.

A turbofan engine for an aircraft, the turbofan engine comprising: a fan having a plurality of fan blades coupled to a fan shaft having one or more fan bearings, the fan being an open fan, and each of the plurality of fan blades being rotatable about a pitch axis and extending from a fan hub; a plurality of outlet guide vanes, wherein a pitch angle of the plurality of outlet guide vanes is variable; a fan actuation system disposed within the fan hub and including one or more actuators for rotating the plurality of fan blades about the pitch axis and one or more radial thrust bearings; and a controller configured to execute operations, the operations comprising: receiving data indicative of a noise sensitive condition, and changing, in response to the received data indicative of the noise sensitive condition, at least one of: a pitch angle of the outlet guide vanes, a speed of the fan, and a pitch angle of the plurality of fan blades of the fan; wherein the fan actuation system is characterized by a fan actuation system length envelope in a range of 8.5 to 24, the fan actuation system length envelope being given by:

$$\frac{{N}_{FB} \times {D}_{FT}}{{L}_{AXIAL} \times ( \frac{{R}_{TB}}{{N}_{FB}} )}$$

wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches.

A turbofan engine comprising a fan having a plurality of fan blades coupled to a fan shaft, each of the plurality of fan blades being rotatable about a pitch axis, and a fan actuation system disposed within a fan hub, wherein the fan actuation system includes a hydraulic cylinder and is characterized by a fan actuation system length (FASL) envelope in a range of 8.5 to 24; and a controller configured to maintain a substantially constant core engine speed during a flight phase while modulating an output thrust by actuating the hydraulic cylinder to adjust the pitch axis of the plurality of fan blades.

A turbofan engine comprising an unducted variable pitch rotor assembly and a fan actuation system including a pneumatic chamber, wherein the fan actuation system is characterized by a fan actuation system (FAS) envelope in a range from 300 to 1860; wherein the fan actuation system further comprises a scheduling ring having a plurality of slots defining different blade pitch schedules for asynchronous pitching of the plurality of fan blades to a reverse thrust position; and wherein the pneumatic chamber is pressurized and configured to passively bias the scheduling ring to a feather position upon a loss of hydraulic pressure in the fan actuation system.

A turbofan engine comprising a primary fan having a plurality of fan blades rotatable about a pitch axis, a fan actuation system having a fan actuation system length (FASL) envelope in a range of 8.5 to 24, a fan hub having a fan hub radius ratio in a range from 0.1 to 0.4 enabled by the FASL envelope, a ducted midfan positioned aft of the primary fan, and a controller responsive to a noise sensitive condition; wherein the controller is configured to adjust a pitch of the plurality of fan blades via the fan actuation system to selectively shift a thrust split from the primary fan to the ducted midfan to reduce an acoustic noise level.

A propulsion system comprising an unducted variable pitch rotor assembly having a plurality of fan blades, and a fan actuation system comprising line-contact radial thrust bearings disposed radially at a thrust bearing radius; wherein the fan actuation system is bounded by a fan actuation system (FAS) envelope in a range from 660 to 1860; and wherein the propulsion system further comprises a controller configured to maintain a substantially constant core speed while asynchronously pitching the plurality of fan blades through a flat pitch to a reverse thrust position via the fan actuation system.

A turbofan engine comprising a fan actuation system bounded by a fan actuation system length (FASL) envelope in a range of 8.5 to 24, the fan actuation system comprising a rigid unison ring coupled to a plurality of fan blades; and a model-based controller configured to obtain an acoustic measurement and generate a pitch feedback signal; wherein the model-based controller executes micro-adjustments to the unison ring based on the pitch feedback signal to mitigate a noise sensitive condition while simultaneously maintaining a constant low spool speed.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A turbofan engine for an aircraft, the turbofan engine comprising:
a fan having a plurality of fan blades coupled to a fan shaft having one or more fan bearings, each of the plurality of fan blades being rotatable about a pitch axis and extending from a fan hub;
a fan guide vane array downstream of the fan and comprising a plurality of fan guide vanes, each of the plurality of fan guide vanes being rotatable about a vane pitch axis;
a fan actuation system disposed within the fan hub and including one or more actuators for rotating the plurality of fan blades about the pitch axis and one or more radial thrust bearings; and
a first controller configured to execute a first set of operations, the first set of operations comprising:
obtaining a first signal corresponding to a commanded low spool speed;
obtaining a second signal indicative of a pitch angle corresponding to thrust output from the fan and the fan guide vane array;
generating a pitch feedback signal corresponding to a commanded adjustment to the pitch angle based at least on one or both of a variable blade pitch angle or a variable vane pitch angle;
a second controller configured to execute a second set of operations, the second set of operations comprising:
obtaining a desired thrust output via a throttle input;
determining, at least via a power management block, a commanded thrust output signal;
receiving the commanded thrust output signal; and
generating an output signal corresponding to one or more of a commanded fuel flow to a combustion section, a variable blade pitch angle, a variable vane pitch angle, or a rotor plane angle;
wherein the fan actuation system is characterized by a fan actuation system length envelope in a range of 8.5 to 24, the fan actuation system length envelope being given by:
$$\frac{{N}_{FB} \times {D}_{FT}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings.

2. The turbofan engine of claim 1, wherein the second controller is configured to adjust engine thrust output via the output signal within a 7% margin relative to the first controller.

3. The turbofan engine of claim 1, wherein the first controller is configured to generate the pitch feedback signal during transient changes in engine operating condition.

4. The turbofan engine of claim 3, wherein transient changes in engine operating condition comprises conditions to and between two or more of ignition, idle, takeoff, climb, cruise, descent, approach, or thrust reverse.

5. The turbofan engine of claim 1, wherein the second controller is configured to generate the output signal during substantially steady state engine operating condition.

6. The turbofan engine of claim 1, the first set of operations comprising:
obtaining a throttle input corresponding to one or more of a desired air speed of an aircraft, a desired thrust output, or a desired pressure ratio;
generating the first signal corresponding to the commanded low spool speed; and
generating the second signal indicative of the pitch angle corresponding to thrust output at the fan.

7. The turbofan engine of claim 5, the first set of operations comprising:
generating a low spool speed feedback signal corresponding to the commanded fuel flow.

8. The turbofan engine of claim 7, wherein generating the low spool speed feedback signal corresponding to the commanded adjustment to the fuel flow maintains a substantially constant core engine speed.

9. The turbofan engine of claim 7, wherein generating the low spool speed feedback signal corresponding to the commanded adjustment to the fuel flow provides a variable fan speed.

10. The turbofan engine of claim 7, wherein generating the pitch feedback signal is independent of generating the low spool speed feedback signal when the combustion section is at a substantially steady state aircraft operating condition.

11. The turbofan engine of claim 1, the second set of operations comprising:
receiving, via a sensor at the turbofan engine, an engine signal corresponding to one or more of a torque, a low spool speed, a high spool speed, a rotor blade pitch angle, a vane pitch angle, a rotor plane position, one or more actuator positions corresponding to a variable geometry, or an acoustic sensor; and
generating a thrust feedback signal based at least on the engine signal.

12. A turbofan engine for an aircraft, the turbofan engine comprising:
a fan having a plurality of fan blades coupled to a fan shaft having one or more fan bearings, each of the plurality of fan blades being rotatable about a pitch axis and extending from a fan hub;
a nacelle that circumferentially surrounds the fan;
a fan actuation system disposed within the fan hub and including one or more actuators for rotating the plurality of fan blades about the pitch axis and one or more radial thrust bearings; and
a computing system comprising one or more processors and one or more memory devices, wherein the one or more memory devices is configured to store instructions that, when executed by the one or more processors, performs operations, the operations comprising:
obtaining a first signal corresponding to a commanded low spool speed,
obtaining a second signal indicative of a pitch angle corresponding to thrust output at the fan, and
generating a pitch feedback signal corresponding to a commanded adjustment to the pitch angle based at least on one or both of a variable blade pitch angle or a variable vane pitch angle;
wherein the fan actuation system is characterized by a fan actuation system length envelope in a range of 8.5 to 13, the fan actuation system length envelope being given by:
$$\frac{{N}_{FB} \times {D}_{FT}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 40 inches, and A_{FB} is in a range of 17 inches to 20 inches.

13. The turbofan engine of claim 12, the operations comprising:
obtaining a throttle input corresponding to one or more of a desired air speed of an aircraft, a desired thrust output, or a desired pressure ratio;
generating the first signal corresponding to the commanded low spool speed; and
generating the second signal indicative of the pitch angle corresponding to thrust output at the fan.

14. The turbofan engine of claim 13, wherein the first signal is indicative of a fuel flow to a combustion section.

15. The turbofan engine of claim 14, the operations comprising:
generating a low spool speed feedback signal corresponding to a commanded adjustment to the fuel flow.

16. The turbofan engine of claim 15, wherein generating the pitch feedback signal is a first closed control loop, and wherein generating the low spool speed feedback is a second closed control loop.

17. The turbofan engine of claim 15, wherein generating the low spool speed feedback signal corresponding to the commanded adjustment to the fuel flow maintains a substantially constant core engine speed.

18. The turbofan engine of claim 17, wherein generating the low spool speed feedback signal corresponding to the commanded adjustment to the fuel flow provides a variable fan speed.

19. The turbofan engine of claim 15, wherein generating the pitch feedback signal is independent of generating the low spool speed feedback when a combustion section is of the turbofan engine at a substantially steady state aircraft operating condition.

20. A turbofan engine for an aircraft, the turbofan engine comprising:
a fan having a plurality of fan blades coupled to a fan shaft having one or more fan bearings, the fan being an open fan, and each of the plurality of fan blades being rotatable about a pitch axis and extending from a fan hub;
a fan actuation system disposed within the fan hub and including one or more actuators for rotating the plurality of fan blades about the pitch axis and one or more radial thrust bearings; and
a computing system comprising one or more processors and one or more memory devices, wherein the one or more memory devices is configured to store instructions that, when executed by the one or more processors, performs operations, the operations comprising:
obtaining a desired thrust output via a throttle input;
determining, at least via a power management block, a commanded thrust output signal;
receiving, at a controller, the commanded thrust output signal; and
generating, via the controller, an output signal corresponding to one or more of a commanded fuel flow, a blade pitch angle, a vane pitch angle, or a rotor plane angle;
wherein the fan actuation system is characterized by a fan actuation system length envelope in a range of 8.5 to 24, the fan actuation system length envelope being given by:
$$\frac{{N}_{FB} \times {D}_{FT}}{{L}_{AXIAL} \times ( \frac{{R}_{TB}}{{N}_{FB}} )}$$
wherein N_{FB} is a number of the plurality of fan blades, D_{FT} is a fan tip diameter of the plurality of fan blades, R_{TB} is a thrust bearing radius of the one or more radial thrust bearings, and L_{AXIAL} is an axial length from a fan hub tip of the fan hub to the one or more fan bearings, and R_{TB} is a thrust bearing radius of the one or more radial thrust bearings, wherein L_{AXIAL} is given by A_{FH}+A_{FB}, A_{FH} being a fan hub axial length from the fan hub tip to the pitch axis of the plurality of fan blades and A_{FB} being a fan bearing axial length from the pitch axis of the plurality of fan blades to the one or more fan bearings, A_{FH} is in a range of 25 inches to 75 inches, and A_{FB} is in a range of 16 inches to 23 inches, and D_{FT} is in a range of 120.0 inches to 180.0 inches.
